(19) United States
(12) Patent Application Publication
(10) Pub. No.: US 2022/0148265 A1
(43) Pub. Date: May 12, 2022

(54) VIRTUAL CAMERA CONTROL DEVICE, VIRTUAL CAMERA CONTROL METHOD, AND VIRTUAL CAMERA CONTROL PROGRAM STORING MEDIUM

(71) Applicant: Mitsubishi Electric Corporation, Tokyo (JP)

(72) Inventors: Yusuke YOKOSUKA, Tokyo (JP); Takayuki TSUKITANI, Tokyo (JP)

(73) Assignee: Mitsubishi Electric Corporation, Tokyo (JP)

(21) Appl. No.: 17/583,209

(22) Filed: Jan. 25, 2022

Related U.S. Application Data
(63) Continuation of application No. PCT/JP2019/039506, filed on Oct. 7, 2019.

(51) Int. Cl. G06T 19/00; G06F 3/01

(52) U.S. Cl. CPC G06T 19/003; G06F 3/013

(57) ABSTRACT

A virtual camera control device includes: a gaze point determining unit to determine, as a gaze point, any one point of a traveling object or a browsing object that is disposed in a virtual 3D space and is a virtual 3D object; and a virtual camera traveling unit to move a virtual camera while keeping a photographing direction of a virtual camera that photographs an inside of the virtual 3D space and is disposed in the virtual 3D space in a direction from the virtual camera toward the gaze point determined by the gaze point determining unit and keeping a distance from the virtual camera to the traveling object at a fixed distance.

### CROSS-REFERENCE TO RELATED APPLICATION

This application is a continuation of PCT filing PCT/JP2019/039506, filed Oct. 7, 2019, the entire contents of which are incorporated herein by reference.

### TECHNICAL FIELD

The present invention relates to a virtual camera control device, a virtual camera control method, and a virtual camera control program.

### BACKGROUND ART

There is a display control device that outputs to a display device an image photographed by a virtual camera virtually arranged in a virtual three-dimensional (3D) space. The display control device changes an area photographed by the virtual camera by controlling a position of the virtual camera in the virtual 3D space, a direction in which the virtual camera photographs an image, or the like.

For example, Patent Literature 1 discloses a technique of disposing a virtual camera around a virtual 3D object disposed in a virtual 3D space, keeping a direction in which the virtual camera photographs an image in a direction orthogonal to a surface of the virtual 3D object, and causing the virtual camera to circularly move while keeping a distance from the virtual camera to the virtual 3D object constant, thereby causing the virtual camera to photograph the virtual 3D object.

### CITATION LIST

### Patent Literature

Patent Literature 1: U.S. Pat. No. 8,044,953

### SUMMARY OF INVENTION

### Technical Problem

In the conventional technique as disclosed in Patent Literature 1, a virtual 3D object (hereinafter, referred to as a “photographing object”) to be photographed by a virtual camera and a virtual 3D object (hereinafter, referred to as a “traveling object”) serving as a reference of circular movement of the virtual camera are the same virtual 3D object.

Here, for example, in a case where a certain display is to be performed on a periphery of a certain object, it is desired to confirm how the display looks from various positions around the object by performing simulation in advance. In a case where such simulation is performed in the virtual 3D space, it is necessary to set a virtual 3D object corresponding to a display as an object to be browsed (hereinafter, referred to as a “browsing object”) and set a virtual 3D object corresponding to the object as a traveling object. That is, the browsing object and the traveling object need to be set as virtual 3D objects different from each other.

Since the conventional technique sets the same virtual 3D object as the photographing object and the traveling object, there is a problem that it cannot be applied to the use of simulation as described above.

The present invention is intended to solve the above-described problems, and an object of the present invention is to provide a virtual camera control device capable of setting a virtual 3D object different from a browsing object as a traveling object.

### Solution to Problem

A virtual camera control device according to the present invention includes: processing circuitry to perform a process to: determine, as a gaze point, any one point of a traveling object or a browsing object that is disposed in a virtual 3D space and is a virtual 3D object; and move a virtual camera while keeping a photographing direction of the virtual camera that photographs an inside of the virtual 3D space and is disposed in the virtual 3D space in a direction from the virtual camera toward the gaze point determined and keeping a distance from the virtual camera to the traveling object at a fixed distance, wherein the travelling object is the virtual 3D object indicating a vehicle in the virtual 3D space, and the browsing object is the virtual 3D object indicating an image formed on a road surface by a projecting device provided on the vehicle in the virtual 3D space.

### Advantageous Effects of Invention

According to the present invention, a virtual 3D object different from a browsing object can be set as a traveling object.

### BRIEF DESCRIPTION OF DRAWINGS

FIG. 1 is a block diagram illustrating an example of a configuration of a main part of a display system to which a display control device according to a first embodiment is applied.

FIG. 2 is a block diagram showing an example of a configuration of a main part of a virtual camera control device according to the first embodiment.

FIGS. 3A and 3B are diagrams showing an example of a hardware configuration of a main part of the virtual camera control device according to the first embodiment.

FIG. 4 is a flowchart illustrating an example of processing in which the virtual camera control device according to the first embodiment determines a gaze point.

FIG. 5 is an arrangement diagram illustrating an example of a positional relationship among a traveling object, a browsing object, and a virtual camera as viewed from above a virtual 3D object indicating a vehicle that is the traveling object in a virtual 3D space according to the first embodiment.

FIG. 6 is a flowchart illustrating an example of processing in which the virtual camera control device according to the first embodiment moves a virtual camera.

FIG. 7 is a diagram illustrating an example when a virtual camera traveling unit in the virtual camera control device according to the first embodiment moves a virtual camera.

FIG. 8 is a flowchart illustrating an example of processing in which the virtual camera traveling unit in the virtual camera control device according to the first embodiment moves the virtual camera.

FIG. 9 is a diagram illustrating an example when the virtual camera traveling unit in the virtual camera control device according to the first embodiment moves the virtual camera.

FIGS. 10A and 10B are arrangement diagrams illustrating an example of a positional relationship among a traveling object, a browsing object, a spatial object, and a virtual camera when viewed from above a virtual 3D object indicating a vehicle that is the traveling object in the virtual 3D space according to the first embodiment.

FIG. 11 is a flowchart illustrating an example of processing in which the virtual camera control device according to the first embodiment determines a gaze point.

FIG. 12 is a block diagram illustrating an example of a configuration of a main part of a display system to which a display control device according to a second embodiment is applied.

FIG. 13 is a block diagram showing an example of a configuration of a main part of a virtual camera control device according to the second embodiment.

FIG. 14 is an arrangement diagram illustrating an example of a positional relationship among a traveling object, a browsing object, and a virtual camera as viewed from above a virtual 3D object indicating a vehicle that is the traveling object in a virtual 3D space according to the second embodiment.

FIG. 15 is a flowchart illustrating an example of processing in which the virtual camera control device according to the second embodiment moves the virtual camera.

FIG. 16 is a block diagram illustrating an example of a configuration of a main part of a display system to which a display control device according to a third embodiment is applied.

FIG. 17 is a block diagram showing an example of a configuration of a main part of a virtual camera control device according to the third embodiment.

FIG. 18 is an arrangement diagram illustrating an example of a positional relationship among a traveling object, a browsing object, and a virtual camera as viewed from above a virtual 3D object indicating a vehicle that is the traveling object in a virtual 3D space according to the third embodiment.

FIG. 19 is a flowchart illustrating an example of processing in which the virtual camera control device according to the third embodiment moves the virtual camera.

FIG. 20 is a block diagram illustrating an example of a configuration of a main part of a display system to which a display control device according to a fourth embodiment is applied.

FIG. 21 is a block diagram showing an example of a configuration of a main part of a virtual camera control device according to the fourth embodiment.

FIG. 22 is an arrangement diagram illustrating an example of a positional relationship among a traveling object, a browsing object, and a virtual camera as viewed from above a virtual 3D object indicating a vehicle that is the traveling object in a virtual 3D space according to the fourth embodiment.

FIG. 23 is a flowchart illustrating an example of processing in which the virtual camera control device according to the fourth embodiment determines a gaze point.

FIG. 24 is a block diagram illustrating an example of a configuration of a main part of a display system to which a display control device according to a fifth embodiment is applied.

FIG. 25 is a block diagram showing an example of a configuration of a main part of a virtual camera control device according to the fifth embodiment.

FIG. 26 is an arrangement diagram illustrating an example of a positional relationship among a traveling object, a browsing object, and a virtual camera as viewed from above a virtual 3D object indicating a vehicle that is the traveling object in a virtual 3D space according to the fifth embodiment.

FIG. 27 is a flowchart illustrating an example of processing in which the virtual camera control device according to the fifth embodiment determines a gaze point.

FIG. 28 is a block diagram illustrating an example of a configuration of a main part of a display system to which a display control device according to a sixth embodiment is applied.

FIG. 29 is a block diagram showing an example of a configuration of a main part of a virtual camera control device according to the sixth embodiment.

FIG. 30 is an arrangement diagram illustrating an example of a positional relationship among a traveling object, a first browsing object, a second browsing object, and a virtual camera as viewed from above a virtual 3D object indicating a vehicle that is the traveling object in a virtual 3D space according to the sixth embodiment.

FIG. 31 is a flowchart illustrating an example of processing in which the virtual camera control device according to the sixth embodiment determines a gaze point.

FIG. 32 is a block diagram illustrating an example of a configuration of a main part of a display system to which a display control device according to a seventh embodiment is applied.

FIG. 33 is a block diagram showing an example of a configuration of a main part of a virtual camera control device according to the seventh embodiment.

FIG. 34 is an arrangement diagram illustrating an example of a positional relationship among a traveling object, a browsing object, and a virtual camera as viewed from above a virtual 3D object indicating a vehicle that is the traveling object in a virtual 3D space according to the seventh embodiment.

FIG. 35 is a flowchart illustrating an example of processing in which the virtual camera control device according to the seventh embodiment determines a gaze point again.

FIG. 36 is a block diagram illustrating an example of a configuration of a main part of a display system to which a display control device according to an eighth embodiment is applied.

FIG. 37 is a block diagram showing an example of a configuration of a main part of a virtual camera control device according to the eighth embodiment.

FIG. 38 is an arrangement diagram illustrating an example of a positional relationship among a traveling object, a first browsing object, a second browsing object, and a virtual camera as viewed from above a virtual 3D object indicating a vehicle that is the traveling object in a virtual 3D space according to the eighth embodiment.

FIG. 39 is a flowchart illustrating an example of processing in which the virtual camera control device according to the eighth embodiment determines a gaze point again.

### DESCRIPTION OF EMBODIMENTS

Hereinafter, embodiments of the present invention will be described in detail with reference to the drawings.

### First Embodiment

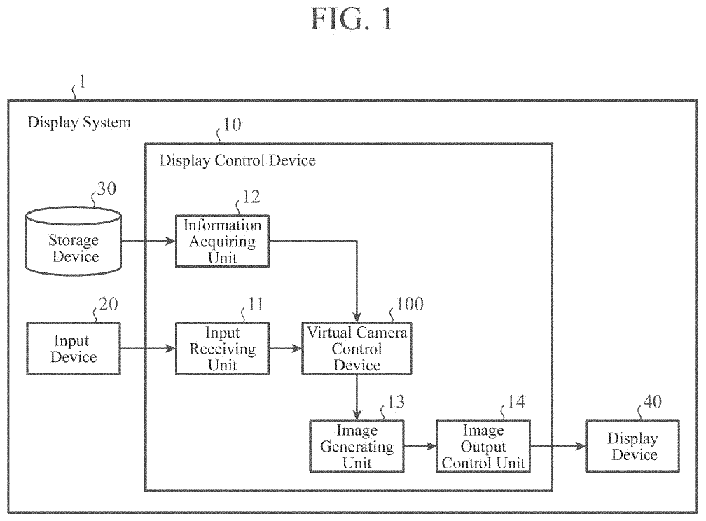

A virtual camera control device 100 according to a first embodiment will be described with reference to FIGS. 1 to 11.

With reference to FIG. 1, a configuration of a main part of a display control device 10 to which the virtual camera control device 100 according to the first embodiment is applied will be described.

FIG. 1 is a block diagram illustrating an example of a configuration of a main part of a display system 1 to which the display control device 10 according to the first embodiment is applied.

The display system 1 includes the display control device 10, an input device 20, a storage device 30, and a display device 40.

The display control device 10 includes an information processing device such as a general-purpose personal computer (PC).

The input device 20 is a keyboard, a mouse, or the like, receives an operation from a user, and inputs an operation signal to the display control device 10.

The storage device 30 is a hard disk drive, an SD card memory, or the like, and stores information (hereinafter referred to as “display control information”) necessary for display control by the display control device 10. For example, the storage device 30 stores, as the display control information, virtual 3D object information indicating the position or area in a virtual 3D space of a virtual 3D object disposed in the virtual 3D space.

The display device 40 is a display or the like, and displays an image indicated by an image signal output from the display control device 10.

The display control device 10 includes an input receiving unit 11, an information acquiring unit 12, the virtual camera control device 100, an image generating unit 13, and an image output control unit 14.

The input receiving unit 11 receives an operation signal input from the input device 20 and generates operation input information corresponding to the operation signal. The input receiving unit 11 outputs the generated operation input information to the virtual camera control device 100 or the like.

The information acquiring unit 12 reads the display control information from the storage device 30. The information acquiring unit 12 reads, for example, virtual 3D object information from the storage device 30 as the display control information.

The virtual camera control device 100 acquires virtual 3D object information and operation input information, and controls the position (hereinafter referred to as a “virtual camera photographing position”) in the virtual 3D space of the virtual camera disposed in the virtual 3D space and the direction (hereinafter referred to as a “virtual camera photographing direction”) in which the virtual camera photographs an image on the basis of the acquired virtual 3D object information and operation input information. The virtual camera control device 100 outputs the acquired virtual 3D object information and virtual camera information to the image generating unit 13.

The virtual camera information includes camera position information indicating the virtual camera photographing position and camera direction information indicating a virtual camera photographing direction. The virtual camera information may include camera view angle information indicating a view angle at which the virtual camera photographs an image, and the like, in addition to the camera position information and the camera direction information.

The image generating unit 13 generates an image (hereinafter, referred to as a “photographed image”) generated by the virtual camera when the virtual camera photographs an image in the virtual 3D space on the basis of the virtual 3D object information and the virtual camera information, and outputs the generated photographed image to the image output control unit 14 as image information. The image generating unit 13 generates photographed images, for example, at predetermined intervals assuming that the virtual camera always photographs an inside of the virtual 3D space while moving and stopping moving as described later.

The image output control unit 14 converts the image information generated by the image generating unit 13 into an image signal, and controls the output of the image signal to the display device 40.

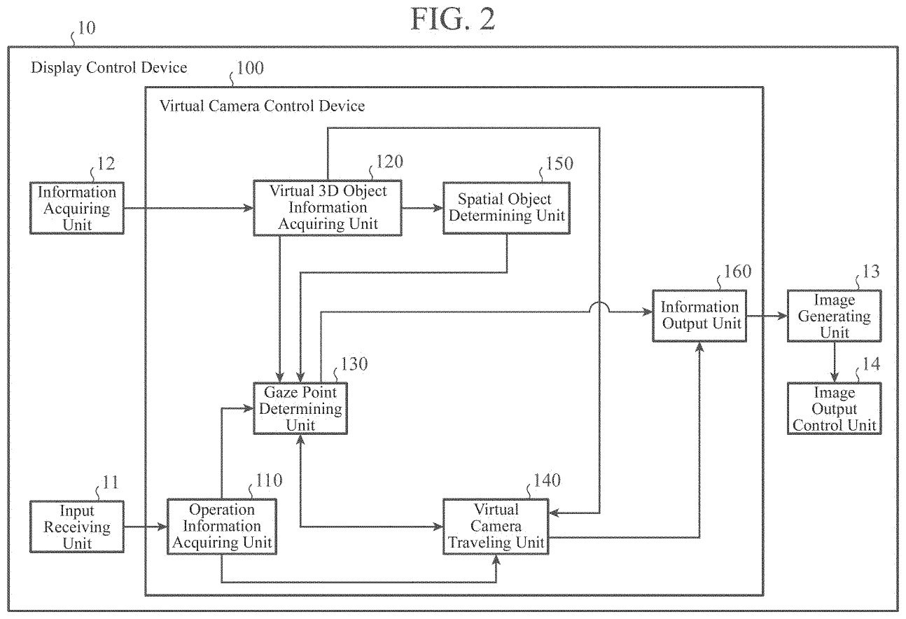

A configuration of a main part of the virtual camera control device 100 according to the first embodiment will be described with reference to FIG. 2.

FIG. 2 is a block diagram showing an example of a configuration of a main part of the virtual camera control device 100 according to the first embodiment.

The virtual camera control device 100 includes an operation information acquiring unit 110, a virtual 3D object information acquiring unit 120, a gaze point determining unit 130, a virtual camera traveling unit 140, and an information output unit 160.

The virtual camera control device 100 may include a spatial object determining unit 150 in addition to the above-described configuration. The virtual camera control device 100 illustrated in FIG. 2 includes the spatial object determining unit 150.

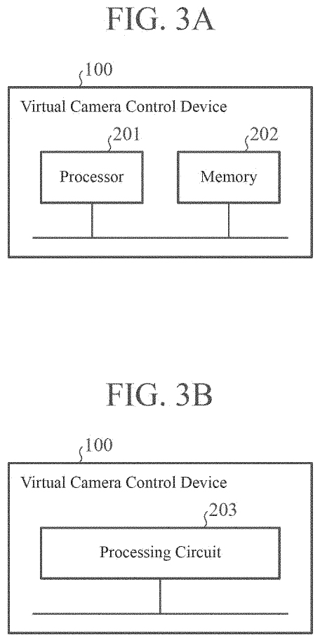

A hardware configuration of a main part of the virtual camera control device 100 according to the first embodiment will be described with reference to FIGS. 3A and 3B.

FIGS. 3A and 3B are diagrams showing an example of the hardware configuration of the main part of the virtual camera control device 100 according to the first embodiment.

As illustrated in FIG. 3A, the virtual camera control device 100 is configured by a computer, and the computer includes a processor 201 and a memory 202. The memory 202 stores programs for causing the computer to function as the operation information acquiring unit 110, the virtual 3D object information acquiring unit 120, the gaze point determining unit 130, the virtual camera traveling unit 140, the spatial object determining unit 150, and the information output unit 160. The processor 201 reads and executes the programs stored in the memory 202, thereby implementing the operation information acquiring unit 110, the virtual 3D object information acquiring unit 120, the gaze point determining unit 130, the virtual camera traveling unit 140, the spatial object determining unit 150, and the information output unit 160.

In addition, as illustrated in FIG. 3B, the virtual camera control device 100 may be configured by a processing circuit 203. In this case, the functions of the operation information acquiring unit 110, the virtual 3D object information acquiring unit 120, the gaze point determining unit 130, the virtual camera traveling unit 140, the spatial object determining unit 150, and the information output unit 160 may be implemented by the processing circuit 203.

Furthermore, the virtual camera control device 100 may include a processor 201, a memory 202, and a processing circuit 203 (not illustrated). In this case, some of the functions of the operation information acquiring unit 110, the virtual 3D object information acquiring unit 120, the gaze point determining unit 130, the virtual camera traveling unit 140, the spatial object determining unit 150, and the information output unit 160 may be implemented by the processor 201 and the memory 202, and the remaining functions may be implemented by the processing circuit 203.

The processor 201 is implemented by using, for example, a central processing unit (CPU), a graphics processing unit (GPU), a microprocessor, a microcontroller, or a digital signal processor (DSP).

The memory 202 is implemented by using, for example, a semiconductor memory or a magnetic disk. More specifically, the memory 202 is implemented by using a random access memory (RAM), a read only memory (ROM), a flash memory, an erasable programmable read only memory (EPROM), an electrically erasable programmable read-only memory (EEPROM), a solid state drive (SSD), a hard disk drive (HDD), or the like.

The processing circuit 203 is implemented by useing, for example, an application specific integrated circuit (ASIC), a programmable logic device (PLD), a field-programmable gate array (FPGA), a system-on-a-chip (SoC), or a system large-scale integration (LSI).

The operation information acquiring unit 110 acquires the operation input information output by the input receiving unit 11 of the display control device 10. The operation input information acquired by the operation information acquiring unit 110 is information indicating an operation for changing the virtual camera photographing direction of the virtual camera disposed in the virtual 3D space, information indicating an operation for changing the virtual camera photographing position, or the like.

The operation information acquiring unit 110 outputs the acquired operation input information to the gaze point determining unit 130 and the virtual camera traveling unit 140.

The virtual 3D object information acquiring unit 120 acquires, for example, the virtual 3D object information stored in the storage device 30 via the information acquiring unit 12 of the display control device 10.

The virtual 3D object information acquiring unit 120 may acquire the virtual 3D object information on the basis of the operation input information output by the input receiving unit 11. That is, the virtual 3D object information acquired by the virtual 3D object information acquiring unit 120 may be provided to the virtual 3D object information acquiring unit 120 via the input receiving unit 11 by the user operating the input device 20.

The virtual 3D object information acquiring unit 120 acquires, as the virtual 3D object information, browsing object information indicating the position or area of a browsing object in the virtual 3D space. Furthermore, the virtual 3D object information acquiring unit 120 acquires, as the virtual 3D object information, traveling object information indicating the position or area of a traveling object in the virtual 3D space. Furthermore, the virtual 3D object information acquiring unit 120 may acquire, as the virtual 3D object information, spatial object information indicating the position or area in the virtual 3D space of a spatial object, which is a virtual 3D object indicating a predetermined space in the virtual 3D space, in addition to the browsing object information and the traveling object information.

The virtual 3D object information acquiring unit 120 outputs the acquired virtual 3D object information to the gaze point determining unit 130 and the virtual camera traveling unit 140. Furthermore, the virtual 3D object information acquiring unit 120 outputs the acquired virtual 3D object information to the spatial object determining unit 150.

The gaze point determining unit 130 determines, as a gaze point, any one point of the traveling object or the browsing object. For example, the gaze point determining unit 130 determines, as the gaze point, any one point in the surface of the traveling object or the surface of the browsing object.

More specifically, for example, the gaze point determining unit 130 determines, as the gaze point, any one point of the traveling object or the browsing object on the basis of the virtual 3D object information acquired by the virtual 3D object information acquiring unit 120 and the operation input information acquired by the operation information acquiring unit 110.

For example, the display device 40 displays a photographed image obtained by photographing an image of a traveling object or a browsing object from a certain virtual camera photographing position in a certain virtual camera photographing direction. The user can change the virtual camera photographing direction with respect to the traveling object or the browsing object in the photographed image displayed on the display device 40 by operating the input device 20. For example, in a case where the input device 20 is a mouse, the user gives an instruction to change the virtual camera photographing direction by changing a display angle of the traveling object or the browsing object in the photographed image by performing a so-called drag operation. The gaze point determining unit 130 determines, as the gaze point, a point closest to the virtual camera among points at which a straight line passing through the virtual camera photographing position at the time when the virtual camera photographing direction is designated and extending in the designated virtual camera photographing direction intersects with the traveling object or the browsing object.

Furthermore, for example, the user operates the input device 20 to designate any one point of the traveling object or the browsing object in the photographed image displayed on the display device 40. The gaze point determining unit 130 specifies the position of one point in the photographed image designated by the user in the virtual 3D space on the basis of the virtual 3D object information, the operation input information, and the like. Then, the gaze point determining unit 130 determines a direction from the position of the virtual camera toward one point in the photographed image designated by the user as a virtual camera photographing direction. That is, the user can also designate the virtual camera photographing direction by operating the input device 20 to designate any one point of the traveling object or the browsing object in the photographed image displayed on the display device 40. The gaze point determining unit 130 determines, as the gaze point, a point closest to the virtual camera among points at which a straight line passing through the virtual camera photographing position at the time when the virtual camera photographing direction is designated and extending in the designated virtual camera photographing direction intersects with the traveling object or the browsing object. However, in a case where the user designates any one point in the photographed image, the gaze point determining unit 130 may determine the one point as the gaze point.

Note that, when the virtual camera is moved as described later, the virtual camera photographing direction designated by the user is changed with the movement.

The gaze point determining unit 130 outputs information on the determined gaze point to the virtual camera traveling unit 140 and the information output unit 160.

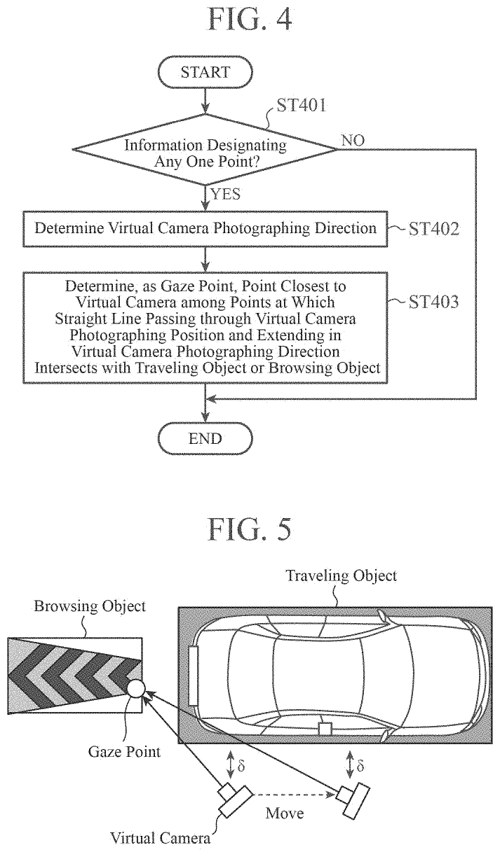

An operation in which the virtual camera control device 100 according to the first embodiment determines a gaze point will be described with reference to FIG. 4.

FIG. 4 is a flowchart illustrating an example of processing in which the virtual camera control device 100 according to the first embodiment determines a gaze point.

For example, every time the operation information acquiring unit 110 acquires the operation input information, the virtual camera control device 100 repeatedly executes the processing of the flowchart.

First, in step ST401, the gaze point determining unit 130 determines whether or not the operation input information acquired by the operation information acquiring unit 110 is information designating any one point of the traveling object or the browsing object in the photographed image.

In step ST401, in a case where the gaze point determining unit 130 determines that the operation input information acquired by the operation information acquiring unit 110 is not information designating any one point of the traveling object or the browsing object in the photographed image, the virtual camera control device 100 ends the processing of the flowchart.

In step ST401, in a case where the gaze point determining unit 130 determines that the operation input information acquired by the operation information acquiring unit 110 is information for designating any one point of the traveling object or the browsing object in the photographed image, in step ST402, the gaze point determining unit 130 determines the virtual camera photographing direction on the basis of the operation input information acquired by the operation information acquiring unit 110.

After step ST402, in step ST403, the gaze point determining unit 130 determines, as the gaze point, a point closest to the virtual camera among points at which a straight line passing through the virtual camera photographing position and extending in the virtual camera photographing direction intersects with the traveling object or the browsing object on the basis of the information indicating the virtual camera photographing position, the information indicating the virtual camera photographing direction, the position or area of the traveling object in the virtual 3D space, and the position or area of the browsing object in the virtual 3D space.

After step ST403, the virtual camera control device 100 ends the processing of the flowchart.

The virtual camera traveling unit 140 moves the virtual camera while keeping the virtual camera photographing direction in the direction from the virtual camera toward the gaze point determined by the gaze point determining unit 130 and keeping the distance from the virtual camera to the traveling object at a fixed distance.

The distance from the virtual camera to the traveling object is the distance between the virtual camera photographing position and the position of the closest point (hereinafter, referred to as a “closest point”) on the traveling object as viewed from the virtual camera photographing position. In a case where the moving direction and the moving amount of the virtual camera are designated with respect to the current virtual camera photographing position, the virtual camera traveling unit 140 calculates (hereinafter, referred to as “next position calculation”) the virtual camera photographing position after the movement based on the designation. In the process of the next position calculation, for example, the virtual camera traveling unit 140 reflects the designated moving direction and moving amount on a plane (hereinafter, referred to as a “calculation plane”) orthogonal to a straight line connecting the virtual camera photographing position and the closest point and passing through the virtual camera photographing position. In the next position calculation using the calculation plane, the virtual camera traveling unit 140 first temporarily moves the current virtual camera photographing position on the calculation plane on the basis of the above-described moving direction and moving amount, and newly calculates the closest point at the position after the temporary movement. Then, the virtual camera traveling unit 140 determines, as the next virtual camera photographing position, a position on a straight line connecting the position after the temporary movement and the newly calculated closest point, the position having a fixed distance from the closest point. For example, the virtual camera traveling unit 140 can move the virtual camera while keeping the distance from the virtual camera to the traveling object at a fixed distance by such next position calculation. Note that “fixed” in “fixed distance” does not need to be strictly “fixed” and includes “substantially fixed”.

For example, the user can input the moving direction and the moving amount of the virtual camera by operating an arrow key of the input device 20 such as a keyboard. The virtual camera traveling unit 140 moves the virtual camera in the virtual 3D space on the basis of the moving direction and the moving amount of the virtual camera indicated by the operation input information acquired by the operation information acquiring unit 110. At the time of this movement, the virtual camera traveling unit 140 moves the virtual camera in the above-described manner on the basis of the virtual 3D object information acquired by the virtual 3D object information acquiring unit 120 and the information of the gaze point determined by the gaze point determining unit 130.

Note that the information indicating the fixed distance may be held in advance by the virtual camera traveling unit 140 or may be provided to the virtual camera traveling unit 140 via the input receiving unit 11 by the user operating the input device 20.

The virtual camera traveling unit 140 generates virtual camera information including camera position information, camera direction information, camera view angle information, and the like. The virtual camera traveling unit 140 outputs the generated virtual camera information to the gaze point determining unit 130 and the information output unit 160.

The information output unit 160 outputs the virtual camera information generated by the virtual camera traveling unit 140 to the image generating unit 13 in the display control device 10. Furthermore, the information output unit 160 outputs information on the gaze point determined by the gaze point determining unit 130 to the image generating unit 13. Furthermore, the information output unit 160 outputs the virtual 3D object information to the image generating unit 13. For example, the information output unit 160 may acquire the virtual 3D object information from any of the virtual 3D object information acquiring unit 120, the gaze point determining unit 130, or the virtual camera traveling unit 140. Note that, in FIG. 2, connection lines in a case where the information output unit 160 acquires the virtual 3D object information from the virtual 3D object information acquiring unit 120 are omitted. Furthermore, in a case where the information output unit 160 acquires the virtual 3D object information from the gaze point determining unit 130 or the virtual camera traveling unit 140, the gaze point determining unit 130 or the virtual camera traveling unit 140 outputs the virtual 3D object information to the information output unit 160 in addition to the above-described output information.

Hereinafter, as an example, a case where the display control device 10 is used as a device that performs a simulation on an image (hereinafter, referred to as a “road surface image”) formed on a road surface by a light projection device provided in a vehicle will be described. Hereinafter, a description will be given assuming that the traveling object is a virtual 3D object indicating a vehicle in a virtual 3D space, and the browsing object is a virtual 3D object indicating a road surface image in the virtual 3D space.

FIG. 5 is an arrangement diagram illustrating an example of a positional relationship among a traveling object, a browsing object, and a virtual camera as viewed from above a virtual 3D object indicating a vehicle that is the traveling object in the virtual 3D space according to the first embodiment.

Hereinafter, as illustrated in FIG. 5, a description will be given assuming that the gaze point is already determined as one point in the browsing object that is the virtual 3D object indicating the road surface image by the gaze point determining unit 130.

For example, the virtual camera traveling unit 140 moves the virtual camera on the basis of the operation input information acquired by the operation information acquiring unit 110. The virtual camera traveling unit 140, when moving the virtual camera, moves the virtual camera while keeping the virtual camera photographing direction in the direction from the virtual camera to the gaze point determined by the gaze point determining unit 130 and keeping the distance from the virtual camera to the traveling object at a fixed distance δ.

Note that, although FIG. 5 illustrates, as an example, a case where the gaze point is any one point in the browsing object, the gaze point may be any one point in the traveling object. Also in a case where the gaze point is any one point on the traveling object, the processing in which the virtual camera traveling unit 140 moves the virtual camera is similar to the processing in a case where the gaze point is any one point in the browsing object. Therefore, the description of the case where the gaze point is any one point in the traveling object will be omitted.

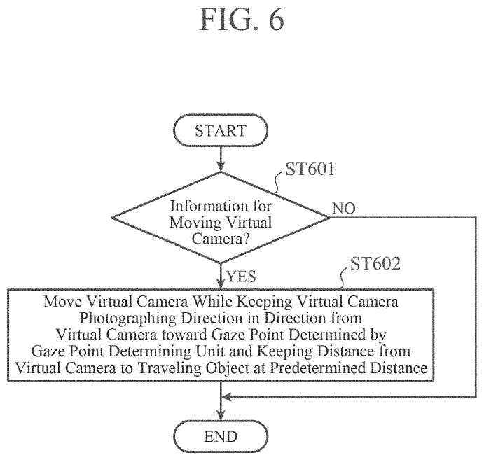

An operation in which the virtual camera control device 100 according to the first embodiment moves a virtual camera will be described with reference to FIG. 6.

FIG. 6 is a flowchart illustrating an example of processing in which the virtual camera control device 100 according to the first embodiment moves the virtual camera.

For example, every time the operation information acquiring unit 110 acquires the operation input information, the virtual camera control device 100 repeatedly executes the processing of the flowchart.

First, in step ST601, the virtual camera traveling unit 140 determines whether or not the operation input information acquired by the operation information acquiring unit 110 is information for moving the virtual camera.

In step ST601, when the virtual camera traveling unit 140 has determined that the operation input information acquired by the operation information acquiring unit 110 is not information for moving the virtual camera, the virtual camera control device 100 ends the processing of the flowchart.

In step ST601, when the virtual camera traveling unit 140 has determined that the operation input information acquired by the operation information acquiring unit 110 is information for moving the virtual camera, the virtual camera traveling unit 140 performs processing of step ST602. In step ST602, the virtual camera traveling unit 140 moves the virtual camera while keeping the virtual camera photographing direction in the direction from the virtual camera toward the gaze point determined by the gaze point determining unit 130 and keeping the distance from the virtual camera to the traveling object at a fixed distance on the basis of the operation input information acquired by the operation information acquiring unit 110.

After step ST602, the virtual camera control device 100 ends the processing of the flowchart.

In the virtual camera control device 100 according to the first embodiment, a virtual 3D object different from a browsing object can be set as a traveling object. Then, by the virtual camera control device 100 controlling the virtual camera in the above-described manner, the display control device 10 can simulate how the browsing object looks from various positions around the traveling object and display the result.

Furthermore, by the virtual camera control device 100 controlling the virtual camera in the above-described manner, the user can confirm how the browsing object looks from various positions around the traveling object, for example, by a simple operation such as an arrow key of the keyboard, for example, as an image displayed on the display.

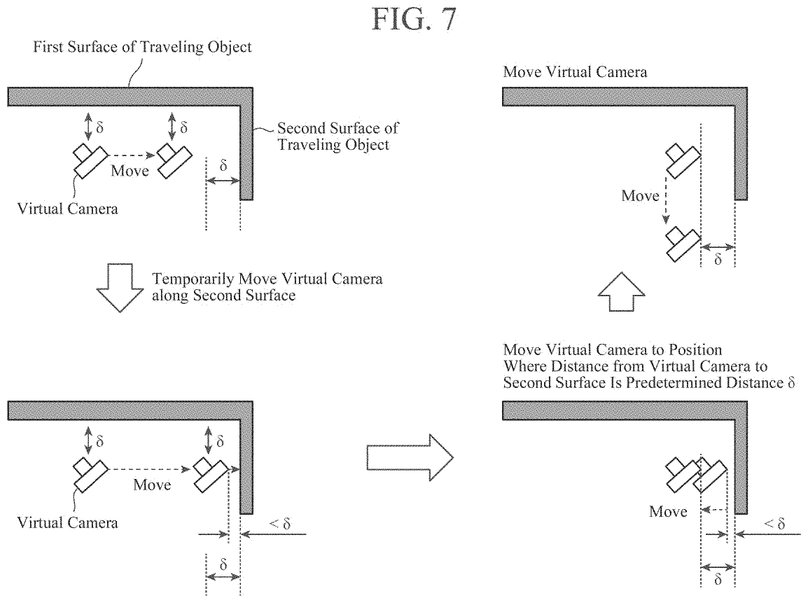

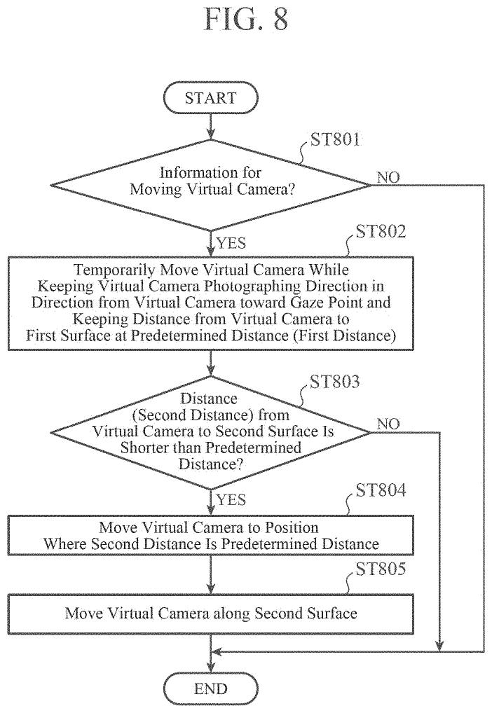

Next, a more specific operation when the virtual camera control device 100 according to the first embodiment moves the virtual camera will be described with reference to FIGS. 7 and 8.

FIG. 7 is a diagram illustrating an example when the virtual camera traveling unit 140 in the virtual camera control device 100 according to the first embodiment moves a virtual camera.

As illustrated in FIG. 7, the virtual camera traveling unit 140 moves the virtual camera while keeping a distance (hereinafter, referred to as a “first distance”) from the virtual camera to the first surface of the traveling object at a fixed distance δ. When having determined that a distance (hereinafter, referred to as a “second distance”) from the virtual camera to a second surface of the traveling object becomes shorter than the fixed distance δ in the process of the next position calculation as described above, the virtual camera traveling unit 140 moves the virtual camera to a position where the second distance is the fixed distance δ.

That is, in the process of the next position calculation as described above, the virtual camera traveling unit 140 first temporarily moves the current virtual camera photographing position on the calculation plane on the basis of the designated moving direction and moving amount, and newly calculates the closest point at the position after the temporary movement. In the example of FIG. 7, the calculation plane is a plane parallel to the first plane and passing through the virtual camera photographing position. The lower left diagram in FIG. 7 illustrates a state in which the closest point newly calculated as a result of the virtual camera traveling unit 140 temporarily moving the virtual camera on the calculation plane is a point on the second surface. Here, the distance between the virtual camera photographing position after the temporary movement and the point on the second surface that is the newly calculated closest point is less than the fixed distance δ. Therefore, as illustrated in the lower right diagram of FIG. 7, the virtual camera traveling unit 140 determines, as the next virtual camera photographing position, a position on a straight line connecting the position after the temporary movement and the newly calculated closest point, the position at which the distance to the closest point is the fixed distance δ.

More specifically, after moving the virtual camera to a position where the second distance is the fixed distance δ, since the new closest point is a point on the second surface, the virtual camera traveling unit 140 moves the virtual camera along the second surface while keeping the second distance at the fixed distance δ. The upper right diagram in FIG. 7 illustrates an example of movement of the virtual camera after the virtual camera traveling unit 140 has moved the virtual camera to a position where the second distance is the fixed distance δ. As illustrated in the upper right diagram of FIG. 7, for example, the virtual camera traveling unit 140 moves the virtual camera along the second surface in a direction away from the first surface while keeping the second distance at the fixed distance δ after moving the virtual camera to a position where the second distance is the fixed distance δ.

For example, the virtual camera traveling unit 140 can move the virtual camera while keeping the distance from the virtual camera to the traveling object at a fixed distance by such next position calculation.

Note that, in FIG. 7, the virtual camera photographing direction after the movement to the next virtual camera photographing position is the same as that before the movement, but actually the virtual camera photographing direction is changed to face the gaze point.

FIG. 8 is a flowchart illustrating an example of processing in which the virtual camera control device 100 according to the first embodiment moves the virtual camera.

For example, every time the operation information acquiring unit 110 acquires the operation input information, the virtual camera control device 100 repeatedly executes the processing of the flowchart.

First, in step ST801, the virtual camera traveling unit 140 determines whether or not the operation input information acquired by the operation information acquiring unit 110 is information for moving the virtual camera.

In step ST801, when the virtual camera traveling unit 140 has determined that the operation input information acquired by the operation information acquiring unit 110 is not information for moving the virtual camera, the virtual camera control device 100 ends the processing of the flowchart.

In step ST801, when the virtual camera traveling unit 140 has determined that the operation input information acquired by the operation information acquiring unit 110 is information for moving the virtual camera, the virtual camera traveling unit 140 performs processing of step ST802. In step ST802, on the basis of the operation input information acquired by the operation information acquiring unit 110, the virtual camera traveling unit 140 temporarily moves the virtual camera while keeping the virtual camera photographing direction in the direction from the virtual camera toward the gaze point determined by the gaze point determining unit 130 and keeping the first distance at a fixed distance.

After step ST802, in step ST803, the virtual camera traveling unit 140 determines whether or not the second distance becomes shorter than a fixed distance.

In step ST803, when the virtual camera traveling unit 140 has determined that the second distance does not become shorter than the fixed distance, the virtual camera control device 100 determines the virtual camera photographing direction and the virtual camera photographing position after the temporary movement as the next virtual camera photographing direction and the virtual camera photographing position as they are, and ends the processing of the flowchart.

In step ST803, when the virtual camera traveling unit 140 has determined that the second distance has become shorter than the fixed distance, in step ST804, the virtual camera traveling unit 140 moves the virtual camera to a position where the second distance is the fixed distance.

After step ST804, in step ST805, the virtual camera traveling unit 140 moves the virtual camera along the second surface while keeping the second distance at the fixed distance δ.

After step ST805, the virtual camera control device 100 ends the processing of the flowchart.

Note that, in the above description, as an example, it is assumed that the virtual camera traveling unit 140 temporarily moves the virtual camera while keeping the first distance at a fixed distance, and in a case where it is determined that the second distance becomes shorter than the fixed distance, determines the next virtual camera photographing position as the position where the second distance becomes the fixed distance, and then outputs the virtual camera information at the next virtual camera photographing position to the information output unit 160. In this case, the display device 40 does not display the photographed image at the virtual camera photographing position in the temporarily moved state.

On the other hand, the virtual camera control device 100 may temporarily move the virtual camera in step ST802, generate the virtual camera information also during a part or all of a period while moving the virtual camera to a position where the second distance becomes a fixed distance in the processing of step ST804, and output the virtual camera information to the information output unit 160. Note that, in a case where the virtual camera control device 100 generates virtual camera information and outputs the virtual camera information to the information output unit 160 during a part or all of the period while moving the virtual camera to a position where the second distance becomes a fixed distance, the virtual camera control device 100 may end the processing of the flowchart without performing the processing of step ST805 after step ST804.

A part of the period while moving the virtual camera to the position where the second distance becomes the fixed distance is, for example, a period during which the virtual camera traveling unit 140 temporarily moves the virtual camera from the position where the virtual camera has started temporary movement to the position where the second distance becomes shorter than the fixed distance. In this case, the photographed image until the second distance becomes less than the fixed distance is displayed on the display device 40 like a moving image. Therefore, the display control device 10 can cause the user to visually recognize that the virtual camera cannot be moved any more in the direction in which the user has moved the virtual camera.

In particular, in a case where the virtual camera control device 100 generates virtual camera information and outputs the virtual camera information to the information output unit 160 during a part of a period while moving the virtual camera to a position where the second distance becomes a fixed distance, the virtual camera control device 100 ends the processing of the flowchart without performing the processing of step ST805 after step ST804, and thereby the display control device 10 can cause the user to further visually recognize that the virtual camera cannot be moved any more in the direction in which the user has moved the virtual camera.

In addition, the entire period while moving the virtual camera to the position where the second distance becomes the fixed distance is, for example, a period during which the virtual camera traveling unit 140 temporarily moves the virtual camera from the position where the virtual camera has started temporary movement to the position where the second distance becomes shorter than the fixed distance while keeping the first distance at the fixed distance, and a period until the virtual camera is moved from the position to a position where the second distance becomes the fixed distance. In this case, the photographed image until the second distance becomes less than the fixed distance and the photographed image from the state in which the second distance has become less than the fixed distance to the state in which the second distance has become the fixed distance are displayed on the display device 40 like a moving image. Therefore, the display control device 10 can cause the user to visually recognize that the virtual camera cannot be moved any more in the direction in which the user has moved the virtual camera.

In particular, in a case where the virtual camera control device 100 generates virtual camera information and outputs the virtual camera information to the information output unit 160 during the entire period while moving the virtual camera to the position where the second distance becomes the fixed distance, the virtual camera control device 100 ends the processing of the flowchart without performing the processing of step ST805 after step ST804, and thereby the display control device 10 can cause the user to further visually recognize that the virtual camera cannot be moved any more in the direction in which the user has moved the virtual camera.

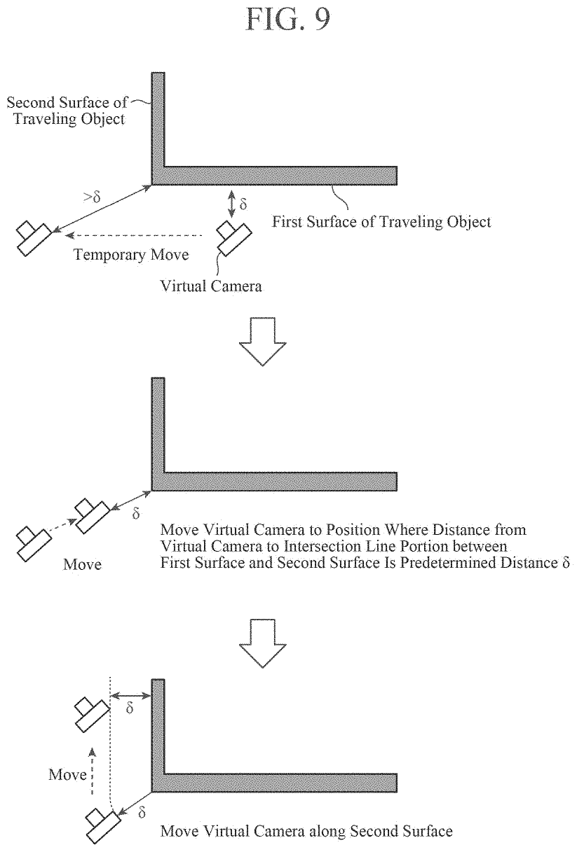

Next, another more specific operation example when the virtual camera control device 100 according to the first embodiment moves the virtual camera will be described with reference to FIG. 9.

FIG. 9 is a diagram illustrating an example when the virtual camera traveling unit 140 in the virtual camera control device 100 according to the first embodiment moves a virtual camera.

As illustrated in FIG. 9, the virtual camera traveling unit 140 moves the virtual camera while keeping the first distance at a fixed distance. When having determined that the first distance becomes longer than the fixed distance, the virtual camera traveling unit 140 moves the virtual camera to a position where the first distance becomes the fixed distance.

More specifically, in the process of next position calculation as described above, the virtual camera traveling unit 140 first temporarily moves the current virtual camera photographing position on the calculation plane on the basis of the designated moving direction and moving amount, and newly calculates the closest point at the position after the temporary movement. In the example in the upper diagram of FIG. 9, the calculation plane is a plane parallel to the first plane and passing through the virtual camera photographing position. The upper diagram in FIG. 9 illustrates a state in which the closest point newly calculated as a result of the virtual camera traveling unit 140 temporarily moving the virtual camera on the calculation plane is an intersection line portion between the first surface and the second surface. However, the distance between the virtual camera photographing position after the temporary movement and the intersection line portion between the first surface and the second surface, which is the newly calculated closest point, is longer than the fixed distance δ. Therefore, as illustrated in the middle diagram of FIG. 9, the virtual camera traveling unit 140 determines, as the next virtual camera photographing position, a position on a straight line connecting the position after the temporary movement and the newly calculated closest point, the position at which the distance to the closest point is the fixed distance δ.

More specifically, the virtual camera traveling unit 140 moves the virtual camera along the second surface while keeping the second distance at the fixed distance δ, assuming that the new closest point is a point on the second surface after moving the virtual camera to a position where the first distance becomes the fixed distance. The lower diagram in FIG. 9 illustrates an example of the movement of the virtual camera after the virtual camera traveling unit 140 has moved the virtual camera until the first distance becomes the fixed distance. As illustrated in the lower diagram of FIG. 9, for example, the virtual camera traveling unit 140 moves the virtual camera along the second surface while keeping the second distance at the fixed distance δ after moving the virtual camera until the first distance becomes the fixed distance.

For example, the virtual camera traveling unit 140 can move the virtual camera while keeping the distance from the virtual camera to the traveling object at a fixed distance by such next position calculation.

Note that, in FIG. 9, the virtual camera photographing direction after the movement to the next virtual camera photographing position is the same as that before the movement, but actually the virtual camera photographing direction is changed to face the gaze point.

A case where the virtual camera control device 100 includes the spatial object determining unit 150 will be described.

The spatial object determining unit 150 determines whether or not the virtual 3D object information acquiring unit 120 has acquired spatial object information that is virtual 3D object information.

In a case where the spatial object determining unit 150 has determined that the virtual 3D object information acquiring unit 120 has acquired the spatial object information, the gaze point determining unit 130 determines, as the gaze point, any one point of the traveling object, the browsing object, or the spatial object.

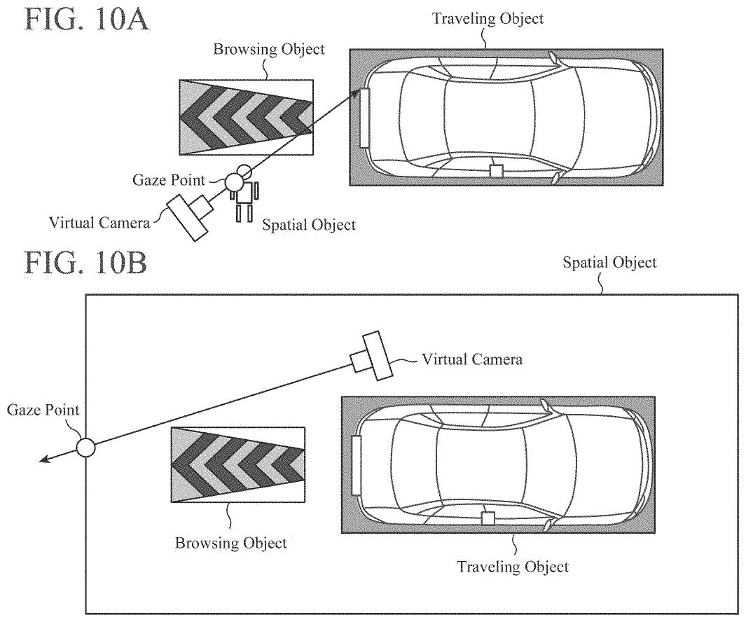

FIGS. 10A and 10B are arrangement diagrams illustrating an example of a positional relationship among a traveling object, a browsing object, a spatial object, and a virtual camera as viewed from above a virtual 3D object indicating a vehicle that is the traveling object in the virtual 3D space according to the first embodiment. In particular, the spatial object illustrated in FIG. 10A illustrates a virtual 3D object indicating a person. Furthermore, the spatial object illustrated in FIG. 10B illustrates a rectangular parallelepiped virtual 3D object indicating the periphery surrounding the traveling object, the browsing object, and the virtual camera.

As illustrated in FIG. 10A or FIG. 10B, the gaze point determining unit 130 can determine any one point of the spatial object as the gaze point.

More specifically, for example, the gaze point determining unit 130 determines, as the gaze point, any one point of the traveling object, the browsing object, or the spatial object on the basis of the operation input information acquired by the operation information acquiring unit 110. For example, in a case where the input device 20 is a mouse, the user gives an instruction to change the virtual camera photographing direction by changing a display angle of the traveling object or the browsing object in the photographed image by performing a so-called drag operation. Alternatively, the user can also give an instruction to change the virtual camera photographing direction by operating the input device 20 to designate any one point of the traveling object or the browsing object in the photographed image displayed on the display device 40. The gaze point determining unit 130 determines, as the gaze point, a point closest to the virtual camera among points at which a straight line passing through the virtual camera photographing position and extending in the instructed virtual camera photographing direction intersects with the traveling object, the browsing object, or the spatial object.

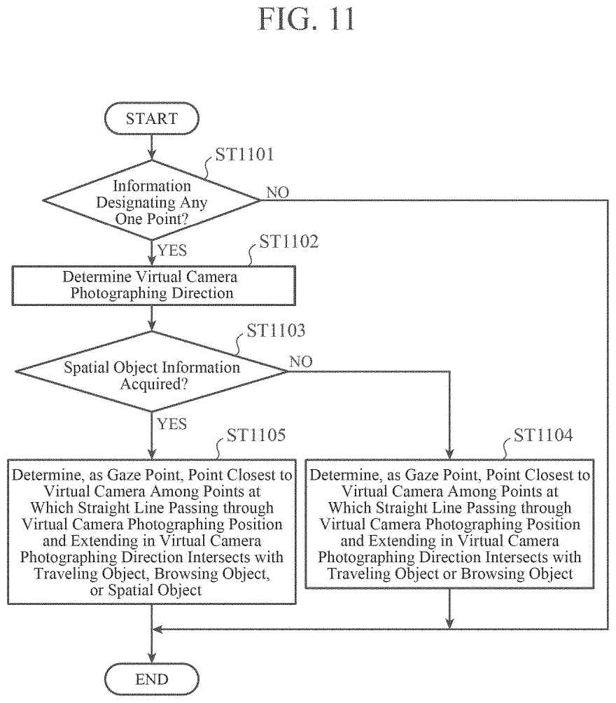

An operation in which the virtual camera control device 100 according to the first embodiment determines a gaze point will be described with reference to FIG. 11.

FIG. 11 is a flowchart illustrating an example of processing in which the virtual camera control device 100 according to the first embodiment determines a gaze point.

For example, every time the operation information acquiring unit 110 acquires the operation input information, the virtual camera control device 100 repeatedly executes the processing of the flowchart.

First, in step ST1101, the gaze point determining unit 130 determines whether or not the operation input information acquired by the operation information acquiring unit 110 is information designating any one point in the photographed image.

In step ST1101, when the gaze point determining unit 130 has determined that the operation input information acquired by the operation information acquiring unit 110 is not information designating any one point in the photographed image, the virtual camera control device 100 ends the processing of the flowchart.

In step ST1101, in a case where the gaze point determining unit 130 has determined that the operation input information acquired by the operation information acquiring unit 110 is information designating any one point in the photographed image, in step ST1102, the gaze point determining unit 130 determines the virtual camera photographing direction on the basis of the operation input information acquired by the operation information acquiring unit 110.

After step ST1102, in step ST1103, the spatial object determining unit 150 determines whether or not the virtual 3D object information acquiring unit 120 has acquired spatial object information.

In step ST1103, in a case where the spatial object determining unit 150 has determined that the virtual 3D object information acquiring unit 120 has not acquired spatial object information, the gaze point determining unit 130 performs processing of step ST1104. In step ST1104, the gaze point determining unit 130 determines, as the gaze point, a point closest to the virtual camera among points at which the virtual camera photographing direction intersects with the traveling object or the browsing object on the basis of the information indicating the virtual camera photographing direction determined by the gaze point determining unit 130 and the position or area of the traveling object in the virtual 3D space or the position or area of the browsing object in the virtual 3D space.

After step ST1104, the virtual camera control device 100 ends the processing of the flowchart.

In step ST1103, in a case where the spatial object determining unit 150 has determined that the virtual 3D object information acquiring unit 120 has acquired spatial object information, the gaze point determining unit 130 performs processing of step ST1105. In step ST1105, the gaze point determining unit 130 determines, as the gaze point, a point closest to the virtual camera among points at which the virtual camera photographing direction intersects with the traveling object, the browsing object, or the spatial object on the basis of the information indicating the virtual camera photographing direction determined by the gaze point determining unit 130, and the position or area of the traveling object in the virtual 3D space, the position or area of the browsing object in the virtual 3D space, and the position or area of the spatial object in the virtual 3D space.

After step ST1105, the virtual camera control device 100 ends the processing of the flowchart.

Note that the flowchart illustrated in FIG. 11 is an example, and the processing in which the virtual camera control device 100 determines the gaze point is not limited to the flowchart illustrated in FIG. 11.

For example, the virtual camera control device 100 may determine the gaze point by the following method.

First, the gaze point determining unit 130 changes the virtual camera photographing direction on the basis of the operation input information acquired by the operation information acquiring unit 110. More specifically, for example, in a case where the input device 20 is a mouse, the user gives an instruction to change the virtual camera photographing direction by performing a so-called drag operation. The gaze point determining unit 130 determines a gaze point on the basis of the virtual camera photographing position and the changed virtual camera photographing direction.

By the virtual camera control device 100 controlling the virtual camera with any one point of the traveling object, the browsing object, or the spatial object as the gaze point, the display control device 10 can simulate how the browsing object looks in a state where one point in the 3D space different from both the browsing object and the traveling object is gazed at from various positions around the traveling object, and display the result.

As described above, the virtual camera control device 100 includes the gaze point determining unit 130 that determines, as a gaze point, any one point of the traveling object or the browsing object, which is the virtual 3D object, disposed in the virtual 3D space, and the virtual camera traveling unit 140 that moves the virtual camera while keeping the photographing direction of the virtual camera photographing an inside of the virtual 3D space and disposed in the virtual 3D space in the direction from the virtual camera toward the gaze point determined by the gaze point determining unit 130 and keeping the distance from the virtual camera to the traveling object at a fixed distance.

With this configuration, the virtual camera control device 100 can set a virtual 3D object different from the browsing object as the traveling object.

Furthermore, in the above-described configuration, when the virtual camera photographing direction is designated, the gaze point determining unit 130 is configured to determine, as the gaze point, a point closest to the virtual camera among points at which the designated virtual camera photographing direction intersects with the traveling object or the browsing object.

With this configuration, the virtual camera control device 100 can automatically determine the gaze point from the virtual camera photographing direction designated by the user.

Furthermore, in the above-described configuration, the virtual camera traveling unit 140 is configured to move the virtual camera to a position where the distance from the virtual camera to the second surface of the traveling object becomes a fixed distance in a case where the distance from the virtual camera to the second surface of the traveling object becomes shorter than the fixed distance when the virtual camera traveling unit 140 moves the virtual camera while keeping the distance from the virtual camera to the first surface of the traveling object at the fixed distance.

With this configuration, the virtual camera control device 100 can move the virtual camera depending on the shape of the traveling object.

Furthermore, in the above-described configuration, the gaze point determining unit 130 is configured to determine, as the gaze point, any one point of the traveling object, the browsing object, or the spatial object, which is the virtual 3D object.

With this configuration, the virtual camera control device 100 can simulate how the browsing object looks in a state where one point in the 3D space different from both the browsing object and the traveling object is gazed at from various positions around the traveling object, and display the result.

Furthermore, in the above-described configuration, when the virtual camera photographing direction is designated, the gaze point determining unit 130 is configured to determine, as the gaze point, a point closest to the virtual camera among points at which a straight line passing through the position of the virtual camera and extending in the designated virtual camera photographing direction intersects with the traveling object, the browsing object, or the spatial object.

With this configuration, the virtual camera control device 100 can automatically determine the gaze point from the virtual camera photographing direction designated by the user in a case where the traveling object, the browsing object, and the spatial object exist in the virtual 3D space.

Furthermore, in the above-described configuration, when moving the virtual camera or changing the photographing direction, the virtual camera traveling unit 140 is configured to generate virtual camera information including information on the position of the virtual camera and information on the photographing direction, and output the generated virtual camera information to the image generating unit 13 that generates an image in which the virtual camera has photographed the virtual 3D object on the basis of the virtual camera information.

With this configuration, the virtual camera control device 100 can cause the display device 40 via the image generating unit 13 included in the display control device 10 to display, like a moving image, the photographed image in the process of moving the virtual camera from the state where the second distance has become less than the fixed distance to the position where the second distance has become the fixed distance. Therefore, the user can visually recognize that the virtual camera cannot be moved any more in the direction in which the virtual camera has been moved.

### Second Embodiment

The virtual camera control device 100 according to the first embodiment does not consider the photographing state of the browsing object when controlling the movement of the virtual camera. In a second embodiment, an embodiment will be described in which movement of a virtual camera is controlled in consideration of a photographing state of a browsing object.

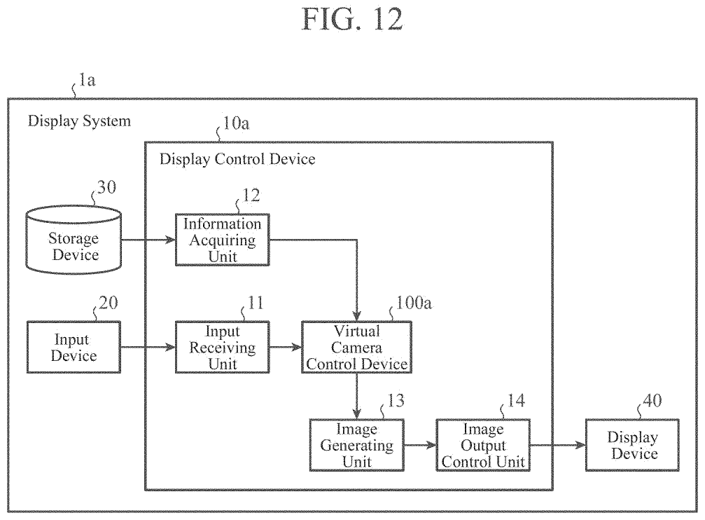

A virtual camera control device 100a according to the second embodiment will be described with reference to FIGS. 12 to 15.

A configuration of a main part of a display control device 10a to which the virtual camera control device 100a according to the second embodiment is applied will be described with reference to FIG. 12.

FIG. 12 is a block diagram illustrating an example of a configuration of a main part of a display system 1a to which the display control device 10a according to the second embodiment is applied.

The display system 1a includes a display control device 10a, an input device 20, a storage device 30, and a display device 40.

The display system 1a according to the second embodiment is obtained by changing the display control device 10 in the display system 1 according to the first embodiment to the display control device 10a.

In the configuration of the display system 1a according to the second embodiment, the same reference numerals are given to the same components as the display system 1 according to the first embodiment, and duplicate description thereof will be omitted. That is, the description of the components of FIG. 12 having the same reference numerals as those shown in FIG. 1 will be omitted.

The display control device 10a includes an information processing device such as a general-purpose PC.

The display control device 10a includes an input receiving unit 11, an information acquiring unit 12, a virtual camera control device 100a, an image generating unit 13, and an image output control unit 14.

The display control device 10a according to the second embodiment is obtained by changing the virtual camera control device 100 in the display control device 10 according to the first embodiment to the virtual camera control device 100a.

In the configuration of the display control device 10a according to the second embodiment, the same reference numerals are given to the same components as the display control device 10 according to the first embodiment, and duplicate description thereof will be omitted. That is, the description of the components of FIG. 12 having the same reference numerals as those shown in FIG. 1 will be omitted.

The virtual camera control device 100a acquires virtual 3D object information and operation input information, and controls a virtual camera photographing position and a virtual camera photographing direction of a virtual camera disposed in the virtual 3D space on the basis of the acquired virtual 3D object information and operation input information. The virtual camera control device 100a outputs the acquired virtual 3D object information and virtual camera information to the image generating unit 13.

The virtual camera information includes camera position information indicating the virtual camera photographing position and camera direction information indicating the virtual camera photographing direction. The virtual camera information may include camera view angle information indicating a view angle at which the virtual camera photographs an image, and the like, in addition to the camera position information and the camera direction information.

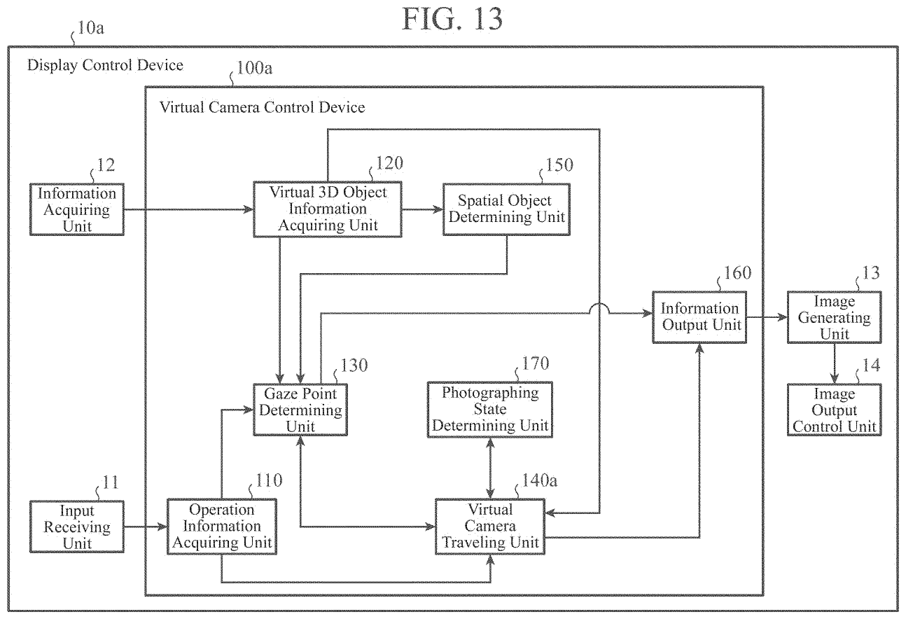

A configuration of a main part of the virtual camera control device 100a according to the second embodiment will be described with reference to FIG. 13.

FIG. 13 is a block diagram showing an example of a configuration of a main part of the virtual camera control device 100a according to the second embodiment.

The virtual camera control device 100a includes an operation information acquiring unit 110, a virtual 3D object information acquiring unit 120, a gaze point determining unit 130, a virtual camera traveling unit 140a, a photographing state determining unit 170, and an information output unit 160.

The virtual camera control device 100a may include a spatial object determining unit 150 in addition to the above-described configuration. The virtual camera control device 100a illustrated in FIG. 13 includes the spatial object determining unit 150.

In the virtual camera control device 100a according to the second embodiment, the virtual camera traveling unit 140 in the virtual camera control device 100 according to the first embodiment is changed to the virtual camera traveling unit 140a, and the photographing state determining unit 170 is added.

In the configuration of the virtual camera control device 100a according to the second embodiment, the same reference numerals are given to the same components as the virtual camera control device 100 according to the first embodiment, and duplicate description thereof will be omitted. That is, the description of the components of FIG. 13 having the same reference numerals as those shown in FIG. 2 will be omitted.

Note that each function of the operation information acquiring unit 110, the virtual 3D object information acquiring unit 120, the gaze point determining unit 130, the virtual camera traveling unit 140a, the photographing state determining unit 170, the information output unit 160, and the spatial object determining unit 150 in the virtual camera control device 100a according to the second embodiment may be implemented by the processor 201 and the memory 202 or may be implemented by the processing circuit 203 in the hardware configuration illustrated as an example in FIGS. 3A and 3B in the first embodiment.

The operation input information acquired by the operation information acquiring unit 110 is input to the virtual camera traveling unit 140a. On the basis of the operation input information acquired by the operation information acquiring unit 110, the virtual camera traveling unit 140a temporarily moves the virtual camera while keeping the virtual camera photographing direction in the direction from the virtual camera toward the gaze point determined by the gaze point determining unit 130 and keeping the distance from the virtual camera to the traveling object at a fixed distance. The virtual camera traveling unit 140a generates virtual camera information on the virtual camera after the temporary movement, and outputs the virtual camera information to the photographing state determining unit 170. Furthermore, the virtual camera traveling unit 140a outputs the virtual 3D object information acquired from the virtual 3D object information acquiring unit 120 to the photographing state determining unit 170.

The photographing state determining unit 170 determines the photographing state of the browsing object in the virtual camera on the basis of the browsing object information and the traveling object information included in the virtual 3D object information, and the virtual camera information.

Specifically, the photographing state determining unit 170 determines whether or not the virtual camera after the movement is in a state of photographing at least a part of the browsing object. The photographing state determining unit 170 outputs the determination result to the virtual camera traveling unit 140a.

In a case where the determination result acquired from the photographing state determining unit 170 indicates that the virtual camera after the movement is in a state of photographing at least a part of the browsing object, the virtual camera traveling unit 140a moves the virtual camera on the basis of the operation input information acquired by the operation information acquiring unit 110. At the time of this movement, the virtual camera traveling unit 140a moves the virtual camera while keeping the virtual camera photographing direction in the direction from the virtual camera toward the gaze point determined by the gaze point determining unit 130 and keeping the distance from the virtual camera to the traveling object at a fixed distance. The virtual camera traveling unit 140a generates virtual camera information on the virtual camera after the movement, and outputs the virtual camera information to the information output unit 160.

In addition, in a case where the determination result acquired from the photographing state determining unit 170 indicates that the virtual camera is not in a state of photographing at least a part of the browsing object at the position of the virtual camera after the movement, that is, indicates that the virtual camera is in a state of not photographing the browsing object at all, the virtual camera traveling unit 140a ignores the operation input information acquired by the operation information acquiring unit 110 so as not to move the virtual camera.

That is, on the basis of the operation input information acquired by the operation information acquiring unit 110, the virtual camera traveling unit 140a moves the virtual camera within the range of the position where the virtual camera can photograph at least a part of the browsing object when moving the virtual camera while keeping the virtual camera photographing direction in the direction from the virtual camera toward the gaze point determined by the gaze point determining unit 130 and keeping the distance from the virtual camera to the traveling object at a fixed distance.

Note that the user inputs the moving direction of the virtual camera by operating, for example, an arrow key of the input device 20 such as a keyboard.

Furthermore, the information indicating the fixed distance may be held in advance by the virtual camera traveling unit 140a, or may be provided to the virtual camera traveling unit 140a via the input receiving unit 11 by the user operating the input device 20.

Hereinafter, as an example, a case where the display control device 10a is used as a device that performs simulation on a road surface image will be described. Hereinafter, a description will be given assuming that the traveling object is a virtual 3D object indicating a vehicle in a virtual 3D space, and the browsing object is a virtual 3D object indicating a road surface image in the virtual 3D space.

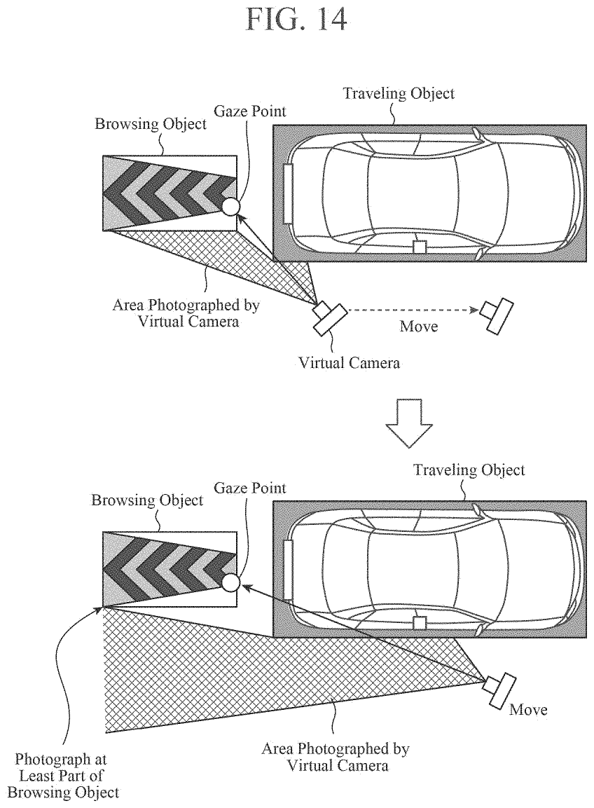

FIG. 14 is an arrangement diagram illustrating an example of a positional relationship among a traveling object, a browsing object, and a virtual camera as viewed from above a virtual 3D object indicating a vehicle that is the traveling object in a virtual 3D space according to the second embodiment.

Hereinafter, as illustrated in FIG. 14, a description will be given assuming that the gaze point is already determined as one point in the browsing object that is the virtual 3D object indicating the road surface image by the gaze point determining unit 130.

For example, the virtual camera traveling unit 140a moves the virtual camera on the basis of the operation input information acquired by the operation information acquiring unit 110. Specifically, as illustrated in FIG. 14, the virtual camera traveling unit 140a moves the virtual camera while keeping the virtual camera photographing direction in the direction from the virtual camera toward the gaze point determined by the gaze point determining unit 130 and keeping the distance from the virtual camera to the traveling object at a fixed distance. At the time of this movement, the virtual camera traveling unit 140a moves the virtual camera within a range of a position where the virtual camera can photograph at least a part of the browsing object.

Note that although FIG. 14 illustrates, as an example, a case where the gaze point is any one point in the browsing object, the gaze point may be any one point in the traveling object. Also in a case where the gaze point is any one point in the traveling object, the processing in which the virtual camera traveling unit 140a moves the virtual camera is similar to the processing in a case where the gaze point is any one point in the browsing object. Therefore, the description of a case where the gaze point is any one point in the traveling object will be omitted.

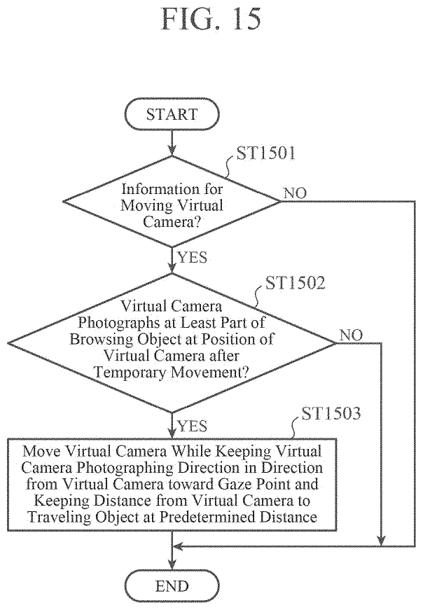

An operation in which the virtual camera control device 100a according to the second embodiment moves the virtual camera will be described with reference to FIG. 15.

FIG. 15 is a flowchart illustrating an example of processing in which the virtual camera control device 100a according to the second embodiment moves the virtual camera.

For example, every time the operation information acquiring unit 110 acquires the operation input information, the virtual camera control device 100a repeatedly executes the processing of the flowchart.

First, in step ST1501, the virtual camera traveling unit 140a determines whether or not the operation input information acquired by the operation information acquiring unit 110 is information for moving the virtual camera.

In step ST1501, when the virtual camera traveling unit 140a has determined that the operation input information acquired by the operation information acquiring unit 110 is not information for moving the virtual camera, the virtual camera control device 100a ends the processing of the flowchart.

In step ST1501, when the virtual camera traveling unit 140a has determined that the operation input information acquired by the operation information acquiring unit 110 is information for moving the virtual camera, the virtual camera traveling unit 140a performs processing of step ST1502. In step ST1502, the virtual camera traveling unit 140a causes the photographing state determining unit 170 to determine whether or not the virtual camera after the temporary movement is in a state of photographing at least a part of the browsing object when the virtual camera traveling unit 140a temporarily moves the virtual camera while keeping the distance from the virtual camera to the traveling object at a fixed distance.

In step ST1502, when the photographing state determining unit 170 has determined that the virtual camera after the temporary movement is not in a state of photographing at least a part of the browsing object, that is, has determined that the virtual camera after the temporary movement is in a state of not photographing the browsing object at all, the virtual camera control device 100a ends the processing of the flowchart.

In step ST1502, when the photographing state determining unit 170 has determined that the virtual camera after the temporary movement is in a state of photographing at least a part of the browsing object, in step ST1503, the virtual camera traveling unit 140a moves the virtual camera while keeping the virtual camera photographing direction in a direction from the virtual camera toward the gaze point determined by the gaze point determining unit 130 and keeping the distance from the virtual camera to the traveling object at a fixed distance, on the basis of the operation input information acquired by the operation information acquiring unit 110.

After step ST1503, the virtual camera control device 100a ends the processing of the flowchart.

As described above, by the virtual camera control device 100a according to the second embodiment controlling the virtual camera, the display control device 10a can suppress a state in which the browsing object is not displayed on the display device 40.

Note that, in the above description, it has been described that the virtual camera traveling unit 140a in the virtual camera control device 100a moves the virtual camera within the range of the position where the virtual camera can photograph at least a part of the browsing object, but it is not limited thereto. For example, the virtual camera traveling unit 140a may move the virtual camera within a range of positions where the virtual camera can photograph the entire browsing object. Note that the entire browsing object mentioned here is the entire outer shape of the browsing object that can be visually recognized when the browsing object is viewed from any direction.

Furthermore, in the above description, it has been described that the gaze point determining unit 130 determines any one point of the traveling object or the browsing object as the gaze point, but it is not limited thereto. For example, the virtual camera control device 100a may include the spatial object determining unit 150, and in a case where the spatial object determining unit 150 has determined that the virtual 3D object information acquiring unit 120 has acquired the spatial object information, the gaze point determining unit 130 may determine, as the gaze point, any one point of the traveling object, the browsing object, or the spatial object.

The operation of the virtual camera traveling unit 140a in a case where the gaze point determining unit 130 determines, as the gaze point, any one point of the traveling object, the browsing object, or the spatial object is similar to the operation of the virtual camera traveling unit 140a described so far, and thus the description thereof will be omitted.

As described above, the virtual camera control device 100a includes the gaze point determining unit 130 that determines, as a gaze point, any one point of the traveling object or the browsing object, which is the virtual 3D object, disposed in the virtual 3D space, and the virtual camera traveling unit 140a that moves the virtual camera while keeping the photographing direction of the virtual camera photographing an inside of the virtual 3D space and disposed in the virtual 3D space in the direction from the virtual camera toward the gaze point determined by the gaze point determining unit 130 and keeping the distance from the virtual camera to the traveling object at a fixed distance, and the virtual camera traveling unit 140a is configured to move the virtual camera within the range of the position where the virtual camera can photograph at least a part of the browsing object.

With this configuration, the virtual camera control device 100a can set a virtual 3D object different from the browsing object as the traveling object, and at the same time, can suppress the browsing object from deviating entirely from the photographing range.

Furthermore, as described above, the virtual camera control device 100a includes the gaze point determining unit 130 that determines any one point of the traveling object or the browsing object, which is the virtual 3D object, disposed in the virtual 3D space as the gaze point, and the virtual camera traveling unit 140a that moves the virtual camera while keeping the photographing direction of the virtual camera photographing the inside of the virtual 3D space and disposed in the virtual 3D space in the direction from the virtual camera toward the gaze point determined by the gaze point determining unit 130 and keeping the distance from the virtual camera to the traveling object at a fixed distance, and the virtual camera traveling unit 140a is configured to move the virtual camera within the range of the position where the virtual camera can photograph the entire browsing object.

With this configuration, the virtual camera control device 100a can set a virtual 3D object different from the browsing object as the traveling object, and at the same time, can suppress the browsing object from deviating even partially from the photographing range.

### Third Embodiment

The virtual camera control device 100a according to the second embodiment temporarily moves the virtual camera on the basis of the operation input information, and in a case where the virtual camera after the temporary movement does not photograph the browsing object at all or does not photograph a part thereof, ignores the operation input information so as not to move the virtual camera. In a third embodiment, an embodiment will be described in which a virtual camera is moved on the basis of operation input information, and in a case where the virtual camera after the movement does not photograph the browsing object at all or does not photograph a part thereof, the virtual camera is moved to a position where the virtual camera is in a state of photographing a part or all of the browsing object.

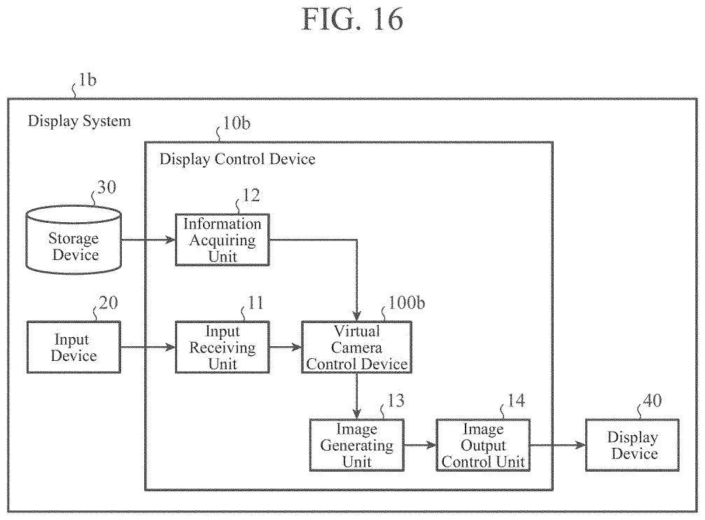

A virtual camera control device 100b according to the third embodiment will be described with reference to FIGS. 16 to 19.

With reference to FIG. 16, a configuration of a main part of a display control device 10b to which the virtual camera control device 100b according to the third embodiment is applied will be described.

FIG. 16 is a block diagram illustrating an example of a configuration of a main part of a display system 1b to which the display control device 10b according to the third embodiment is applied.

The display system 1b includes the display control device 10b, an input device 20, a storage device 30, and a display device 40.

The display system 1b according to the third embodiment is obtained by changing the display control device 10 in the display system 1 according to the first embodiment to the display control device 10b.

In the configuration of the display system 1b according to the third embodiment, the same reference numerals are given to the same components as the display system 1 according to the first embodiment, and duplicate description thereof will be omitted. That is, the description of the component of FIG. 16 having the same reference numerals as those shown in FIG. 1 will be omitted.

The display control device 10b includes an information processing device such as a general-purpose PC.

The display control device 10b includes an input receiving unit 11, an information acquiring unit 12, a virtual camera control device 100b, an image generating unit 13, and an image output control unit 14.

The display control device 10b according to the third embodiment is obtained by changing the virtual camera control device 100 in the display control device 10 according to the first embodiment to the virtual camera control device 100b.

In the configuration of the display control device 10b according to the third embodiment, the same reference numerals are given to the same components as the display control device 10 according to the first embodiment, and duplicate description thereof will be omitted. That is, the description of the component of FIG. 16 having the same reference numerals as those shown in FIG. 1 will be omitted.

The virtual camera control device 100b acquires virtual 3D object information and operation input information, and controls a virtual camera photographing position and a virtual camera photographing direction of a virtual camera disposed in the virtual 3D space on the basis of the acquired virtual 3D object information and operation input information. The virtual camera control device 100b outputs the acquired virtual 3D object information and virtual camera information to the image generating unit 13.

The virtual camera information includes camera position information indicating the virtual camera photographing position and camera direction information indicating the virtual camera photographing direction. The virtual camera information may include camera view angle information indicating a view angle at which the virtual camera photographs an image, and the like, in addition to the camera position information and the camera direction information.

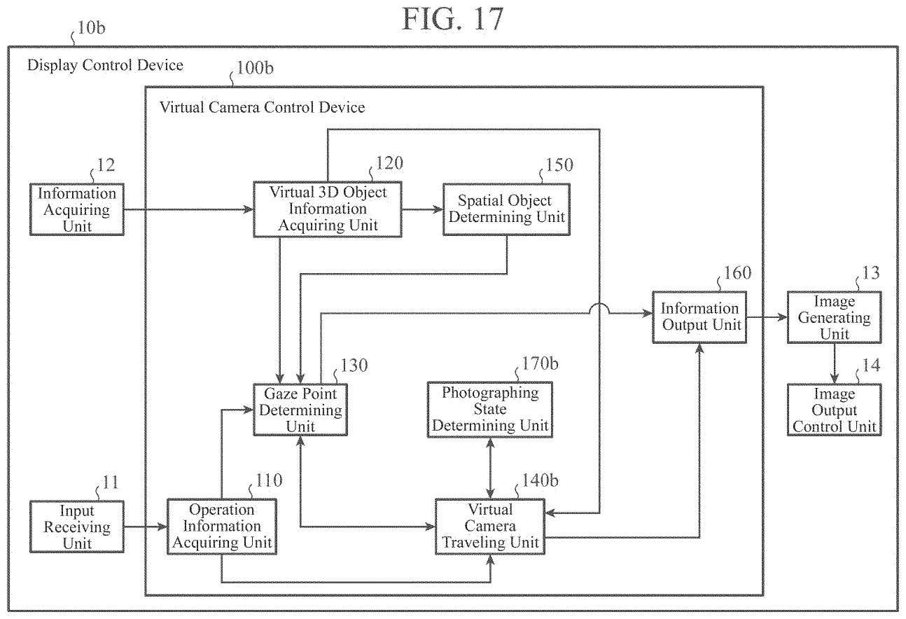

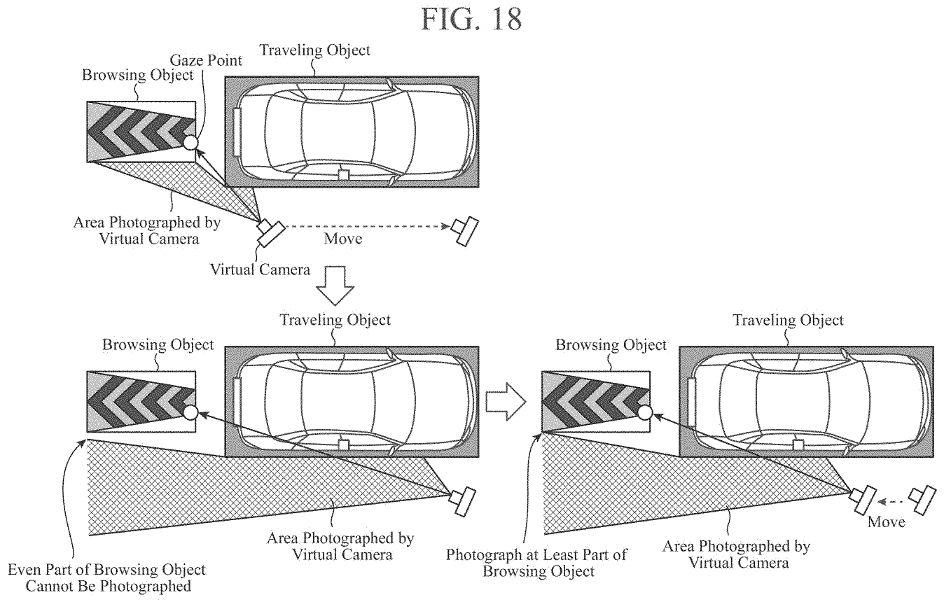

A configuration of a main part of the virtual camera control device 100b according to the third embodiment will be described with reference to FIG. 17.

FIG. 17 is a block diagram illustrating an example of a configuration of a main part of the virtual camera control device 100b according to the third embodiment.

The virtual camera control device 100b includes an operation information acquiring unit 110, a virtual 3D object information acquiring unit 120, a gaze point determining unit 130, a virtual camera traveling unit 140b, a photographing state determining unit 170b, and an information output unit 160.

The virtual camera control device 100b may include a spatial object determining unit 150 in addition to the above-described configuration. The virtual camera control device 100b illustrated in FIG. 17 includes the spatial object determining unit 150.

In the virtual camera control device 100b according to the third embodiment, the virtual camera traveling unit 140 in the virtual camera control device 100 according to the first embodiment is changed to the virtual camera traveling unit 140b, and the photographing state determining unit 170b is added.

In the configuration of the virtual camera control device 100b according to the third embodiment, the same reference numerals are given to the same components as the virtual camera control device 100 according to the first embodiment, and duplicate description thereof will be omitted. That is, the description of the component of FIG. 17 having the same reference numerals as those shown in FIG. 2 will be omitted.

Note that each function of the operation information acquiring unit 110, the virtual 3D object information acquiring unit 120, the gaze point determining unit 130, the virtual camera traveling unit 140b, the photographing state determining unit 170b, the information output unit 160, and the spatial object determining unit 150 in the virtual camera control device 100b according to the third embodiment may be implemented by the processor 201 and the memory 202 in the first embodiment or may be implemented by the processing circuit 203 in the hardware configuration illustrated as an example in FIGS. 3A and 3B.

The operation input information acquired by the operation information acquiring unit 110 is input to the virtual camera traveling unit 140b. On the basis of the operation input information acquired by the operation information acquiring unit 110, the virtual camera traveling unit 140b moves the virtual camera while keeping the virtual camera photographing direction in the direction from the virtual camera toward a gaze point determined by the gaze point determining unit 130 and keeping the distance from the virtual camera to the traveling object at a fixed distance. The virtual camera traveling unit 140b generates virtual camera information on the virtual camera after the movement, and outputs the virtual camera information to the information output unit 160 and the photographing state determining unit 170b. Furthermore, the virtual camera traveling unit 140b outputs the virtual 3D object information acquired from the virtual 3D object information acquiring unit 120 to the photographing state determining unit 170b.

The photographing state determining unit 170b determines the photographing state of the browsing object in the virtual camera on the basis of the browsing object information and the traveling object information included in the virtual 3D object information, and the virtual camera information.

Specifically, the photographing state determining unit 170b determines whether or not the virtual camera is in a state of photographing at least a part of the browsing object. The photographing state determining unit 170b outputs the determination result to the virtual camera traveling unit 140b.

In a case where the determination result acquired from the photographing state determining unit 170b indicates that the virtual camera is not in a state of photographing at least a part of the browsing object, that is, in a case where the determination result indicates that the virtual camera is in a state of not photographing the browsing object at all, the virtual camera traveling unit 140b moves the virtual camera to a position where the virtual camera is in a state of photographing at least a part of the browsing object.

Specifically, for example, the virtual camera traveling unit 140b moves the virtual camera by a predetermined movement amount in a direction opposite to the movement direction indicated by the operation input information from the virtual camera photographing position in a state where the virtual camera does not photograph the browsing object at all. The virtual camera traveling unit 140b generates virtual camera information on the virtual camera after moving by the predetermined movement amount, and outputs the virtual camera information to the photographing state determining unit 170b. The photographing state determining unit 170b determines a photographing state, and outputs a determination result to the virtual camera traveling unit 140b. The virtual camera traveling unit 140b repeats the above-described processing until the determination result acquired from the photographing state determining unit 170b indicates that the virtual camera after the movement by the predetermined movement amount is in a state of photographing at least a part of the browsing object. By performing such processing, the virtual camera traveling unit 140b can move the virtual camera to a position where the virtual camera is in a state of photographing at least a part of the browsing object.

Furthermore, for example, in a case where it is determined that the virtual camera is not in a state of photographing at least a part of the browsing object, that is, in a case where it is determined that the virtual camera is in a state of not photographing the browsing object at all, the photographing state determining unit 170b calculates the virtual camera photographing position at which the virtual camera is in a state of photographing at least a part of the browsing object. The photographing state determining unit 170b outputs information of the calculated virtual camera photographing position to the virtual camera traveling unit 140b. By moving the virtual camera on the basis of the information, the virtual camera traveling unit 140b can move the virtual camera to a position where it is in a state of photographing at least a part of the browsing object.

Also when moving the virtual camera from a position where the virtual camera does not photograph the browsing object at all to a position where it photographs at least a part of the browsing object, the virtual camera traveling unit 140b moves the virtual camera while keeping the virtual camera photographing direction in a direction from the virtual camera to a gaze point determined by the gaze point determining unit 130 and keeping the distance from the virtual camera to the traveling object at a fixed distance. The virtual camera traveling unit 140b generates virtual camera information and outputs the virtual camera information to the information output unit 160, for example, while the virtual camera traveling unit 140b moves the virtual camera from a position where the virtual camera does not photograph a browsing object at all to a position where it photographs at least a part of the browsing object.

By the virtual camera control device 100b controlling the virtual camera in this manner, the display control device 10b can suppress, when moving the virtual camera, a state in which the browsing object is not displayed on the display device 40.

Furthermore, on the display device 40, a process from a state in which the virtual camera does not photograph the browsing object at all to a state in which it photographs at least a part of the browsing object is displayed like a moving image. Therefore, the display control device 10b can cause the user to visually recognize that the virtual camera cannot be moved any more in the direction in which the user has moved the virtual camera.

Note that the virtual camera traveling unit 140b may not generate virtual camera information while the virtual camera traveling unit 140b moves the virtual camera from a position where the virtual camera does not photograph the browsing object at all to a position where it photographs at least a part of the browsing object or, after generating virtual camera information, may not output the virtual camera information to the information output unit 160.

Note that the user inputs the moving direction of the virtual camera by operating, for example, an arrow key of the input device 20 such as a keyboard.

Furthermore, the information indicating the fixed distance may be held in advance by the virtual camera traveling unit 140b, or may be provided to the virtual camera traveling unit 140b via the input receiving unit 11 by the user operating the input device 20.

Hereinafter, as an example, a case where the display control device 10b is used as a device that performs simulation on a road surface image will be described. Hereinafter, a description will be given assuming that the traveling object is a virtual 3D object indicating a vehicle in a virtual 3D space, and the browsing object is a virtual 3D object indicating a road surface image in the virtual 3D space.

FIG. 18 is an arrangement diagram illustrating an example of a positional relationship among a traveling object, a browsing object, and a virtual camera, as viewed from above a virtual 3D object indicating a vehicle that is the traveling object in a virtual 3D space according to the third embodiment.

Hereinafter, as illustrated in FIG. 18, a description will be given assuming that the gaze point is already determined as one point in the browsing object that is the virtual 3D object indicating the road surface image by the gaze point determining unit 130.

For example, the virtual camera traveling unit 140b moves the virtual camera on the basis of the operation input information acquired by the operation information acquiring unit 110. When moving the virtual camera, the virtual camera traveling unit 140b moves the virtual camera while keeping the virtual camera photographing direction in the direction from the virtual camera toward the gaze point determined by the gaze point determining unit 130 and keeping the distance from the virtual camera to the traveling object at a fixed distance. When having moved the virtual camera to a position where the virtual camera does not photograph at least a part of the browsing object, that is, a position where the virtual camera does not photograph the browsing object at all, the virtual camera traveling unit 140b moves the virtual camera to a position where the virtual camera is in a state of photographing at least a part of the browsing object.

Note that, although FIG. 18 illustrates, as an example, a case where the gaze point is any one point in the browsing object, the gaze point may be any one point in the traveling object. Also in a case where the gaze point is any one point in the traveling object, the processing in which the virtual camera traveling unit 140b moves the virtual camera is similar to the processing in a case where the gaze point is any one point in the browsing object. Therefore, the description of the case where the gaze point is any one point in the traveling object will be omitted.

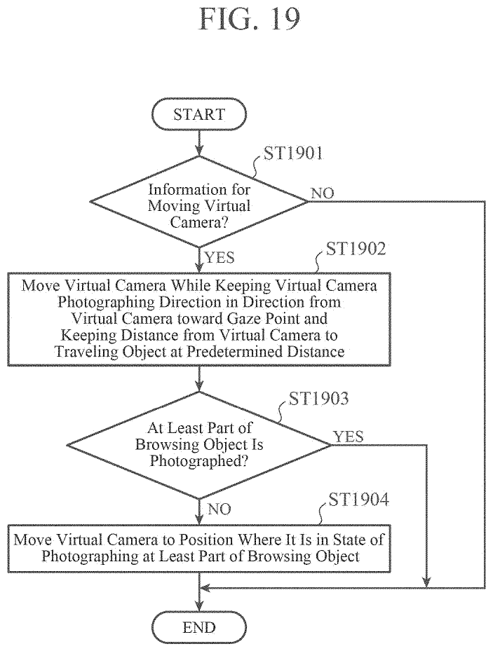

An operation in which the virtual camera control device 100b according to the third embodiment moves the virtual camera will be described with reference to FIG. 19.

FIG. 19 is a flowchart illustrating an example of processing in which the virtual camera control device 100b according to the third embodiment moves the virtual camera.

For example, every time the operation information acquiring unit 110 acquires the operation input information, the virtual camera control device 100b repeatedly executes the processing of the flowchart.

First, in step ST1901, the virtual camera traveling unit 140b determines whether or not the operation input information acquired by the operation information acquiring unit 110 is information for moving the virtual camera.

In step ST1901, when the virtual camera traveling unit 140b has determined that the operation input information acquired by the operation information acquiring unit 110 is not information for moving the virtual camera, the virtual camera control device 100b ends the processing of the flowchart.

In step ST1901, when the virtual camera traveling unit 140b has determined that the operation input information acquired by the operation information acquiring unit 110 is information for moving the virtual camera, the virtual camera traveling unit 140b performs processing of step ST1902. In step ST1902, on the basis of the operation input information acquired by the operation information acquiring unit 110, the virtual camera traveling unit 140b moves the virtual camera while keeping the virtual camera photographing direction in the direction from the virtual camera toward the gaze point determined by the gaze point determining unit 130 and keeping the distance from the virtual camera to the traveling object at a fixed distance.

After step ST1902, in step ST1903, the photographing state determining unit 170b determines whether or not the virtual camera is in a state of photographing at least a part of the browsing object.

In step ST1903, when the photographing state determining unit 170b has determined that the virtual camera is in a state of photographing at least a part of the browsing object, the virtual camera control device 100b ends the processing of the flowchart.

In step ST1903, when the photographing state determining unit 170b has determined that the virtual camera is not in a state of photographing at least a part of the browsing object, that is, has determined that the virtual camera is in a state of not photographing the browsing object at all, in step ST1904, the virtual camera traveling unit 140b moves the virtual camera to a position where the virtual camera is in a state of photographing at least a part of the browsing object.

After step ST1904, the virtual camera control device 100b ends the processing of the flowchart.

Note that, in the above description, it has been described that the virtual camera traveling unit 140b in the virtual camera control device 100b moves the virtual camera to a position where the virtual camera is in a state of photographing at least a part of the browsing object when having moved the virtual camera to a position where the virtual camera does not photograph the browsing object at all. However, it is not limited to this. For example, when having moved the virtual camera to a position where the virtual camera does not photograph the entire browsing object, the virtual camera traveling unit 140b may move the virtual camera to a position where the virtual camera is in a state of photographing the entire browsing object. More specifically, for example, when moving the virtual camera to a position where the virtual camera does not photograph the entire browsing object, the virtual camera traveling unit 140b may move the virtual camera to a position where the virtual camera is in a state of photographing the entire browsing object. Note that the entire browsing object mentioned here is the entire outer shape of the browsing object that can be visually recognized when the browsing object is viewed from any direction.

Furthermore, in the above description, it has been described that the gaze point determining unit 130 determines any one point of the traveling object or the browsing object as the gaze point, but it is not limited thereto. For example, the virtual camera control device 100b may include the spatial object determining unit 150, and in a case where the spatial object determining unit 150 has determined that the virtual 3D object information acquiring unit 120 has acquired the spatial object information, the gaze point determining unit 130 may determine any one point of the traveling object, the browsing object, or the spatial object as the gaze point.

The operation of the virtual camera traveling unit 140b in a case where the gaze point determining unit 130 determines any one point of the traveling object, the browsing object, or the spatial object as the gaze point is similar to the operation of the virtual camera traveling unit 140b described so far, and thus the description thereof will be omitted.

As described above, the virtual camera control device 100b includes the gaze point determining unit 130 that determines, as a gaze point, any one point of the traveling object or the browsing object, which is the virtual 3D object, disposed in the virtual 3D space, and the virtual camera traveling unit 140b that moves the virtual camera while keeping the photographing direction of the virtual camera photographing an inside of the virtual 3D space and disposed in the virtual 3D space in the direction from the virtual camera toward the gaze point determined by the gaze point determining unit 130 and keeping the distance from the virtual camera to the traveling object at a fixed distance, and when the virtual camera traveling unit 140b has moved the virtual camera to a position where the virtual camera does not photograph the browsing object at all, the virtual camera traveling unit 140b is configured to move the virtual camera to a position where the virtual camera is in a state of photographing at least a part of the browsing object.

With this configuration, the virtual camera control device 100b can set a virtual 3D object different from the browsing object as the traveling object, and at the same time, can suppress the browsing object from deviating entirely from the photographing range.

Furthermore, in the above-described configuration, when moving the virtual camera or changing the photographing direction, the virtual camera traveling unit 140b is configured to generate virtual camera information including information on the position of the virtual camera and information on the photographing direction, and output the generated virtual camera information to the image generating unit 13 that generates an image in which the virtual camera photographs the virtual 3D object on the basis of the virtual camera information.

With this configuration, the virtual camera control device 100b can cause the display device 40 via the image generating unit 13 included in the display control device 10b to display, like a moving image, the photographed image in the process of moving the virtual camera from the position where the virtual camera does not photograph the browsing object at all to the position where the virtual camera photographs at least a part of the browsing object. Therefore, the user can visually recognize that the virtual camera cannot be moved any more in the direction in which the virtual camera has been moved.

Furthermore, as described above, the virtual camera control device 100b includes: the gaze point determining unit 130 that determines, as a gaze point, any one point of the traveling object or the browsing object, which is the virtual 3D object, disposed in the virtual 3D space; and the virtual camera traveling unit 140b that moves the virtual camera while keeping the photographing direction of the virtual camera photographing an inside of the virtual 3D space and disposed in the virtual 3D space in the direction from the virtual camera toward the gaze point determined by the gaze point determining unit 130 and keeping the distance from the virtual camera to the traveling object at a fixed distance, in which when the virtual camera traveling unit 140b has moved the virtual camera to a position where the virtual camera does not photograph the entire browsing object, the virtual camera traveling unit 140b is configured to move the virtual camera to a position where the virtual camera is in a state of photographing the entire browsing object.

With this configuration, the virtual camera control device 100b can set a virtual 3D object different from the browsing object as the traveling object, and at the same time, can suppress the browsing object from deviating even partially from the photographing range.

Furthermore, in the above-described configuration, when moving the virtual camera or changing the photographing direction, the virtual camera traveling unit 140b is configured to generate virtual camera information including information on the position of the virtual camera and information on the photographing direction, and output the generated virtual camera information to the image generating unit 13 that generates an image in which the virtual camera photographs the virtual 3D object on the basis of the virtual camera information.

With this configuration, the virtual camera control device 100b can cause the display device 40 via the image generating unit 13 included in the display control device 10b to display, like a moving image, the photographed image in the process of moving the virtual camera from the position where the virtual camera does not photograph the entire browsing object to the position where the virtual camera is in a state of photographing the entire browsing object. Therefore, the user can visually recognize that the virtual camera cannot be moved any more in the direction in which the virtual camera has been moved.

### Fourth Embodiment

The virtual camera control devices 100a and 100b according to the second embodiment and the third embodiment consider the photographing state of the browsing object when changing the virtual camera photographing position. In a fourth embodiment, an embodiment will be described in which a photographing state of a browsing object is considered when a virtual camera photographing direction is changed on the basis of instruction input information.

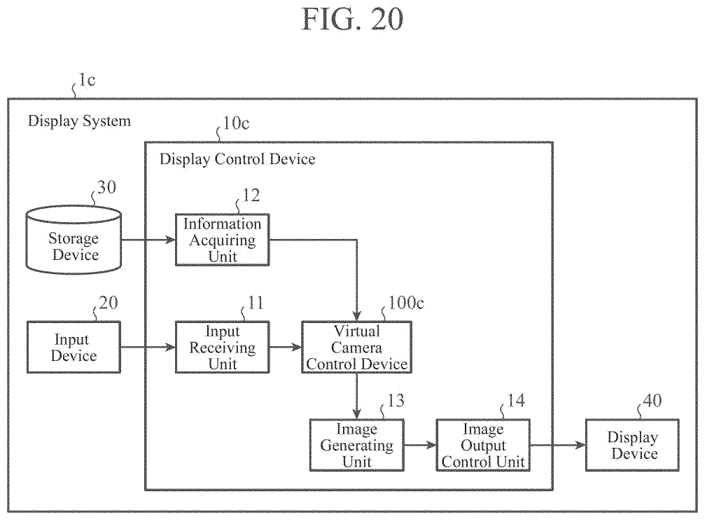

A virtual camera control device 100c according to the fourth embodiment will be described with reference to FIGS. 20 to 23.

With reference to FIG. 20, a configuration of a main part of a display control device 10c to which the virtual camera control device 100c according to the fourth embodiment is applied will be described.

FIG. 20 is a block diagram illustrating an example of a configuration of a main part of a display system 1c to which the display control device 10c according to the fourth embodiment is applied.

The display system 1c includes the display control device 10c, an input device 20, a storage device 30, and a display device 40.

The display system 1c according to the fourth embodiment is obtained by changing the display control device 10 in the display system 1 according to the first embodiment to the display control device 10c.

In the configuration of the display system 1c according to the fourth embodiment, the same reference numerals are given to the same components as the display system 1 according to the first embodiment, and duplicate description thereof will be omitted. That is, the description of the component of FIG. 20 having the same reference numerals as those shown in FIG. 1 will be omitted.

The display control device 10c includes an information processing device such as a general-purpose PC.

The display control device 10c includes an input receiving unit 11, an information acquiring unit 12, a virtual camera control device 100c, an image generating unit 13, and an image output control unit 14.

The display control device 10c according to the fourth embodiment is obtained by changing the virtual camera control device 100 in the display control device 10 according to the first embodiment to the virtual camera control device 100c.

In the configuration of the display control device 10c according to the fourth embodiment, the same reference numerals are given to the same configurations as the display control device 10 according to the first embodiment, and duplicate description thereof will be omitted. That is, the description of the configuration of FIG. 20 having the same reference numerals as those shown in FIG. 1 will be omitted.

The virtual camera control device 100c acquires virtual 3D object information and operation input information, and controls a virtual camera photographing position and a virtual camera photographing direction of a virtual camera disposed in a virtual 3D space on the basis of the acquired virtual 3D object information and operation input information. The virtual camera control device 100c outputs the acquired virtual 3D object information and virtual camera information to the image generating unit 13.

The virtual camera information includes camera position information indicating the virtual camera photographing position and camera direction information indicating the virtual camera photographing direction. The virtual camera information may include camera view angle information indicating a view angle at which the virtual camera photographs an image, and the like, in addition to the camera position information and the camera direction information.

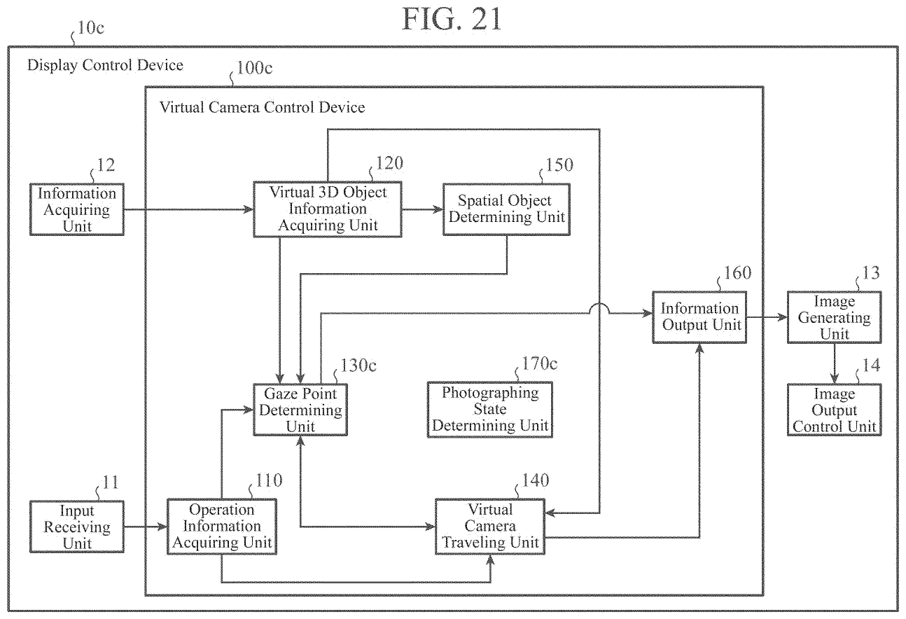

A configuration of a main part of the virtual camera control device 100c according to the fourth embodiment will be described with reference to FIG. 21.

FIG. 21 is a block diagram showing an example of a configuration of a main part of the virtual camera control device 100c according to the fourth embodiment.

The virtual camera control device 100c includes an operation information acquiring unit 110, a virtual 3D object information acquiring unit 120, a gaze point determining unit 130c, a virtual camera traveling unit 140, a photographing state determining unit 170c, and an information output unit 160.

The virtual camera control device 100c may include a spatial object determining unit 150 in addition to the above-described configuration. The virtual camera control device 100c illustrated in FIG. 21 includes the spatial object determining unit 150.

In the virtual camera control device 100c according to the fourth embodiment, the gaze point determining unit 130 in the virtual camera control device 100 according to the first embodiment is changed to the gaze point determining unit 130c, and the photographing state determining unit 170c is added.

In the configuration of the virtual camera control device 100c according to the fourth embodiment, the same reference numerals are given to the same components as the virtual camera control device 100 according to the first embodiment, and duplicate description thereof will be omitted. That is, the description of the component of FIG. 21 having the same reference numerals as those shown in FIG. 2 will be omitted.

Note that, each function of the operation information acquiring unit 110, the virtual 3D object information acquiring unit 120, the gaze point determining unit 130c, the virtual camera traveling unit 140, the photographing state determining unit 170c, the information output unit 160, and the spatial object determining unit 150 in the virtual camera control device 100c according to the fourth embodiment may be implemented by the processor 201 and the memory 202 or may be implemented by the processing circuit 203 in the hardware configuration illustrated as an example in FIGS. 3A and 3B in the first embodiment.

The gaze point determining unit 130c determines, as a gaze point, any one point of the traveling object or the browsing object. To the gaze point determining unit 130c, operation input information is input from the operation information acquiring unit 110, virtual 3D object information is input from the virtual 3D object information acquiring unit 120, and virtual camera information is input from the virtual camera traveling unit 140. The gaze point determining unit 130c determines, as a gaze point, any one point on the surface of the traveling object or the surface of the browsing object on the basis of the operation input information, the virtual 3D object information, and the virtual camera information.

The gaze point determining unit 130c, when determining the gaze point, first temporarily changes the virtual camera photographing direction on the basis of the operation input information acquired by the operation information acquiring unit 110.

Note that, the virtual camera photographing direction is also changed when there is operation input information for giving an instruction on movement of the virtual camera, that is, operation input information for giving an instruction on change of the virtual camera photographing position. On the other hand, the operation input information taken into consideration in the gaze point determining unit 130c when determining the gaze point is not operation input information for giving an instruction on movement of the virtual camera, but operation input information for giving an instruction on change of the virtual camera photographing direction without changing the virtual camera photographing position.

For example, in a case where the input device 20 is a mouse, the user gives an instruction to change the virtual camera photographing direction by performing a so-called drag operation to change the display angles of the traveling object and the browsing object in the photographed image. Alternatively, the user can also give an instruction to change the virtual camera photographing direction by operating the input device 20 to designate any one point of the traveling object or the browsing object in the photographed image displayed on the display device 40.

The gaze point determining unit 130c outputs virtual camera information including information on the virtual camera photographing direction after the temporary change to the photographing state determining unit 170c. Furthermore, the gaze point determining unit 130c outputs the virtual 3D object information acquired from the virtual 3D object information acquiring unit 120 to the photographing state determining unit 170c.

The photographing state determining unit 170c determines the photographing state of the browsing object by the virtual camera in the state of reflecting the virtual camera photographing direction after the temporary change on the basis of the virtual 3D object information and the virtual camera information.

Specifically, when the virtual camera is directed to the virtual camera photographing direction after the temporary change at the virtual camera photographing position indicated by the virtual camera information, the photographing state determining unit 170c determines whether or not the virtual camera is in a state of photographing at least a part of the browsing object. The photographing state determining unit 170c outputs the determination result to the gaze point determining unit 130c.

The gaze point determining unit 130c changes the virtual camera photographing direction in a case where the determination result acquired from the photographing state determining unit 170c indicates that the virtual camera is in a state of photographing at least a part of the browsing object. Then, the gaze point determining unit 130c determines a gaze point on the basis of the changed virtual camera photographing direction.

Furthermore, the gaze point determining unit 130c does not change the virtual camera photographing direction when the determination result acquired from the photographing state determining unit 170c indicates that the virtual camera is not in a state of photographing at least a part of the browsing object, that is, the virtual camera is in a state of not photographing the browsing object at all. In this case, the gaze point determining unit 130c does not perform gaze point decision processing by ignoring the operation input information.

That is, when changing the virtual camera photographing direction on the basis of the operation input information acquired by the operation information acquiring unit 110, the gaze point determining unit 130c changes the virtual camera photographing direction within the range of the direction in which the virtual camera can photograph at least a part of the browsing object, and determines the gaze point.

The gaze point determining unit 130c, when having performed the gaze point decision processing, outputs information on the determined gaze point to the virtual camera traveling unit 140. Alternatively, the gaze point determining unit 130c, when having performed the gaze point decision processing, outputs information on the determined gaze point and information on the changed virtual camera photographing direction to the virtual camera traveling unit 140.

The virtual camera traveling unit 140 changes the virtual camera photographing direction on the basis of the gaze point determined by the gaze point determining unit 130c or the changed virtual camera photographing direction. Thereafter, in a case where the operation input information for giving an instruction on the movement of the virtual camera is input from the operation information acquiring unit 110, the virtual camera traveling unit 140 moves the virtual camera while keeping the virtual camera photographing direction in the direction from the virtual camera toward the gaze point determined by the gaze point determining unit 130c and keeping the distance from the virtual camera to the traveling object at a fixed distance.

Hereinafter, as an example, a case where the display control device 10c is used as a device that performs simulation on a road surface image will be described. Hereinafter, a description will be given assuming that the traveling object is a virtual 3D object indicating a vehicle in a virtual 3D space, and the browsing object is a virtual 3D object indicating a road surface image in the virtual 3D space.

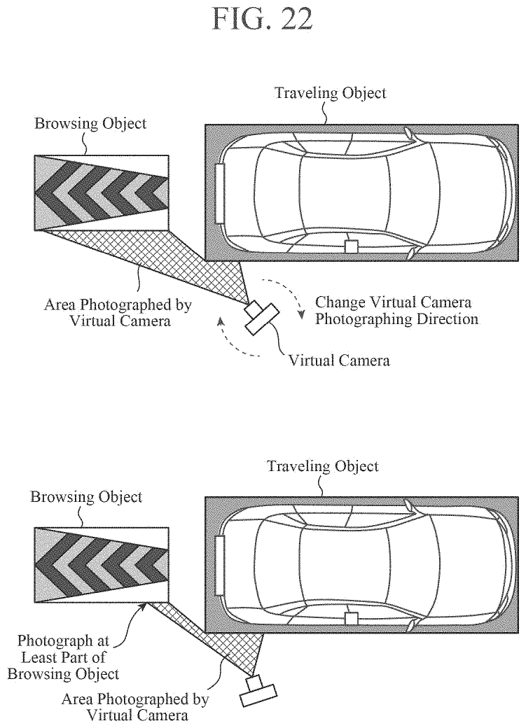

FIG. 22 is an arrangement diagram illustrating an example of a positional relationship among a traveling object, a browsing object, and a virtual camera as viewed from above a virtual 3D object indicating a vehicle that is the traveling object in a virtual 3D space according to the fourth embodiment.

For example, the gaze point determining unit 130c changes the virtual camera photographing direction on the basis of the operation input information acquired by the operation information acquiring unit 110. Specifically, as illustrated in FIG. 22, the gaze point determining unit 130c changes the virtual camera photographing direction within the range of the direction in which the virtual camera can photograph a part of the browsing object.

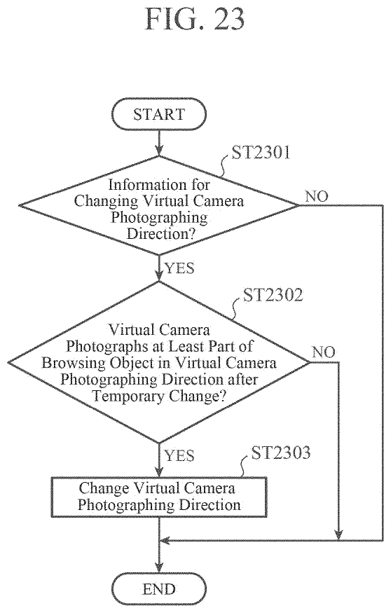

An operation in which the virtual camera control device 100c according to the fourth embodiment determines a gaze point will be described with reference to FIG. 23.

FIG. 23 is a flowchart illustrating an example of processing in which the virtual camera control device 100c according to the fourth embodiment determines a gaze point.

For example, every time the operation information acquiring unit 110 acquires the operation input information, the virtual camera control device 100c repeatedly executes the processing of the flowchart.

First, in step ST2301, the gaze point determining unit 130c determines whether or not the operation input information acquired by the operation information acquiring unit 110 is information for changing the virtual camera photographing direction. Note that, the “information for changing the virtual camera photographing direction” is not operation input information for giving an instruction on movement of the virtual camera, but is operation input information for giving an instruction on change of the virtual camera photographing direction without changing the virtual camera photographing position.

In step ST2301, in a case where the gaze point determining unit 130c has determined that the operation input information acquired by the operation information acquiring unit 110 is information for changing the virtual camera photographing direction, in step ST2302, the gaze point determining unit 130c causes the photographing state determining unit 170c to determine whether or not the virtual camera is in a state of photographing at least a part of the browsing object in the virtual camera photographing direction after the temporary change.

In step ST2302, when the photographing state determining unit 170c has determined that the virtual camera is not in a state of photographing at least a part of the browsing object in the virtual camera photographing direction after the temporary change, that is, has determined that the virtual camera is in a state of not photographing the browsing object at all, the virtual camera control device 100c ends the processing of the flowchart.

In step ST2302, when the photographing state determining unit 170c has determined that the virtual camera is in a state of photographing at least a part of the browsing object in the virtual camera photographing direction after the temporary change, in step ST2303, the gaze point determining unit 130c changes the virtual camera photographing direction on the basis of the operation input information acquired by the operation information acquiring unit 110. Then, the gaze point determining unit 130c determines a gaze point on the basis of the changed virtual camera photographing direction.

After step ST2303, the virtual camera control device 100c ends the processing of the flowchart.

In step ST2301, when the gaze point determining unit 130c has determined that the operation input information acquired by the operation information acquiring unit 110 is not information for changing the virtual camera photographing direction, the virtual camera control device 100c ends the processing of the flowchart.

As described above, by the virtual camera control device 100c controlling the virtual camera, the display control device 10c can suppress a state in which the browsing object is not displayed on the display device 40. Therefore, the user can efficiently obtain a simulation result about how the browsing object looks.

Note that, in the above description, it has been described that the gaze point determining unit 130c in the virtual camera control device 100c changes the virtual camera photographing direction within the range of the direction in which the virtual camera can photograph at least a part of the browsing object, and determines the gaze point, but it is not limited thereto. For example, the gaze point determining unit 130c may change the virtual camera photographing direction within the range of the direction in which the virtual camera can photograph the entire browsing object and determine the gaze point. Note that the entire browsing object mentioned here is the entire outer shape of the browsing object that can be visually recognized when the browsing object is viewed from any direction.

Furthermore, in the description so far, it has been described that the gaze point determining unit 130c determines, as the gaze point, any one point of the traveling object or the browsing object, but it is not limited thereto. For example, the virtual camera control device 100c may include the spatial object determining unit 150, and in a case where the spatial object determining unit 150 has determined that the virtual 3D object information acquiring unit 120 has acquired the spatial object information, the gaze point determining unit 130c may determine, as the gaze point, any one point of the traveling object, the browsing object, or the spatial object.

Since the operation of the gaze point determining unit 130c in a case where the gaze point determining unit 130c determines, as the gaze point, any one point of the traveling object, the browsing object, or the spatial object is similar to the operation of the gaze point determining unit 130 described so far, the description thereof will be omitted.

As described above, the virtual camera control device 100c includes the gaze point determining unit 130c that determines, as a gaze point, any one point of the traveling object or the browsing object, which is the virtual 3D object, disposed in the virtual 3D space, and the virtual camera traveling unit 140 that moves the virtual camera while keeping the photographing direction of the virtual camera photographing the inside of the virtual 3D space and disposed in the virtual 3D space in the direction from the virtual camera toward the gaze point determined by the gaze point determining unit 130c and keeping the distance from the virtual camera to the traveling object at a fixed distance. The gaze point determining unit 130c is configured to change the virtual camera photographing direction within the range of the direction in which the virtual camera can photograph a part of the browsing object.

With this configuration, the virtual camera control device 100c can set a virtual 3D object different from the browsing object as the traveling object, and at the same time, can suppress the browsing object from deviating entirely from the photographing range. Therefore, the user can efficiently obtain a simulation result about how the browsing object looks.

Furthermore, as described above, the virtual camera control device 100c includes the gaze point determining unit 130c that determines, as a gaze point, any one point of the traveling object or the browsing object, which is the virtual 3D object, disposed in the virtual 3D space, and the virtual camera traveling unit 140 that moves the virtual camera while keeping the photographing direction of the virtual camera photographing the inside of the virtual 3D space and disposed in the virtual 3D space in the direction from the virtual camera toward the gaze point determined by the gaze point determining unit 130c and keeping the distance from the virtual camera to the traveling object at a fixed distance, and the gaze point determining unit 130c is configured to change the virtual camera photographing direction within the range of the direction in which the virtual camera can photograph the entire browsing object.

With this configuration, the virtual camera control device 100c can set a virtual 3D object different from the browsing object as the traveling object, and at the same time, can suppress the browsing object from deviating even partially from the photographing range. Therefore, the user can efficiently obtain a simulation result about how the browsing object looks.

### Fifth Embodiment

The virtual camera control device 100c according to the fourth embodiment temporarily changes the virtual camera photographing direction on the basis of the operation input information, and in a case where the virtual camera based on the virtual camera photographing direction after the temporary change does not photograph the browsing object at all or does not photograph a part thereof, ignores the operation input information so as not to change the virtual camera photographing direction. In a fifth embodiment, an embodiment will be described in which a virtual camera photographing direction is changed on the basis of operation input information, and in a case where a virtual camera based on the changed virtual camera photographing direction does not photograph a browsing object at all or does not photograph a part thereof, the virtual camera photographing direction is changed to a state where a part or all of the browsing object is photographed.

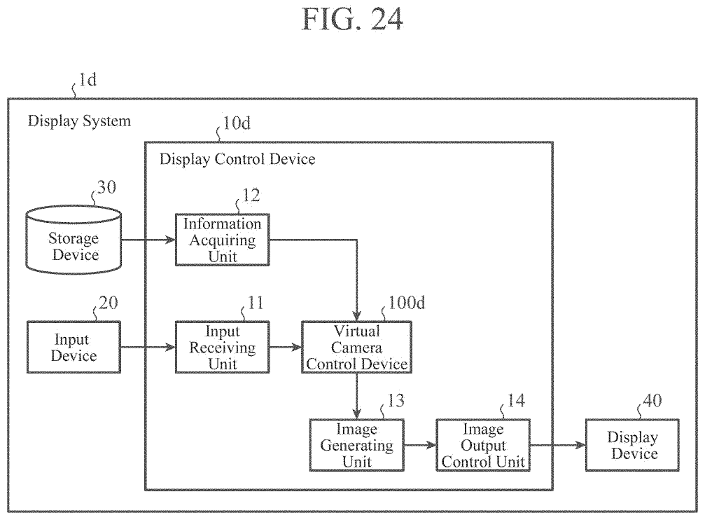

A virtual camera control device 100d according to the fifth embodiment will be described with reference to FIGS. 24 to 27.

With reference to FIG. 24, a configuration of a main part of a display control device 10d to which the virtual camera control device 100d according to the fifth embodiment is applied will be described.

FIG. 24 is a block diagram illustrating an example of a configuration of a main part of a display system 1d to which the display control device 10d according to the fifth embodiment is applied.

The display system 1d includes the display control device 10d, an input device 20, a storage device 30, and a display device 40.

The display system 1d according to the fifth embodiment is obtained by changing the display control device 10 in the display system 1 according to the first embodiment to the display control device 10d.

In the configuration of the display system 1d according to the fifth embodiment, the same reference numerals are given to the same components as the display system 1 according to the first embodiment, and duplicate description thereof will be omitted. That is, the description of the component of FIG. 24 having the same reference numerals as those shown in FIG. 1 will be omitted.

The display control device 10d includes an information processing device such as a general-purpose PC.

The display control device 10d includes an input receiving unit 11, an information acquiring unit 12, a virtual camera control device 100d, an image generating unit 13, and an image output control unit 14.

The display control device 10d according to the fifth embodiment is obtained by changing the virtual camera control device 100 in the display control device 10 according to the first embodiment to the virtual camera control device 100d.

In the configuration of the display control device 10d according to the fifth embodiment, the same reference numerals are given to the same components as the display control device 10 according to the first embodiment, and duplicate description thereof will be omitted. That is, the description of the component of FIG. 24 having the same reference numerals as those shown in FIG. 1 will be omitted.

The virtual camera control device 100d acquires virtual 3D object information and operation input information, and controls a virtual camera photographing position and a virtual camera photographing direction of the virtual camera disposed in a virtual 3D space on the basis of the acquired virtual 3D object information and operation input information. The virtual camera control device 100d outputs the acquired virtual 3D object information and virtual camera information to the image generating unit 13.

The virtual camera information includes camera position information indicating a virtual camera photographing position and camera direction information indicating the virtual camera photographing direction. The virtual camera information may include camera view angle information indicating a view angle at which the virtual camera photographs an image, and the like, in addition to the camera position information and the camera direction information.

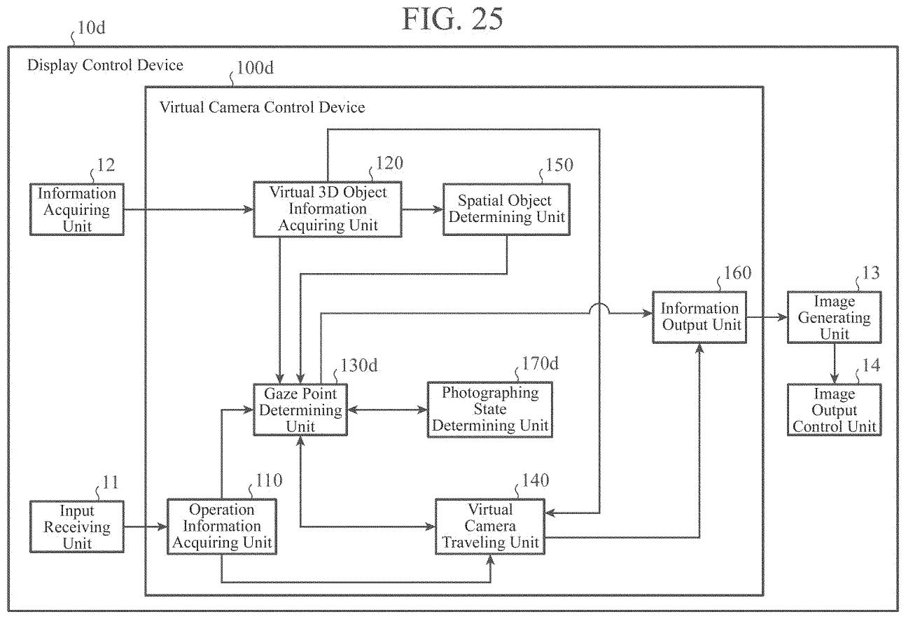

A configuration of a main part of the virtual camera control device 100d according to the fifth embodiment will be described with reference to FIG. 25.

FIG. 25 is a block diagram showing an example of a configuration of a main part of the virtual camera control device 100d according to the fifth embodiment.

The virtual camera control device 100d includes an operation information acquiring unit 110, a virtual 3D object information acquiring unit 120, a gaze point determining unit 130d, a virtual camera traveling unit 140, a photographing state determining unit 170d, and an information output unit 160.

The virtual camera control device 100d may include a spatial object determining unit 150 in addition to the above-described configuration. The virtual camera control device 100d illustrated in FIG. 25 includes the spatial object determining unit 150.

In the virtual camera control device 100d according to the fifth embodiment, the gaze point determining unit 130 in the virtual camera control device 100 according to the first embodiment is changed to the gaze point determining unit 130d, and the photographing state determining unit 170d is added.

In the configuration of the virtual camera control device 100d according to the fifth embodiment, the same reference numerals are given to the same components as the virtual camera control device 100 according to the first embodiment, and duplicate description thereof will be omitted. That is, the description of the component of FIG. 25 having the same reference numerals as those shown in FIG. 2 will be omitted.

Note that, each function of the operation information acquiring unit 110, the virtual 3D object information acquiring unit 120, the gaze point determining unit 130d, the virtual camera traveling unit 140, the photographing state determining unit 170d, the information output unit 160, and the spatial object determining unit 150 in the virtual camera control device 100d according to the fifth embodiment may be implemented by the processor 201 and the memory 202, or may be implemented by the processing circuit 203 in the hardware configuration illustrated as an example in FIGS. 3A and 3B in the first embodiment.

The gaze point determining unit 130d determines, as the gaze point, any one point of the traveling object or the browsing object. To the gaze point determining unit 130d, operation input information is input from the operation information acquiring unit 110, virtual 3D object information is input from the virtual 3D object information acquiring unit 120, and virtual camera information is input from the virtual camera traveling unit 140. The gaze point determining unit 130d determines, as the gaze point, any one point on the surface of the traveling object or the surface of the browsing object on the basis of the operation input information, the virtual 3D object information, and the virtual camera information.

The gaze point determining unit 130d, when determining the gaze point, first changes the virtual camera photographing direction on the basis of the operation input information acquired by the operation information acquiring unit 110.

Note that, the virtual camera photographing direction is also changed when there is operation input information for giving an instruction on movement of the virtual camera, that is, operation input information for giving an instruction on change of the virtual camera photographing position. On the other hand, the operation input information taken into consideration in the gaze point determining unit 130d when determining the gaze point is not the operation input information for giving an instruction on the movement of the virtual camera but the operation input information for giving an instruction on the change of the virtual camera photographing direction without changing the virtual camera photographing position.

For example, in a case where the input device 20 is a mouse, the user gives an instruction to change the virtual camera photographing direction by changing a display angle of the traveling object or the browsing object in the photographed image by performing a so-called drag operation. Alternatively, the user can also give an instruction to change the virtual camera photographing direction by operating the input device 20 to designate any one point of the traveling object or the browsing object in the photographed image displayed on the display device 40.

Next, the gaze point determining unit 130d determines a gaze point on the basis of the virtual camera photographing position, the changed virtual camera photographing direction, and the virtual 3D object information. For example, the gaze point determining unit 130d determines, as the gaze point, a point closest to the virtual camera among points at which a straight line passing through the virtual camera photographing position and extending in the changed virtual camera photographing direction intersects with the traveling object or the browsing object.

The gaze point determining unit 130d outputs information on the determined gaze point, virtual camera information including the changed virtual camera photographing direction, and virtual 3D object information acquired from the virtual 3D object information acquiring unit 120 to the photographing state determining unit 170d. Furthermore, the gaze point determining unit 130d outputs information on the determined gaze point or information on the determined gaze point and the changed virtual camera photographing direction to the virtual camera traveling unit 140.

The virtual camera traveling unit 140 changes the virtual camera photographing direction on the basis of the gaze point determined by the gaze point determining unit 130d or the changed virtual camera photographing direction. The virtual camera traveling unit 140 generates virtual camera information on the virtual camera after changing the virtual camera photographing direction, and outputs the virtual camera information to the information output unit 160.

The photographing state determining unit 170d determines the photographing state of the browsing object by the virtual camera in the state of reflecting the changed virtual camera photographing direction on the basis of the virtual 3D object information and the virtual camera information.

Specifically, at the virtual camera photographing position indicated by the virtual camera information, the photographing state determining unit 170d determines whether or not the virtual camera facing the changed virtual camera photographing direction is in a state of photographing at least a part of the browsing object. The photographing state determining unit 170d outputs the determination result to the gaze point determining unit 130d.

When the determination result acquired from the photographing state determining unit 170d indicates that the virtual camera is not in a state of photographing at least a part of the browsing object, that is, when the determination result indicates that the virtual camera is in a state of not photographing the browsing object at all, the gaze point determining unit 130d changes the virtual camera photographing direction until the virtual camera is in a state of photographing at least a part of the browsing object.

That is, the gaze point determining unit 130d, when having changed the virtual camera photographing direction in a direction in which the virtual camera does not photograph the browsing object at all, changes the virtual camera photographing direction in a direction in which the virtual camera is in a state of photographing at least a part of the browsing object.

Specifically, for example, the gaze point determining unit 130d changes the virtual camera photographing direction by a predetermined change amount from the virtual camera photographing direction in a state where the virtual camera does not photograph the browsing object at all to a direction opposite to the change direction indicated by the operation input information. The gaze point determining unit 130d outputs the virtual camera information including the virtual camera photographing direction after changing the virtual camera photographing direction by the predetermined change amount to the photographing state determining unit 170d. The photographing state determining unit 170d determines the photographing state and outputs the determination result to the gaze point determining unit 130d. The gaze point determining unit 130d repeats the above-described processing until the determination result acquired from the photographing state determining unit 170d indicates that the virtual camera after changing the virtual camera photographing direction by the predetermined change amount is in a state of photographing at least a part of the browsing object. By performing such processing, the gaze point determining unit 130d can change the virtual camera photographing direction to the virtual camera photographing direction in which the virtual camera is in a state of photographing at least a part of the browsing object.

Furthermore, for example, the photographing state determining unit 170d, when having determined that the virtual camera is not in a state of photographing at least a part of the browsing object, that is, when having determined that the virtual camera is in a state of not photographing the browsing object at all, calculates the virtual camera photographing direction in which the virtual camera is in a state of photographing at least a part of the browsing object. The photographing state determining unit 170d outputs the calculated information on the virtual camera photographing direction to the gaze point determining unit 130d. By changing the virtual camera photographing direction on the basis of the information, the gaze point determining unit 130d can change the virtual camera photographing direction to the virtual camera photographing direction in which the virtual camera is in a state of photographing at least a part of the browsing object.

The gaze point determining unit 130d, also while changing the virtual camera photographing direction from a state in which the virtual camera does not photograph the browsing object at all to a state in which it photographs at least a part of the browsing object, outputs at least the virtual camera photographing direction to the virtual camera traveling unit 140, for example, every time the virtual camera photographing direction is changed. For example, while the gaze point determining unit 130d changes the virtual camera photographing direction from a state in which the virtual camera does not photograph the browsing object at all to a state in which it photographs at least a part of the browsing object, the virtual camera traveling unit 140 generates virtual camera information on the basis of the virtual camera photographing direction acquired from the gaze point determining unit 130d and outputs the virtual camera information to the information output unit 160.

By the virtual camera control device 100d controlling the virtual camera in this manner, the display control device 10d can suppress a state in which the browsing object is not displayed on the display device 40 when the gaze point is determined.

Furthermore, on the display device 40, a process from a state in which the virtual camera does not photograph the browsing object at all to a state in which it photographs at least a part of the browsing object is displayed like a moving image. Therefore, the display control device 10d can cause the user to visually recognize that the virtual camera photographing direction cannot be changed any more in the direction in which the user has changed the virtual camera photographing direction.

Note that, while the gaze point determining unit 130d changes the virtual camera photographing direction from a state in which the virtual camera does not photograph the browsing object at all to a state in which it photographs at least a part of the browsing object, the virtual camera traveling unit 140 may not generate virtual camera information or may not output virtual camera information to the information output unit 160 after generating the virtual camera information.

When a virtual camera photographing direction is changed until the virtual camera is in a state of photographing at least a part of the browsing object, the gaze point determining unit 130d determines the gaze point on the basis of the virtual camera photographing direction. The gaze point determining unit 130d outputs information on the determined gaze point to the virtual camera traveling unit 140.

Thereafter, in a case where the operation input information for giving an instruction on the movement of the virtual camera is input from the operation information acquiring unit 110, the virtual camera traveling unit 140 moves the virtual camera while keeping the virtual camera photographing direction in the direction from the virtual camera toward the gaze point determined by the gaze point determining unit 130d and keeping the distance from the virtual camera to the traveling object at a fixed distance.

Hereinafter, as an example, a case where the display control device 10d is used as a device that performs simulation on a road surface image will be described. Hereinafter, a description will be given assuming that the traveling object is a virtual 3D object indicating a vehicle in a virtual 3D space, and the browsing object is a virtual 3D object indicating a road surface image in the virtual 3D space.

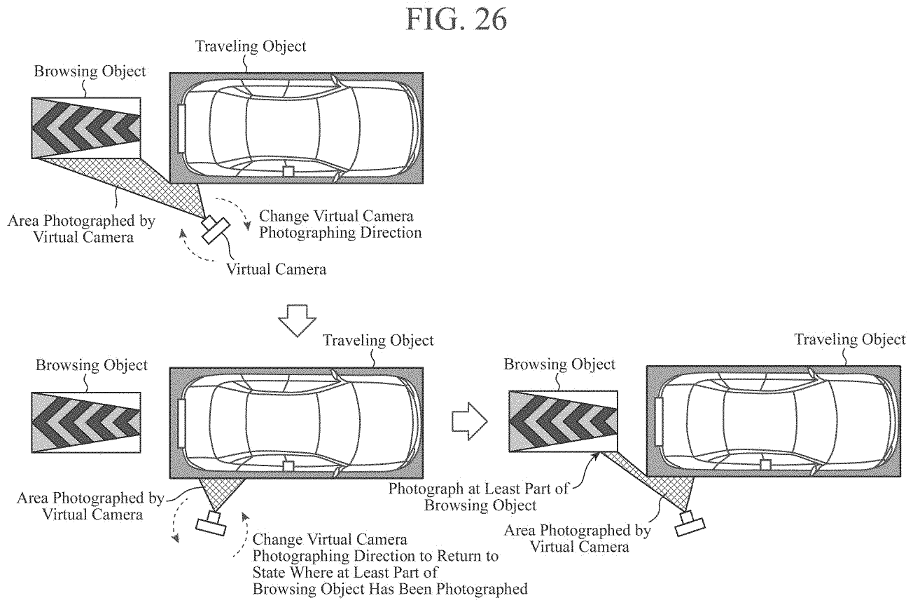

FIG. 26 is an arrangement diagram illustrating an example of a positional relationship among a traveling object, a browsing object, and a virtual camera, as viewed from above a virtual 3D object indicating a vehicle that is the traveling object in the virtual 3D space according to the fifth embodiment.

For example, the gaze point determining unit 130d changes the virtual camera photographing direction as illustrated in FIG. 26 on the basis of the operation input information acquired by the operation information acquiring unit 110. As illustrated in FIG. 26, in a case where the virtual camera photographing direction is changed to a direction in which the virtual camera does not photograph a part of the browsing object, that is, in a direction in which the virtual camera does not photograph the browsing object at all, the gaze point determining unit 130d changes the virtual camera photographing direction to a direction in which it is in a state of photographing at least a part of the browsing object.

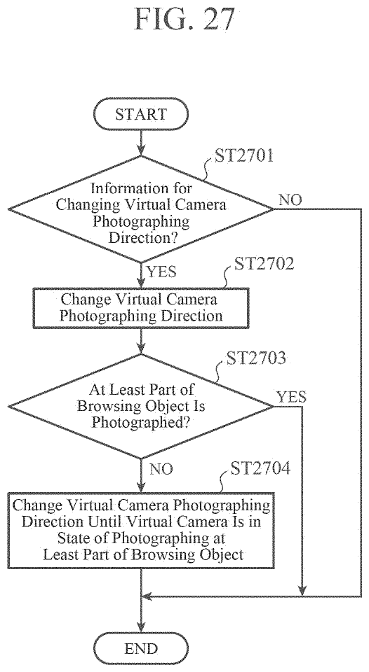

An operation in which the virtual camera control device 100d according to the fifth embodiment determines a gaze point will be described with reference to FIG. 27.

FIG. 27 is a flowchart illustrating an example of processing in which the virtual camera control device 100d according to the fifth embodiment determines a gaze point.

For example, every time the operation information acquiring unit 110 acquires the operation input information, the virtual camera control device 100d repeatedly executes the processing of the flowchart.

First, in step ST2701, the gaze point determining unit 130d determines whether or not the operation input information acquired by the operation information acquiring unit 110 is information for changing the virtual camera photographing direction. Note that, the “information for changing the virtual camera photographing direction” is not operation input information for giving an instruction on movement of the virtual camera, but is operation input information for giving an instruction on change of the virtual camera photographing direction without changing the virtual camera photographing position.

In step ST2701, in a case where the gaze point determining unit 130d has determined that the operation input information acquired by the operation information acquiring unit 110 is information for changing the virtual camera photographing direction, in step ST2702, the gaze point determining unit 130d changes the virtual camera photographing direction on the basis of the operation input information acquired by the operation information acquiring unit 110.

After step ST2702, in step ST2703, the gaze point determining unit 130d causes the photographing state determining unit 170d to determine whether or not the virtual camera is in a state of photographing at least a part of the browsing object.

In step ST2703, when the photographing state determining unit 170d has determined that the virtual camera is in a state of photographing at least a part of the browsing object, the virtual camera control device 100d ends the processing of the flowchart.

In step ST2703, when the photographing state determining unit 170d has determined that the virtual camera is not in a state of photographing at least a part of the browsing object, that is, has determined that the virtual camera is in a state of not photographing the browsing object at all, in step ST2704, the gaze point determining unit 130d changes the virtual camera photographing direction until the virtual camera is in a state of photographing at least a part of the browsing object.

After step ST2704, the virtual camera control device 100d ends the processing of the flowchart.

In step ST2701, when the gaze point determining unit 130d has determined that the operation input information acquired by the operation information acquiring unit 110 is not information for changing the direction in which the virtual camera photographs an image, the virtual camera control device 100d ends the processing of the flowchart.

By the virtual camera control device 100d controlling the virtual camera in this manner, the display control device 10d can suppress a state in which the browsing object is not displayed on the display device 40. Therefore, the user can efficiently obtain a simulation result about how the browsing object looks.

Note that, in the above description, it has been described that the gaze point determining unit 130d in the virtual camera control device 100d changes the virtual camera photographing direction to a direction in which the virtual camera is in a state of photographing at least a part of the browsing object when the gaze point determining unit 130d has changed the virtual camera photographing direction to a direction in which the virtual camera does not photograph the browsing object at all, but it is not limited thereto. For example, the gaze point determining unit 130d, when having changed the virtual camera photographing direction to a direction in which the virtual camera does not photograph the entire browsing object, may change the virtual camera photographing direction to a direction in which the virtual camera is in a state of photographing the entire browsing object. Note that the entire browsing object mentioned here is the entire outer shape of the browsing object that can be visually recognized when the browsing object is viewed from any direction.

Furthermore, in the above description, it has been described that the gaze point determining unit 130d determines, as the gaze point, any one point of the traveling object or the browsing object, but it is not limited thereto. For example, the virtual camera control device 100d may include the spatial object determining unit 150, and in a case where the spatial object determining unit 150 has determined that the virtual 3D object information acquiring unit 120 has acquired the spatial object information, the gaze point determining unit 130d may determine, as the gaze point, any one point of the traveling object, the browsing object, or the spatial object.

Since the operation of the gaze point determining unit 130d in a case where the gaze point determining unit 130d determines, as the gaze point, any one point of the traveling object, the browsing object, or the spatial object is similar to the operation of the gaze point determining unit 130d described so far, the description thereof will be omitted.

As described above, the virtual camera control device 100d includes the gaze point determining unit 130d that determines, as a gaze point, any one point of the traveling object or the browsing object, which is the virtual 3D object, disposed in the virtual 3D space, and the virtual camera traveling unit 140 that moves the virtual camera while keeping the photographing direction of the virtual camera photographing the inside of the virtual 3D space and disposed in the virtual 3D space in the direction from the virtual camera toward the gaze point determined by the gaze point determining unit 130d and keeping the distance from the virtual camera to the traveling object at a fixed distance, in which the gaze point determining unit 130d is configured to change the virtual camera photographing direction to a direction in which the virtual camera is in a state of photographing at least a part of the browsing object when the virtual camera has changed the virtual camera photographing direction in a direction in which the virtual camera does not photograph the browsing object at all.

With this configuration, the virtual camera control device 100d can set a virtual 3D object different from the browsing object as the traveling object, and at the time can suppress the browsing object from deviating entirely from the photographing range when determining the virtual camera photographing direction. Therefore, the user can efficiently obtain a simulation result about how the browsing object looks.

Furthermore, in the above-described configuration, when moving the virtual camera or changing the photographing direction, the virtual camera traveling unit 140 is configured to generate virtual camera information including information on the position of the virtual camera and information on the photographing direction, and output the generated virtual camera information to the image generating unit 13 that generates an image in which the virtual camera has photographed the virtual 3D object on the basis of the virtual camera information.

With this configuration, the virtual camera control device 100d can display, on the display device 40 via the image generating unit 13 included in the display control device 10d, the photographed image in the process of changing the virtual camera photographing direction from the state in which the virtual camera does not photograph the browsing object at all to the virtual camera photographing direction in which at least a part of the browsing object is photographed, like a moving image. Therefore, the user can visually recognize how the virtual camera photographing direction has been changed.

Furthermore, as described above, the virtual camera control device 100d includes the gaze point determining unit 130d that determines, as a gaze point, any one point of the traveling object or the browsing object, which is the virtual 3D object, disposed in the virtual 3D space, and the virtual camera traveling unit 140 that moves the virtual camera while keeping the photographing direction of the virtual camera photographing the inside of the virtual 3D space and disposed in the virtual 3D space in the direction from the virtual camera toward the gaze point determined by the gaze point determining unit 130d and keeping the distance from the virtual camera to the traveling object at a fixed distance, in which the gaze point determining unit 130d is configured to change the virtual camera photographing direction to a direction in which the virtual camera is in a state of photographing the entire browsing object when the virtual camera has changed the virtual camera photographing direction in a direction in which the virtual camera does not photograph the entire browsing object.

With this configuration, the virtual camera control device 100d can set a virtual 3D object different from the browsing object as the traveling object, and at the time can suppress the browsing object from deviating even partially from the photograph range when determining the virtual camera photographing direction. Therefore, the user can efficiently obtain a simulation result about how the browsing object looks.

Furthermore, in the above-described configuration, when moving the virtual camera or changing the photographing direction, the virtual camera traveling unit 140 is configured to generate virtual camera information including information on the position of the virtual camera and information on the photographing direction, and output the generated virtual camera information to the image generating unit 13 that generates an image in which the virtual camera has photographed the virtual 3D object on the basis of the virtual camera information.

With this configuration, the virtual camera control device 100d can cause the display device 40 via the image generating unit 13 included in the display control device 10d to display, like a moving image, the photographed image in the process of changing the virtual camera photographing direction from the state in which the virtual camera does not photograph the entire browsing object to the direction in which the virtual camera photographs the entire browsing object. Therefore, the user can visually recognize how the virtual camera photographing direction has been changed.

### Sixth Embodiment

In the fourth embodiment and the fifth embodiment, it is assumed that there is one browsing object, and the virtual camera control devices 100c and 100d according to the fourth embodiment and the fifth embodiment consider the photographing state of the one browsing object when changing the virtual camera photographing direction on the basis of the instruction input information. In a sixth embodiment, an embodiment will be described in which it is assumed that there are a plurality of browsing objects, and photographing states of the plurality of browsing objects are considered when the virtual camera photographing direction is changed on the basis of instruction input information.

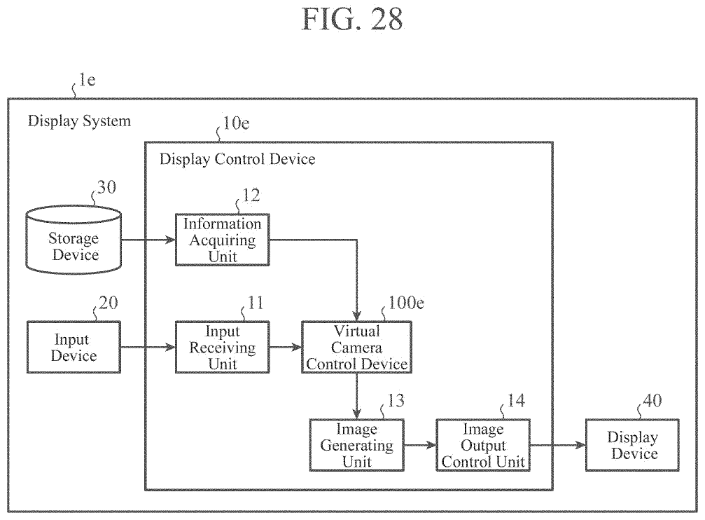

A virtual camera control device 100e according to the sixth embodiment will be described with reference to FIGS. 28 to 31.

A configuration of a main part of a display control device 10e to which the virtual camera control device 100e according to the sixth embodiment is applied will be described with reference to FIG. 28.

FIG. 28 is a block diagram illustrating an example of a configuration of a main part of a display system 1e to which the display control device 10e according to the sixth embodiment is applied.

The display system 1e includes a display control device 10e, an input device 20, a storage device 30, and a display device 40.

The display system 1e according to the sixth embodiment is obtained by changing the display control device 10 in the display system 1 according to the first embodiment to the display control device 10e.

In the configuration of the display system 1e according to the sixth embodiment, the same reference numerals are given to the same components as the display system 1 according to the first embodiment, and duplicate description thereof will be omitted. That is, the description of the component of FIG. 28 having the same reference numerals as those shown in FIG. 1 will be omitted.

The display control device 10e includes an information processing device such as a general-purpose PC.

The display control device 10e includes an input receiving unit 11, an information acquiring unit 12, a virtual camera control device 100e, an image generating unit 13, and an image output control unit 14.

The display control device 10e according to the sixth embodiment is obtained by changing the virtual camera control device 100 in the display control device 10 according to the first embodiment to the virtual camera control device 100e.

In the configuration of the display control device 10e according to the sixth embodiment, the same reference numerals are given to the same configurations as the display control device 10 according to the first embodiment, and duplicate description thereof will be omitted. That is, the description of the configuration of FIG. 28 having the same reference numerals as those shown in FIG. 1 will be omitted.

The virtual camera control device 100e acquires virtual 3D object information and operation input information, and controls a virtual camera photographing position and ae virtual camera photographing direction of a virtual camera disposed in a virtual 3D space on the basis of the acquired virtual 3D object information and operation input information. The virtual camera control device 100e outputs the acquired virtual 3D object information and virtual camera information to the image generating unit 13.

The virtual camera information includes camera position information indicating the virtual camera photographing position and camera direction information indicating the virtual camera photographing direction. The virtual camera information may include camera view angle information indicating a view angle at which the virtual camera photographs an image, and the like, in addition to the camera position information and the camera direction information.

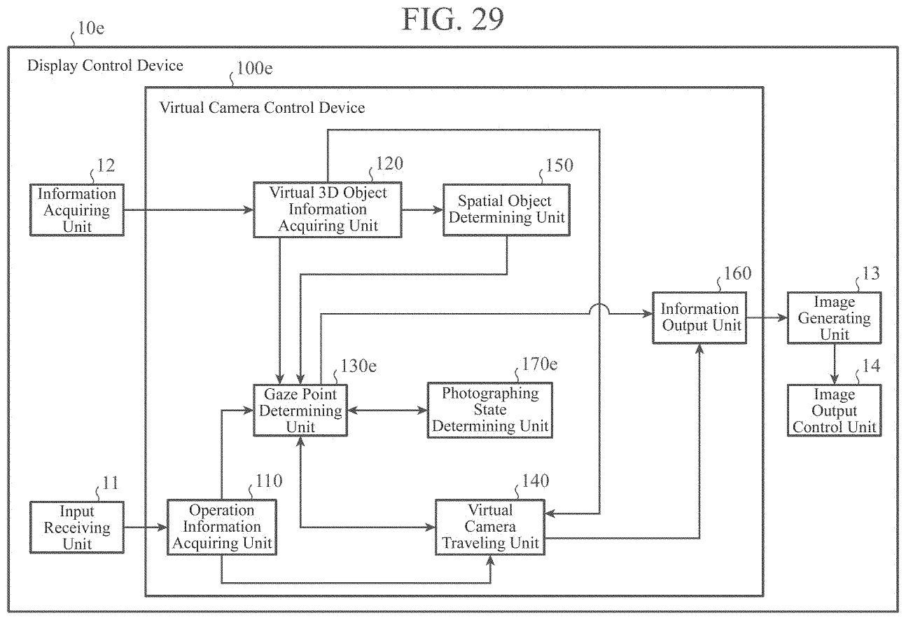

A configuration of a main part of the virtual camera control device 100e according to the sixth embodiment will be described with reference to FIG. 29.

FIG. 29 is a block diagram showing an example of a configuration of a main part of the virtual camera control device 100e according to the sixth embodiment.

The virtual camera control device 100e includes an operation information acquiring unit 110, a virtual 3D object information acquiring unit 120, a gaze point determining unit 130e, a virtual camera traveling unit 140, a photographing state determining unit 170e, and an information output unit 160.

The virtual camera control device 100e may include a spatial object determining unit 150 in addition to the above-described configuration. The virtual camera control device 100e illustrated in FIG. 29 includes the spatial object determining unit 150.

In the virtual camera control device 100e according to the sixth embodiment, the gaze point determining unit 130 in the virtual camera control device 100 according to the first embodiment is changed to the gaze point determining unit 130e, and the photographing state determining unit 170e is added.

Furthermore, in the virtual 3D space according to the first embodiment, only one browsing object is disposed in the virtual 3D space, but in the virtual 3D space according to the sixth embodiment, a plurality of browsing objects are arranged in the virtual 3D space.

In the configuration of the virtual camera control device 100e according to the sixth embodiment, the same reference numerals are given to the same components as the virtual camera control device 100 according to the first embodiment, and duplicate description thereof will be omitted. That is, the description of the component of FIG. 29 having the same reference numerals as those shown in FIG. 2 will be omitted.

Note that, each function of the operation information acquiring unit 110, the virtual 3D object information acquiring unit 120, the gaze point determining unit 130e, the virtual camera traveling unit 140, the photographing state determining unit 170e, the information output unit 160, and the spatial object determining unit 150 in the virtual camera control device 100e according to the sixth embodiment may be implemented by the processor 201 and the memory 202 or may be implemented by the processing circuit 203 in the hardware configuration illustrated as an example in FIGS. 3A and 3B in the first embodiment.

The gaze point determining unit 130e determines, as a gaze point, any one point of the traveling object or the plurality of browsing objects. To the gaze point determining unit 130e, operation input information is input from the operation information acquiring unit 110, virtual 3D object information is input from the virtual 3D object information acquiring unit 120, and virtual camera information is input from the virtual camera traveling unit 140. On the basis of the operation input information, the virtual 3D object information, and the virtual camera information, the gaze point determining unit 130e determines, as the gaze point, any one point on the surface of the traveling object or the surfaces of the plurality of browsing objects.

The gaze point determining unit 130e, when determining the gaze point, first changes the virtual camera photographing direction on the basis of the operation input information acquired by the operation information acquiring unit 110.

Note that, the virtual camera photographing direction is also changed when there is operation input information for giving an instruction on movement of the virtual camera, that is, operation input information for giving an instruction on change of the virtual camera photographing position. On the other hand, the operation input information taken into consideration in the gaze point determining unit 130e when determining the gaze point is not operation input information for giving an instruction on movement of the virtual camera, but operation input information for giving an instruction on change of the virtual camera photographing direction without changing the virtual camera photographing position.

For example, in a case where the input device 20 is a mouse, the user gives an instruction to change the virtual camera photographing direction by changing a display angle of the traveling object or the browsing object in the photographed image by performing a so-called drag operation. Alternatively, the user can also give an instruction to change the virtual camera photographing direction by operating the input device 20 to designate any one point of the traveling object or the browsing object in the photographed image displayed on the display device 40.

Next, the gaze point determining unit 130e determines a gaze point on the basis of the virtual camera photographing position, the changed virtual camera photographing direction, and the virtual 3D object information.

For example, the gaze point determining unit 130e determines, as a gaze point, a point closest to the virtual camera among points at which a straight line passing through the virtual camera photographing position and extending in the changed virtual camera photographing direction intersects with the traveling object or the plurality of browsing objects.

The gaze point determining unit 130e outputs information on the determined gaze point, virtual camera information including the changed virtual camera photographing direction, and virtual 3D object information acquired from the virtual 3D object information acquiring unit 120 to the photographing state determining unit 170e. Furthermore, the gaze point determining unit 130e outputs the information on the determined gaze point or the information on the determined gaze point and the changed virtual camera photographing direction to the virtual camera traveling unit 140.

The virtual camera traveling unit 140 changes the virtual camera photographing direction on the basis of the gaze point determined by the gaze point determining unit 130e or the changed virtual camera photographing direction. The virtual camera traveling unit 140 generates virtual camera information on the virtual camera after changing the virtual camera photographing direction, and outputs the virtual camera information to the information output unit 160.

The photographing state determining unit 170e determines the photographing state of the browsing object by the virtual camera in the state of reflecting the changed virtual camera photographing direction on the basis of the virtual 3D object information and the virtual camera information.

Specifically, the photographing state determining unit 170e determines whether or not the virtual camera facing the changed virtual camera photographing direction is in a state of photographing at least a part of a first browsing object, which is one of the plurality of browsing objects, at the virtual camera photographing position indicated by the virtual camera information. The photographing state determining unit 170e outputs the determination result to the gaze point determining unit 130e.

When the determination result acquired from the photographing state determining unit 170e indicates that the virtual camera is not in a state of photographing at least a part of the first browsing object, that is, when the determination result indicates that the virtual camera is in a state of not photographing the first browsing object at all, the gaze point determining unit 130e changes the virtual camera photographing direction until the virtual camera is in a state of photographing at least a part of other browsing objects different from the first browsing object.

That is, the gaze point determining unit 130e, when having changed the virtual camera photographing direction to a direction in which the virtual camera does not photograph the first browsing object at all, changes the virtual camera photographing direction to a direction in which the virtual camera is in a state of photographing at least a part of a second browsing object.

Specifically, the photographing state determining unit 170e, when having determined that the virtual camera is not in a state of photographing at least a part of the first browsing object, that is, when having determined that the virtual camera is in a state of not photographing the first browsing object at all, determines whether or not it is possible to bring the virtual camera into a state of photographing at least a part of other browsing objects different from the first browsing object by changing the virtual camera photographing direction. The photographing state determining unit 170e, when having determined that it is possible to bring the virtual camera into a state of photographing at least a part of other browsing objects in the determination, determines, as the second browsing object, a browsing object closest to the current virtual camera photographing direction among the other browsing objects. Furthermore, the photographing state determining unit 170e calculates a virtual camera photographing direction in a state of photographing at least a part of the second browsing object, and outputs information on the calculated virtual camera photographing direction to the gaze point determining unit 130e. By changing the virtual camera photographing direction on the basis of the information, the gaze point determining unit 130e can change the virtual camera photographing direction to the virtual camera photographing direction in which the virtual camera is photographing at least a part of the second browsing object.

The gaze point determining unit 130e, also while changing the virtual camera photographing direction from a state in which the virtual camera does not photograph the first browsing object at all to a state in which it photographs at least a part of the second browsing object, outputs at least the virtual camera photographing direction to the virtual camera traveling unit 140, for example, every time the virtual camera photographing direction is changed. For example, while the gaze point determining unit 130e changes the virtual camera photographing direction from a state in which the virtual camera does not photograph the first browsing object at all to a state in which it photographs at least a part of the second browsing object, the virtual camera traveling unit 140 generates virtual camera information on the basis of the virtual camera photographing direction acquired from the gaze point determining unit 130e and outputs the virtual camera information to the information output unit 160.

By the virtual camera control device 100e controlling the virtual camera in this manner, the display control device 10e can suppress a state in which the browsing object is not displayed at all on the display device 40 when the gaze point is determined.

Furthermore, on the display device 40, a process from a state in which the virtual camera does not photograph the first browsing object at all to a state in which it photographs at least a part of the second browsing object is displayed like a moving image. Therefore, the display control device 10e can cause the user to visually recognize how the virtual camera photographing direction has been changed.

Note that, while the gaze point determining unit 130e changes the virtual camera photographing direction from the state in which the virtual camera does not photograph the first browsing object at all to the state in which it photographs at least a part of the second browsing object, the virtual camera traveling unit 140 may not generate virtual camera information or may not output virtual camera information to the information output unit 160 after generating the virtual camera information.

The gaze point determining unit 130e, when having changed the virtual camera photographing direction until the virtual camera is in a state of photographing at least a part of the second browsing object, determines the gaze point on the basis of the changed virtual camera photographing direction. The gaze point determining unit 130e outputs information on the determined gaze point to the virtual camera traveling unit 140.

Thereafter, in a case where the operation input information for giving an instruction on movement of the virtual camera is input from the operation information acquiring unit 110, the virtual camera traveling unit 140 moves the virtual camera while keeping the virtual camera photographing direction in the direction from the virtual camera toward the gaze point determined by the gaze point determining unit 130e and keeping the distance from the virtual camera to the traveling object at a fixed distance.

Hereinafter, as an example, a case where the display control device 10e is used as a device that performs simulation on a road surface image will be described. Hereinafter, a description will be given assuming that the traveling object is a virtual 3D object indicating a vehicle in a virtual 3D space, the first browsing object is a virtual 3D object indicating a first road surface image in the virtual 3D space, and the second browsing object is a virtual 3D object indicating a second road surface image in the virtual 3D space. It is assumed that the first road surface image and the second road surface image are displayed at different positions on the road surface.

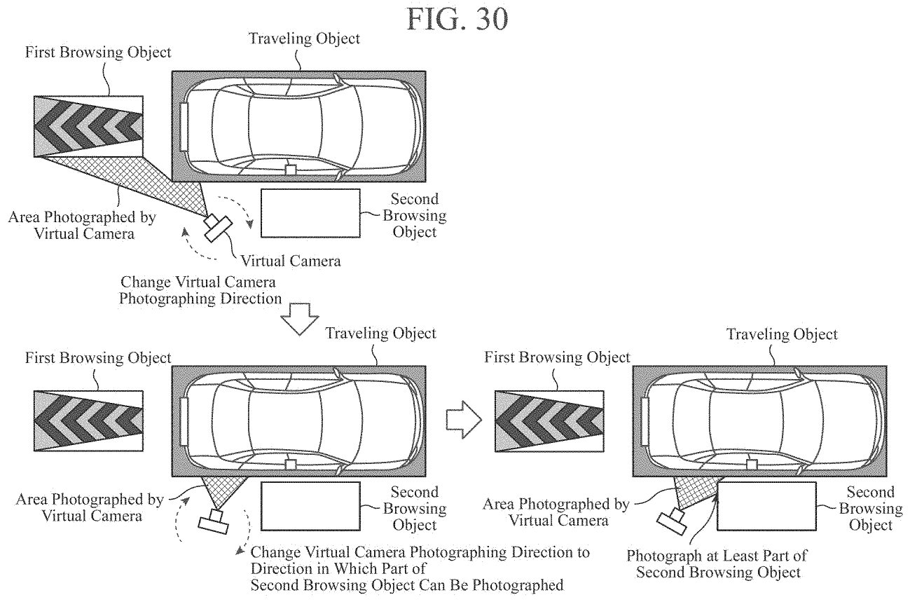

FIG. 30 is an arrangement diagram illustrating an example of a positional relationship among a traveling object, a first browsing object, a second browsing object, and a virtual camera as viewed from above a virtual 3D object indicating a vehicle that is the traveling object in the virtual 3D space according to the sixth embodiment.

For example, the gaze point determining unit 130e changes the virtual camera photographing direction as illustrated in FIG. 30 on the basis of the operation input information acquired by the operation information acquiring unit 110. As illustrated in FIG. 30, the gaze point determining unit 130e, when having changed the virtual camera photographing direction to a direction in which the virtual camera does not photograph the first browsing object at all, changes the photograph direction of the virtual camera to a direction in which it photographs at least a part of the second browsing object.

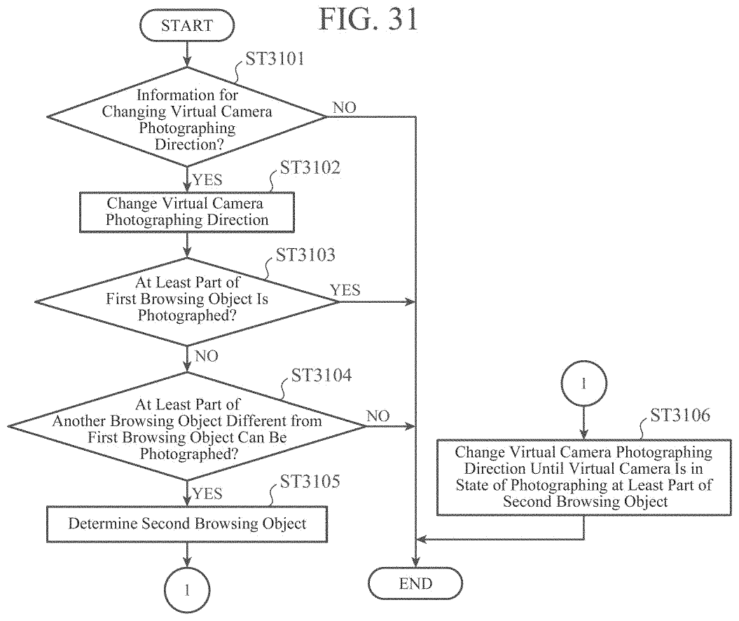

An operation in which the virtual camera control device 100e according to the sixth embodiment determines a gaze point will be described with reference to FIG. 31.

FIG. 31 is a flowchart illustrating an example of processing in which the virtual camera control device 100e according to the sixth embodiment determines a gaze point.

For example, every time the operation information acquiring unit 110 acquires the operation input information, the virtual camera control device 100e repeatedly executes the processing of the flowchart.

First, in step ST3101, the gaze point determining unit 130e determines whether or not the operation input information acquired by the operation information acquiring unit 110 is information for changing the virtual camera photographing direction. Note that, the “information for changing the virtual camera photographing direction” is not operation input information for giving an instruction on movement of the virtual camera, but is operation input information for giving an instruction on change of the virtual camera photographing direction without changing the virtual camera photographing position.

In step ST3101, in a case where the gaze point determining unit 130e has determined that the operation input information acquired by the operation information acquiring unit 110 is information for changing the virtual camera photographing direction, in step ST3102, the gaze point determining unit 130e changes the virtual camera photographing direction on the basis of the operation input information acquired by the operation information acquiring unit 110.

After step ST3102, in step ST3103, the gaze point determining unit 130e causes the photographing state determining unit 170e to determine whether or not the virtual camera is in a state of photographing at least a part of the first browsing object.

In step ST3103, when the photographing state determining unit 170e determines that the virtual camera is in a state of photographing at least a part of the first browsing object, the virtual camera control device 100e ends the processing of the flowchart.

In step ST3103, when the photographing state determining unit 170e has determined that the virtual camera is not in a state of photographing at least a part of the first browsing object, that is, has determined that the virtual camera is in a state of not photographing the first browsing object at all, the photographing state determining unit 170e performs the processing of step ST3104. In step ST3104, the photographing state determining unit 170e determines whether or not it is possible to photograph at least a part of other browsing objects different from the first browsing object by the gaze point determining unit 130e changing the virtual camera photographing direction.

In step ST3104, when the photographing state determining unit 170e has determined that the virtual camera is not in a state of photographing at least a part of other browsing objects different from the first browsing object even if the virtual camera photographing direction is changed, the virtual camera control device 100e ends the processing of the flowchart.

In step ST3104, when the photographing state determining unit 170e has determined that it is possible for the virtual camera to be in a state of photographing at least a part of other browsing objects different from the first browsing object by changing the virtual camera photographing direction, the photographing state determining unit 170e performs processing of step ST3105. In step ST3105, the photographing state determining unit 170e determines, as the second browsing object, a browsing object closest to the current virtual camera photographing direction among the other browsing objects different from the first browsing object, at least a part of which has been determined to be able to photograph.

After step ST3105, in step ST3106, the gaze point determining unit 130e changes the virtual camera photographing direction until the virtual camera is in a state of photographing at least a part of the second browsing object.

After step ST3106, the virtual camera control device 100e ends the processing of the flowchart.

In step ST3101, when the gaze point determining unit 130e has determined that the operation input information acquired by the operation information acquiring unit 110 is not information for changing the direction in which the virtual camera photographs an image, the virtual camera control device 100e ends the processing of the flowchart.

By the virtual camera control device 100e controlling the virtual camera as described above, the display control device 10e can suppress a state in which the browsing object is not displayed on the display device 40. Therefore, the user can efficiently obtain a simulation result about how the browsing object looks.

Note that, in the above description, it has been described that the gaze point determining unit 130e in the virtual camera control device 100e changes the virtual camera photographing direction to a direction in which the virtual camera is in a state of photographing at least a part of the second browsing object in a case where the virtual camera has changed the virtual camera photographing direction to a direction in which the virtual camera does not photograph the first browsing object at all, but it is not limited thereto. For example, when the gaze point determining unit 130e has changed the virtual camera photographing direction to a direction in which the virtual camera does not photograph the entire first browsing object, the gaze point determining unit 130e may change the virtual camera photographing direction to a direction in which the virtual camera is in a state of photographing the entire second browsing object. Note that the entire browsing object mentioned here is the entire outer shape of the browsing object that can be visually recognized when the browsing object is viewed from any direction.

Furthermore, in the above description, it has been described that the gaze point determining unit 130e determines, as the gaze point, any one point of the traveling object or the plurality of browsing objects, but it is not limited thereto. For example, the virtual camera control device 100e may include the spatial object determining unit 150, and in a case where the spatial object determining unit 150 has determined that the virtual 3D object information acquiring unit 120 has acquired the spatial object information, the gaze point determining unit 130e may determine, as the gaze point, any one point of the traveling object, the plurality of browsing objects, or the spatial object.

Since the operation of the gaze point determining unit 130e in a case where the gaze point determining unit 130e determines, as the gaze point, any one point of the traveling object, the plurality of browsing objects, or the spatial object is similar to the operation of the gaze point determining unit 130e described so far, the description thereof will be omitted.

As described above, the virtual camera control device 100e includes the gaze point determining unit 130e that determines, as the gaze point, any one point of the traveling object or the browsing object, which is the virtual 3D object, disposed in the virtual 3D space, and the virtual camera traveling unit 140 that moves the virtual camera while keeping the photographing direction of the virtual camera photographing the inside of the virtual 3D space and disposed in the virtual 3D space in the direction from the virtual camera toward the gaze point determined by the gaze point determining unit 130e and keeping the distance from the virtual camera to the traveling object at a fixed distance, in which when the gaze point determining unit 130e has changed the virtual camera photographing direction to the direction in which the virtual camera does not photograph the first browsing object, which is the browsing object, at all, the gaze point determining unit 130e is configured to change the virtual camera photographing direction to a direction in which the virtual camera is in a state of photographing at least a part of the second browsing object that is the browsing object closest to the virtual camera photographing direction.

With this configuration, the virtual camera control device 100e can set a virtual 3D object different from the browsing object as the traveling object, and at the same time, can suppress all of the plurality of browsing objects from deviating from the field of view when determining the gaze point. Therefore, the user can efficiently obtain a simulation result about how the browsing object looks.

Furthermore, in the above-described configuration, when moving the virtual camera or changing the photographing direction, the virtual camera traveling unit 140 is configured to generate virtual camera information including information on the position of the virtual camera and information on the photographing direction, and output the generated virtual camera information to the image generating unit 13 that generates an image in which the virtual camera has photographed the virtual 3D object on the basis of the virtual camera information.

With this configuration, the virtual camera control device 100e can cause the display device 40 via the image generating unit 13 included in the display control device 10e to display, like a moving image, the photographed image in the process of changing the virtual camera photographing direction from the state in which the virtual camera does not photograph the first browsing object at all to the virtual camera photographing direction in which the virtual camera is in a state of photographing at least a part of the second browsing object. Therefore, the user can visually recognize how the virtual camera photographing direction has been changed.

Furthermore, as described above, the virtual camera control device 100e includes the gaze point determining unit 130e that determines, as the gaze point, any one point of the traveling object or the browsing object, which is the virtual 3D object, disposed in the virtual 3D space, and the virtual camera traveling unit 140 that moves the virtual camera while keeping the photographing direction of the virtual camera photographing the inside of the virtual 3D space and disposed in the virtual 3D space in the direction from the virtual camera toward the gaze point determined by the gaze point determining unit 130e and keeping the distance from the virtual camera to the traveling object at a fixed distance, in which when having changed the virtual camera photographing direction to a direction in which the virtual camera does not photograph the entire first browsing object, the gaze point determining unit 130e is configured to change the virtual camera photographing direction to a direction in which the virtual camera is in a state of photographing the entire second browsing object that is the browsing object closest to the virtual camera photographing direction.

With this configuration, the virtual camera control device 100e can set a virtual 3D object different from the browsing object as the traveling object, and at the same time, can photograph the entirety of at least one of the plurality of browsing objects when determining the gaze point. Therefore, the user can efficiently obtain a simulation result about how the entire outer shape of any of the browsing objects looks.

Furthermore, in the above-described configuration, when moving the virtual camera or changing the photographing direction, the virtual camera traveling unit 140 is configured to generate virtual camera information including information on the position of the virtual camera and information on the photographing direction, and output the generated virtual camera information to the image generating unit 13 that generates an image in which the virtual camera has photographed the virtual 3D object on the basis of the virtual camera information.

With this configuration, the virtual camera control device 100e can cause the display device 40 via the image generating unit 13 included in the display control device 10e to display, like a moving image, the photographed image in the process of changing the virtual camera photographing direction from the state in which the virtual camera does not photograph the entire first browsing object to the direction in which the virtual camera is in a state of photographing the entire second browsing object. Therefore, the user can visually recognize how the virtual camera photographing direction has been changed.

### Seventh Embodiment

The virtual camera control device 100b according to the third embodiment moves the virtual camera on the basis of the operation input information, and in a case where the virtual camera after the movement does not photograph the browsing object at all or does not photograph a part thereof, moves the virtual camera to a position where the virtual camera is in a state of photographing a part or all of the browsing object. In a seventh embodiment, an embodiment will be described in which a virtual camera is moved on the basis of operation input information, and in a case where the virtual camera after the movement does not photograph a browsing object at all or does not photograph a part thereof, the virtual camera photographing direction is changed to a virtual camera photographing direction in which the virtual camera is in a state of photographing a part or all of the browsing object.

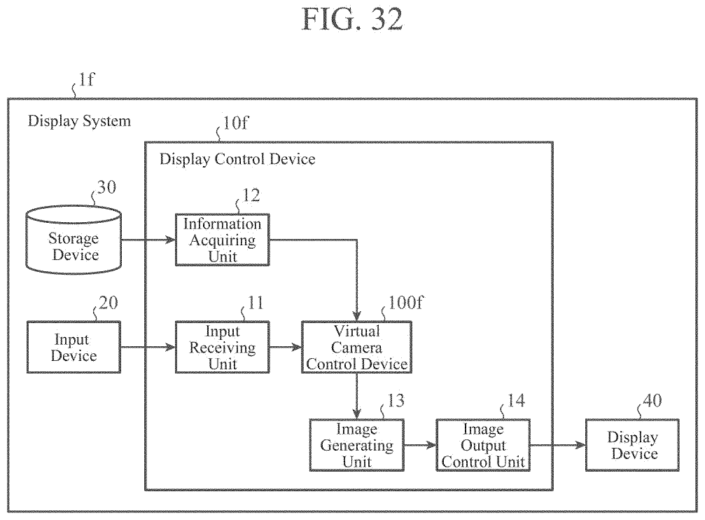

A virtual camera control device 100f according to the seventh embodiment will be described with reference to FIGS. 32 to 35.

A configuration of a main part of the display control device 10f to which the virtual camera control device 100f according to the seventh embodiment is applied will be described with reference to FIG. 32.

FIG. 32 is a block diagram illustrating an example of a configuration of a main part of a display system if to which the display control device 10f according to the seventh embodiment is applied.

The display system if includes the display control device 10f, an input device 20, a storage device 30, and a display device 40.

The display system if according to the seventh embodiment is obtained by changing the display control device 10 in the display system 1 according to the first embodiment to the display control device 10f.

In the configuration of the display system if according to the seventh embodiment, the same reference numerals are given to the same components as the display system 1 according to the first embodiment, and duplicate description thereof will be omitted. That is, the description of the component of FIG. 32 having the same reference numerals as those shown in FIG. 1 will be omitted.

The display control device 10f includes an information processing device such as a general-purpose PC.

The display control device 10f includes an input receiving unit 11, an information acquiring unit 12, a virtual camera control device 100f, an image generating unit 13, and an image output control unit 14.

The display control device 10f according to the seventh embodiment is obtained by changing the virtual camera control device 100 in the display control device 10 according to the first embodiment to the virtual camera control device 100f.

In the configuration of the display control device 10f according to the seventh embodiment, the same reference numerals are given to the same components as the display control device 10 according to the first embodiment, and duplicate description thereof will be omitted. That is, the description of the component of FIG. 32 having the same reference numerals as those shown in FIG. 1 will be omitted.

The virtual camera control device 100f acquires virtual 3D object information and operation input information, and controls a virtual camera photographing position and a virtual camera photographing direction of a virtual camera disposed in a virtual 3D space on the basis of the acquired virtual 3D object information and operation input information. The virtual camera control device 100f outputs the acquired virtual 3D object information and virtual camera information to the image generating unit 13.

The virtual camera information includes camera position information indicating the virtual camera photographing position and camera direction information indicating the virtual camera photographing direction. The virtual camera information may include camera view angle information indicating a view angle at which the virtual camera photographs an image, and the like, in addition to the camera position information and the camera direction information.

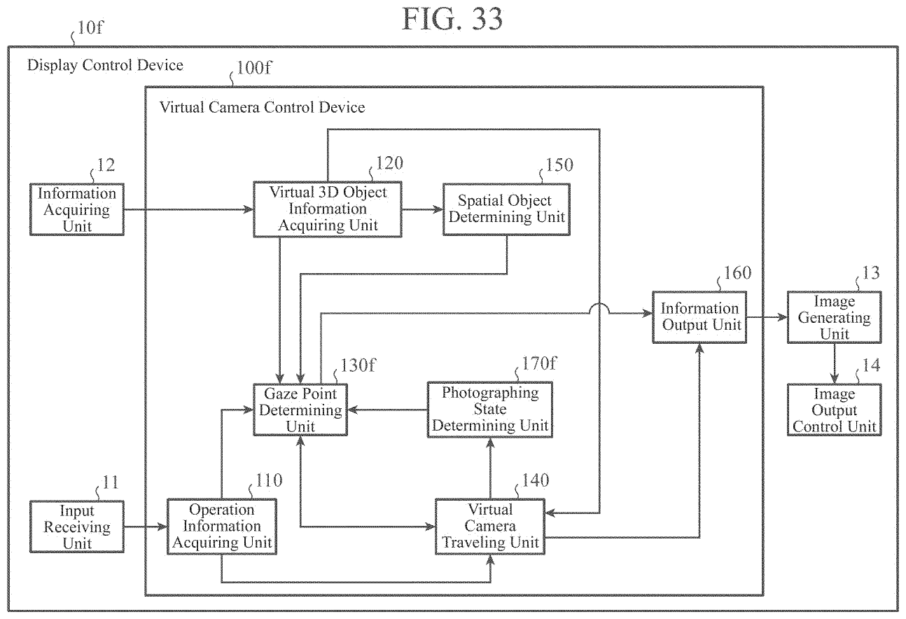

A configuration of a main part of the virtual camera control device 100f according to the seventh embodiment will be described with reference to FIG. 33.

FIG. 33 is a block diagram showing an example of a configuration of a main part of the virtual camera control device 100f according to the seventh embodiment.

The virtual camera control device 100f includes an operation information acquiring unit 110, a virtual 3D object information acquiring unit 120, a gaze point determining unit 130f, a virtual camera traveling unit 140, a photographing state determining unit 170f, and an information output unit 160.

The virtual camera control device 100f may include a spatial object determining unit 150 in addition to the above-described configuration. The virtual camera control device 100f illustrated in FIG. 33 includes the spatial object determining unit 150.

In the virtual camera control device 100f according to the seventh embodiment, the gaze point determining unit 130 in the virtual camera control device 100 according to the first embodiment is changed to the gaze point determining unit 130f, and the photographing state determining unit 170f is added.

In the configuration of the virtual camera control device 100f according to the seventh embodiment, the same reference numerals are given to the same components as the virtual camera control device 100 according to the first embodiment, and duplicate description thereof will be omitted. That is, the description of the component of FIG. 33 having the same reference numerals as those shown in FIG. 2 will be omitted.

Note that, each function of the operation information acquiring unit 110, the virtual 3D object information acquiring unit 120, the gaze point determining unit 130f, the virtual camera traveling unit 140, the photographing state determining unit 170f, the information output unit 160, and the spatial object determining unit 150 in the virtual camera control device 100f according to the seventh embodiment may be implemented by the processor 201 and the memory 202 or may be implemented by the processing circuit 203 in the hardware configuration illustrated as an example in FIGS. 3A and 3B in the first embodiment.

In a case where the operation input information for giving an instruction on change of the virtual camera photographing direction is input from the operation information acquiring unit 110, the gaze point determining unit 130f determines, as the gaze point, any one point of the traveling object or the browsing object.

Note that, the operation of the gaze point determining unit 130f is similar to that of the gaze point determining unit 130 according to the first embodiment except that information on the virtual camera photographing direction is acquired from the photographing state determining unit 170f as described later, and thus detailed description of the basic operation will be omitted.

In a case where the operation input information for giving an instruction on the movement of the virtual camera is input from the operation information acquiring unit 110, the virtual camera traveling unit 140 moves the virtual camera while keeping the virtual camera photographing direction in the direction from the virtual camera toward the gaze point determined by the gaze point determining unit 130f and keeping the distance from the virtual camera to the traveling object at a fixed distance.

The information output unit 160 outputs the virtual camera information generated by the virtual camera traveling unit 140 to the image generating unit 13 in the display control device 10f.

The virtual camera information and the virtual 3D object information are input from the virtual camera traveling unit 140 to the photographing state determining unit 170f The photographing state determining unit 170f determines the photographing state of the browsing object by the virtual camera on the basis of the virtual 3D object information and the virtual camera information. Specifically, the photographing state determining unit 170f determines whether or not the virtual camera is in a state of photographing at least a part of the browsing object. The photographing state determining unit 170f, when having determined that the virtual camera is not in a state of photographing at least a part of the browsing object, that is, when having determined that the virtual camera is in a state of not photographing the browsing object at all, calculates the virtual camera photographing direction in which the virtual camera is in a state of photographing at least a part of the browsing object. The photographing state determining unit 170f outputs information on the calculated virtual camera photographing direction to the gaze point determining unit 130f.

Upon acquiring the information on the virtual camera photographing direction from the photographing state determining unit 170f, the gaze point determining unit 130f changes the virtual camera photographing direction on the basis of the information and determines the gaze point again.

That is, when the virtual camera traveling unit 140 moves the virtual camera to a position where the virtual camera does not photograph the browsing object at all, the gaze point determining unit 130f changes the virtual camera photographing direction to a direction in which the virtual camera is in a state of photographing at least a part of the browsing object and determines the gaze point again.

The gaze point determining unit 130f outputs information on the gaze point determined again to the virtual camera traveling unit 140. Thereafter, in a case where the operation input information for giving an instruction on the movement of the virtual camera is input from the operation information acquiring unit 110, the virtual camera traveling unit 140 moves the virtual camera while keeping the virtual camera photographing direction in the direction from the virtual camera toward the gaze point determined by the gaze point determining unit 130f and keeping the distance from the virtual camera to the traveling object at a fixed distance.

In addition, the gaze point determining unit 130f outputs the virtual camera photographing direction to the virtual camera traveling unit 140 also while changing the virtual camera photographing direction from a state in which the virtual camera does not photograph the browsing object at all to a state in which the virtual camera photographs at least a part of the browsing object. For example, while the gaze point determining unit 130f changes the virtual camera photographing direction from a state in which the virtual camera does not photograph the browsing object at all to a state in which it photographs at least a part of the browsing object, the virtual camera traveling unit 140 generates virtual camera information on the basis of the virtual camera photographing direction acquired from the gaze point determining unit 130f and outputs the virtual camera information to the information output unit 160.

By the virtual camera control device 100f controlling the virtual camera in this manner, the display control device 10f can suppress a state in which the browsing object is not displayed on the display device 40 when determining the gaze point.

Furthermore, on the display device 40, a process from a state in which the virtual camera does not photograph the browsing object at all to a state in which the virtual camera photographs at least a part of the browsing object is displayed like a moving image. Therefore, the display control device 10f can cause the user to visually recognize how the virtual camera photographing direction has been changed.

Note that, while the gaze point determining unit 130f changes the virtual camera photographing direction from a state in which the virtual camera does not photograph the browsing object at all to a state in which it photographs at least a part of the browsing object, the virtual camera traveling unit 140 may not generate virtual camera information or may not output virtual camera information to the information output unit 160 after generating the virtual camera information.

Hereinafter, as an example, a case where the display control device 10f is used as a device that performs simulation on a road surface image will be described. Hereinafter, a description will be given assuming that the traveling object is a virtual 3D object indicating a vehicle in a virtual 3D space, and the browsing object is a virtual 3D object indicating a road surface image in the virtual 3D space.

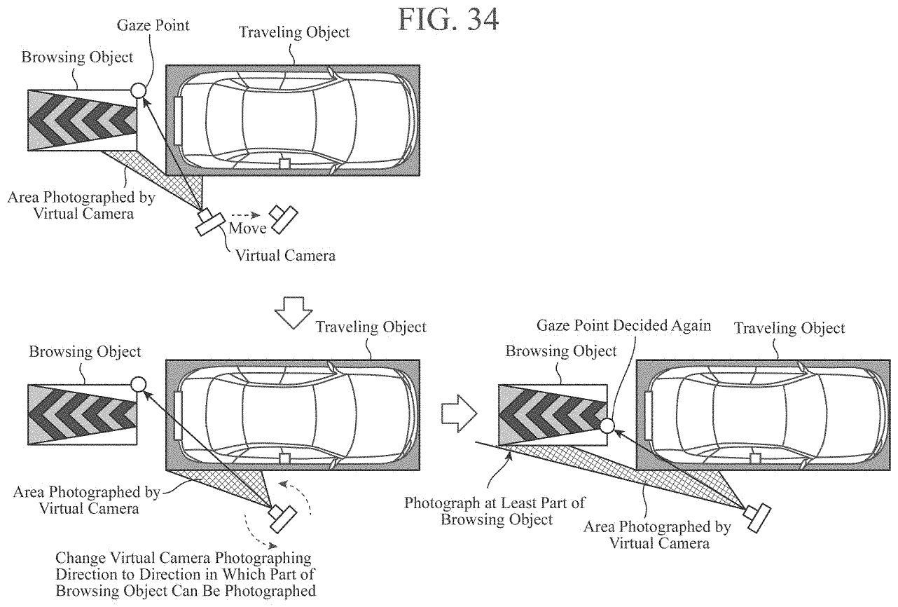

FIG. 34 is an arrangement diagram illustrating an example of a positional relationship among a traveling object, a browsing object, and a virtual camera, as viewed from above a virtual 3D object indicating a vehicle that is the traveling object in the virtual 3D space according to the seventh embodiment.

Hereinafter, as illustrated in FIG. 34, a description will be given assuming that the gaze point is already determined as one point in the browsing object that is the virtual 3D object indicating the road surface image by the gaze point determining unit 130f.

For example, the virtual camera traveling unit 140 moves the virtual camera on the basis of the operation input information acquired by the operation information acquiring unit 110. In a case where the virtual camera traveling unit 140 has moved the virtual camera to a position where the virtual camera does not photograph the browsing object at all, the gaze point determining unit 130f changes the virtual camera photographing direction to a direction in which the virtual camera is in a state of photographing at least a part of the browsing object, and determines the gaze point again.

Note that, FIG. 34 illustrates, as an example, a case where the gaze point when the virtual camera traveling unit 140 moves the virtual camera is any one point in the browsing object. However, the gaze point when the virtual camera traveling unit 140 moves the virtual camera may be any one point in the traveling object.

Furthermore, FIG. 34 illustrates, as an example, a case where the gaze point after being determined again by the gaze point determining unit 130f is any one point in the browsing object, but the gaze point after being determined again by the gaze point determining unit 130f may be any one point in the traveling object.

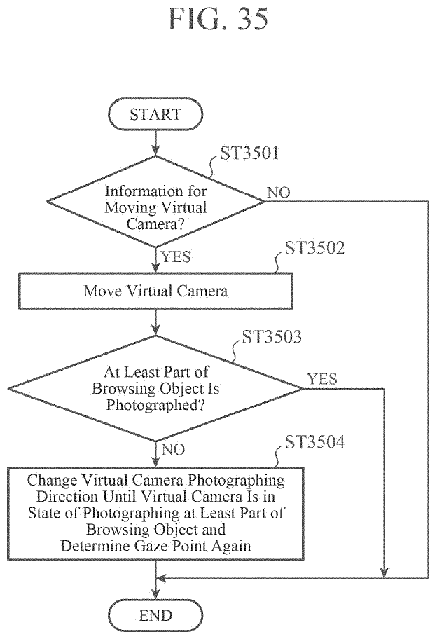

An operation in which the virtual camera control device 100f according to the seventh embodiment determines a gaze point will be described with reference to FIG. 35.

FIG. 35 is a flowchart illustrating an example of processing in which the virtual camera control device 100f according to the seventh embodiment determines the gaze point again. Note that, in the virtual camera control device 100f, it is assumed that the gaze point determining unit 130f determines the gaze point by the operation described with reference to FIG. 4 in the first embodiment or the like before performing the processing of the flowchart.

For example, every time the operation information acquiring unit 110 acquires the operation input information, the virtual camera control device 100f repeatedly executes the processing of the flowchart.

First, in step ST3501, the virtual camera traveling unit 140 determines whether or not the operation input information acquired by the operation information acquiring unit 110 is information for moving the virtual camera.

In step ST3501, when the virtual camera traveling unit 140 has determined that the operation input information acquired by the operation information acquiring unit 110 is not information for moving the virtual camera, the virtual camera control device 100f ends the processing of the flowchart.

In step ST3501, when the virtual camera traveling unit 140 has determined that the operation input information acquired by the operation information acquiring unit 110 is information for moving the virtual camera, in step ST3502, the virtual camera traveling unit 140 moves the virtual camera on the basis of the operation input information acquired by the operation information acquiring unit 110.

After step ST3502, in step ST3503, the gaze point determining unit 130f causes the photographing state determining unit 170f to determine whether or not the virtual camera is in a state of photographing at least a part of the browsing object.

In step ST3503, when the photographing state determining unit 170f has determined that the virtual camera is in a state of photographing at least a part of the browsing object, the virtual camera control device 100f ends the processing of the flowchart.

In step ST3503, when the photographing state determining unit 170f has determined that the virtual camera is not in a state of photographing at least a part of the browsing object, that is, has determined that the virtual camera is in a state of not photographing the browsing object at all, the gaze point determining unit 130f performs processing of step ST3504. In step ST3504, the gaze point determining unit 130f changes the virtual camera photographing direction and determines the gaze point again until the virtual camera is in a state of photographing at least a part of the browsing object.

After step ST3504, the virtual camera control device 100f ends the processing of the flowchart.

By the virtual camera control device 100f controlling the virtual camera in this manner, the display control device 10f can suppress a state in which the browsing object is not displayed on the display device 40.

Note that, in the above description, it has been described that in the gaze point determining unit 130f in the virtual camera control device 100f, the gaze point determining unit 130f changes the virtual camera photographing direction to a direction in which the virtual camera is in a state of photographing at least a part of the browsing object when the virtual camera traveling unit 140 moves the virtual camera to a position where the virtual camera does not photograph the browsing object at all, but it is not limited thereto. For example, the gaze point determining unit 130f may change the virtual camera photographing direction to a direction in which the virtual camera is in a state of photographing the entire browsing object when the virtual camera traveling unit 140 moves the virtual camera to a position where the virtual camera does not photograph the entire browsing object. Note that the entire browsing object mentioned here is the entire outer shape of the browsing object that can be visually recognized when the browsing object is viewed from any direction.

Furthermore, in the above description, it has been described that the gaze point determining unit 130f determines, as the gaze point, any one point of the traveling object or the browsing object, but it is not limited thereto. For example, the virtual camera control device 100f may include the spatial object determining unit 150, and in a case where the spatial object determining unit 150 has determined that the virtual 3D object information acquiring unit 120 has acquired the spatial object information, the gaze point determining unit 130f may determine, as the gaze point, any one point of the traveling object, the browsing object, or the spatial object.

Since the operation of the gaze point determining unit 130f in a case where the gaze point determining unit 130f determines, as the gaze point, any one point of the traveling object, the browsing object, or the spatial object is similar to the operation of the gaze point determining unit 130f described so far, the description thereof will be omitted.

As described above, the virtual camera control device 100f includes the gaze point determining unit 130f that determines, as the gaze point, any one point of the traveling object or the browsing object, which is the virtual 3D object, disposed in the virtual 3D space, and the virtual camera traveling unit 140 that moves the virtual camera while keeping the photographing direction of the virtual camera photographing the inside of the virtual 3D space and disposed in the virtual 3D space in the direction from the virtual camera toward the gaze point determined by the gaze point determining unit 130f and keeping the distance from the virtual camera to the traveling object at a fixed distance, in which the gaze point determining unit 130f is configured to change the virtual camera photographing direction to the direction in which the virtual camera is in a state of photographing a part of the browsing object when having moved the virtual camera to a position where the virtual camera does not photograph the browsing object at all.

With this configuration, the virtual camera control device 100f can set a virtual 3D object different from the browsing object as the traveling object, and at the same time, can suppress the browsing object from deviating entirely from the photographing range.

Furthermore, in the above-described configuration, when moving the virtual camera or changing the photographing direction, the virtual camera traveling unit 140 is configured to generate virtual camera information including information on the position of the virtual camera and information on the photographing direction, and output the generated virtual camera information to the image generating unit 13 that generates an image in which the virtual camera has photographed the virtual 3D object on the basis of the virtual camera information.

With this configuration, the virtual camera control device 100f can cause the display device 40 via the image generating unit 13 included in the display control device 10f to display, like a moving image, the photographed image in the process of changing the virtual camera photographing direction from the state in which the virtual camera does not photograph the browsing object at all to the virtual camera photographing direction in which the virtual camera photographs at least a part of the browsing object. Therefore, the user can visually recognize how the virtual camera photographing direction has been changed.

Furthermore, as described above, the virtual camera control device 100f includes the gaze point determining unit 130f that determines, as the gaze point, any one point of the traveling object or the browsing object, which is the virtual 3D object, disposed in the virtual 3D space, and the virtual camera traveling unit 140 that moves the virtual camera while keeping the photographing direction of the virtual camera photographing the inside of the virtual 3D space and disposed in the virtual 3D space in the direction from the virtual camera toward the gaze point determined by the gaze point determining unit 130f and keeping the distance from the virtual camera to the traveling object at a fixed distance, in which the gaze point determining unit 130f is configured to change the virtual camera photographing direction to a direction in which the virtual camera is in a state of photographing the entire browsing object when the virtual camera traveling unit 140 has moved the virtual camera to a position where the virtual camera does not photograph the entire browsing object.

With this configuration, the virtual camera control device 100f can set a virtual 3D object different from the browsing object as the traveling object, and at the same time, can suppress the browsing object from deviating even partially from the photographing range.

Furthermore, in the above-described configuration, when moving the virtual camera or changing the photographing direction, the virtual camera traveling unit 140 is configured to generate virtual camera information including information on the position of the virtual camera and information on the photographing direction, and output the generated virtual camera information to the image generating unit 13 that generates an image in which the virtual camera has photographed the virtual 3D object on the basis of the virtual camera information.

With this configuration, the virtual camera control device 100f can cause the display device 40 via the image generating unit 13 included in the display control device 10f to display, like a moving image, the photographed image in the process of changing the virtual camera photographing direction from the state in which the virtual camera does not photograph the entire browsing object to the direction in which the virtual camera is in a state of photographing the entire browsing object. Therefore, the user can visually recognize how the virtual camera photographing direction has been changed.

### Eighth Embodiment

The virtual camera control device 100e according to the sixth embodiment performs control based on the input information for giving an instruction on change of the virtual camera photographing direction in consideration of photographing states of a plurality of browsing objects. In the eighth embodiment, an embodiment will be described in which control based on input information for giving an instruction on change of the virtual camera photographing position is performed in consideration of photographing states of a plurality of browsing objects.

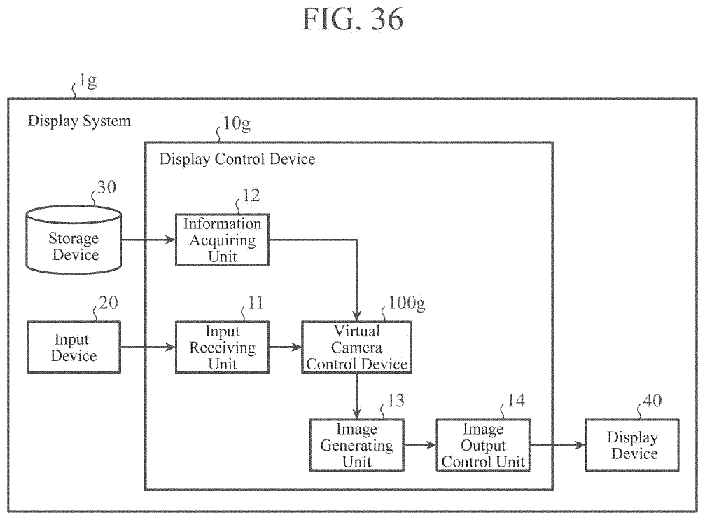

A virtual camera control device 100g according to an eighth embodiment will be described with reference to FIGS. 36 to 39.

With reference to FIG. 36, a configuration of a main part of a display control device 10g to which a virtual camera control device 100g according to the eighth embodiment is applied will be described.

FIG. 36 is a block diagram illustrating an example of a configuration of a main part of a display system 1g to which the display control device 10g according to the eighth embodiment is applied.

The display system 1g includes the display control device 10g, an input device 20, a storage device 30, and a display device 40.

The display system 1g according to the eighth embodiment is obtained by changing the display control device 10 in the display system 1 according to the first embodiment to the display control device 10g.

In the configuration of the display system 1g according to the eighth embodiment, the same reference numerals are given to the same components as the display system 1 according to the first embodiment, and duplicate description thereof will be omitted. That is, the description of the component of FIG. 36 having the same reference numerals as those shown in FIG. 1 will be omitted.

The display control device 10g includes an information processing device such as a general-purpose PC.

The display control device 10g includes an input receiving unit 11, an information acquiring unit 12, a virtual camera control device 100g, an image generating unit 13, and an image output control unit 14.

The display control device 10g according to the eighth embodiment is obtained by changing the virtual camera control device 100 in the display control device 10 according to the first embodiment to the virtual camera control device 100g.

In the configuration of the display control device 10g according to the eighth embodiment, the same reference numerals are given to the same components as the display control device 10 according to the first embodiment, and duplicate description thereof will be omitted. That is, the description of the component of FIG. 36 having the same reference numerals as those shown in FIG. 1 will be omitted.

The virtual camera control device 100g acquires virtual 3D object information and operation input information, and controls a virtual camera photographing position and a virtual camera photographing direction of a virtual camera disposed in a virtual 3D space on the basis of the acquired virtual 3D object information and operation input information. The virtual camera control device 100g outputs the acquired virtual 3D object information and virtual camera information to the image generating unit 13.

The virtual camera information includes camera position information indicating the virtual camera photographing position and camera direction information indicating the virtual camera photographing direction. The virtual camera information may include camera view angle information indicating a view angle at which the virtual camera photographs an image, and the like, in addition to the camera position information and the camera direction information.

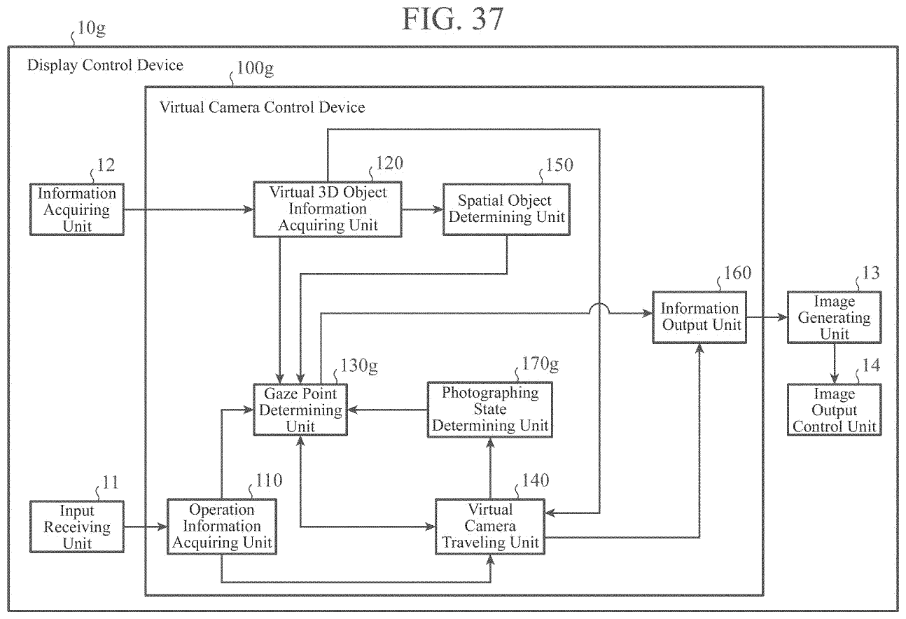

A configuration of a main part of the virtual camera control device 100g according to the eighth embodiment will be described with reference to FIG. 37.

FIG. 37 is a block diagram showing an example of a configuration of a main part of the virtual camera control device 100g according to the eighth embodiment.

The virtual camera control device 100g includes an operation information acquiring unit 110, a virtual 3D object information acquiring unit 120, a gaze point determining unit 130g, a virtual camera traveling unit 140, a photographing state determining unit 170g, and an information output unit 160.

The virtual camera control device 100g may include a spatial object determining unit 150 in addition to the above-described configuration. The virtual camera control device 100g illustrated in FIG. 37 includes the spatial object determining unit 150.

In the virtual camera control device 100g according to the eighth embodiment, the gaze point determining unit 130 in the virtual camera control device 100 according to the first embodiment is changed to the gaze point determining unit 130g, and the photographing state determining unit 170g is added.

Furthermore, in the virtual 3D space according to the first embodiment, only one browsing object is disposed in the virtual 3D space, but in the virtual 3D space according to the eighth embodiment, a plurality of browsing objects are arranged in the virtual 3D space.

In the configuration of the virtual camera control device 100g according to the eighth embodiment, the same reference numerals are given to the same components as the virtual camera control device 100 according to the first embodiment, and duplicate description thereof will be omitted. That is, the description of the component of FIG. 37 having the same reference numerals as those shown in FIG. 2 will be omitted.

Note that, each function of the operation information acquiring unit 110, the virtual 3D object information acquiring unit 120, the gaze point determining unit 130g, the virtual camera traveling unit 140, the photographing state determining unit 170g, the information output unit 160, and the spatial object determining unit 150 in the virtual camera control device 100g according to the eighth embodiment may be implemented by the processor 201 and the memory 202 or may be implemented by the processing circuit 203 in the hardware configuration illustrated as an example in FIGS. 3A and 3B in the first embodiment.

In a case where the operation input information for giving an instruction on change of the virtual camera photographing direction is input from the operation information acquiring unit 110, the gaze point determining unit 130g determines, as a gaze point, any one point of the traveling object or the browsing object. Note that, the operation of the gaze point determining unit 130g is similar to that of the gaze point determining unit 130 according to the first embodiment except that information on the virtual camera photographing direction is acquired from the photographing state determining unit 170g as described later, and thus detailed description of the basic operation will be omitted.

In a case where the operation input information for giving an instruction on the movement of the virtual camera is input from the operation information acquiring unit 110, the virtual camera traveling unit 140 moves the virtual camera while keeping the virtual camera photographing direction in the direction from the virtual camera toward the gaze point determined by the gaze point determining unit 130g and keeping the distance from the virtual camera to the traveling object at a fixed distance.

The information output unit 160 outputs the virtual camera information generated by the virtual camera traveling unit 140 to the image generating unit 13 in the display control device 10g.

The virtual camera information and the virtual 3D object information are input from the virtual camera traveling unit 140 to the photographing state determining unit 170g. The photographing state determining unit 170g determines the photographing state of the browsing object by the virtual camera on the basis of the virtual 3D object information and the virtual camera information. Specifically, the photographing state determining unit 170g determines whether or not the virtual camera is in a state of photographing at least a part of a first browsing object that is one of the plurality of browsing objects. The photographing state determining unit 170g, when having determined that the virtual camera is not in a state of photographing at least a part of the first browsing object, that is, when having determined that the virtual camera is in a state of not photographing the first browsing object at all, determines whether or not it is possible to bring the virtual camera into a state of photographing at least a part of other browsing objects different from the first browsing object by changing the virtual camera photographing direction. The photographing state determining unit 170g, when having determined that the virtual camera is able to be in a state of photographing at least a part of the other browsing objects in the determination, the photographing state determining unit determines, as a second browsing object, one closest to the current virtual camera photographing direction among the other browsing objects. Furthermore, the photographing state determining unit 170g calculates a virtual camera photographing direction in which the virtual camera is in a state of photographing at least a part of the second browsing object, and outputs information on the calculated virtual camera photographing direction to the gaze point determining unit 130g.

Upon acquiring the information on the virtual camera photographing direction from the photographing state determining unit 170g, the gaze point determining unit 130g changes the virtual camera photographing direction on the basis of the information and determines the gaze point again.

That is, when the virtual camera traveling unit 140 has moved the virtual camera to a position where the virtual camera does not photograph the first browsing object at all, the gaze point determining unit 130g changes the virtual camera photographing direction to a direction in which the virtual camera is in a state of photographing at least a part of the second browsing object, and determines the gaze point again.

The gaze point determining unit 130g outputs information on the gaze point determined again to the virtual camera traveling unit 140. Thereafter, in a case where the operation input information for giving an instruction on the movement of the virtual camera is input from the operation information acquiring unit 110, the virtual camera traveling unit 140 moves the virtual camera while keeping the virtual camera photographing direction in the direction from the virtual camera toward the gaze point determined by the gaze point determining unit 130g and keeping the distance from the virtual camera to the traveling object at a fixed distance.

In addition, the gaze point determining unit 130g outputs the virtual camera photographing direction to the virtual camera traveling unit 140 also while changing the virtual camera photographing direction from a state in which the virtual camera does not photograph the first browsing object at all to a state in which the virtual camera photographs at least a part of the second browsing object. For example, while the gaze point determining unit 130g changes the virtual camera photographing direction from a state in which the virtual camera does not photograph the first browsing object at all to a state in which the virtual camera photographs at least a part of the second browsing object, the virtual camera traveling unit 140 generates virtual camera information on the basis of the virtual camera photographing direction acquired from the gaze point determining unit 130g and outputs the virtual camera information to the information output unit 160.

By the virtual camera control device 100g controlling the virtual camera in this manner, the display control device 10g can suppress a state in which the browsing object is not displayed on the display device 40 when determining the gaze point.

Furthermore, on the display device 40, a process from a state in which the virtual camera does not photograph the first browsing object at all to a state in which it photographs at least a part of the second browsing object is displayed like a moving image. Therefore, the display control device 10g can cause the user to visually recognize how the virtual camera photographing direction has been changed.

Note that, while the gaze point determining unit 130g changes the virtual camera photographing direction from a state in which the virtual camera does not photograph the first browsing object at all to a state in which it photographs at least a part of the second browsing object, the virtual camera traveling unit 140 may not generate virtual camera information or may not output virtual camera information to the information output unit 160 after generating the virtual camera information.

Hereinafter, as an example, a case where the display control device 10g is used as a device that performs simulation on a road surface image will be described. Hereinafter, a description will be given assuming that the traveling object is a virtual 3D object indicating a vehicle in a virtual 3D space, the first browsing object is a virtual 3D object indicating a first road surface image in the virtual 3D space, and the second browsing object is a virtual 3D object indicating a second road surface image in the virtual 3D space. It is assumed that the first road surface image and the second road surface image are displayed at different positions on the road surface.

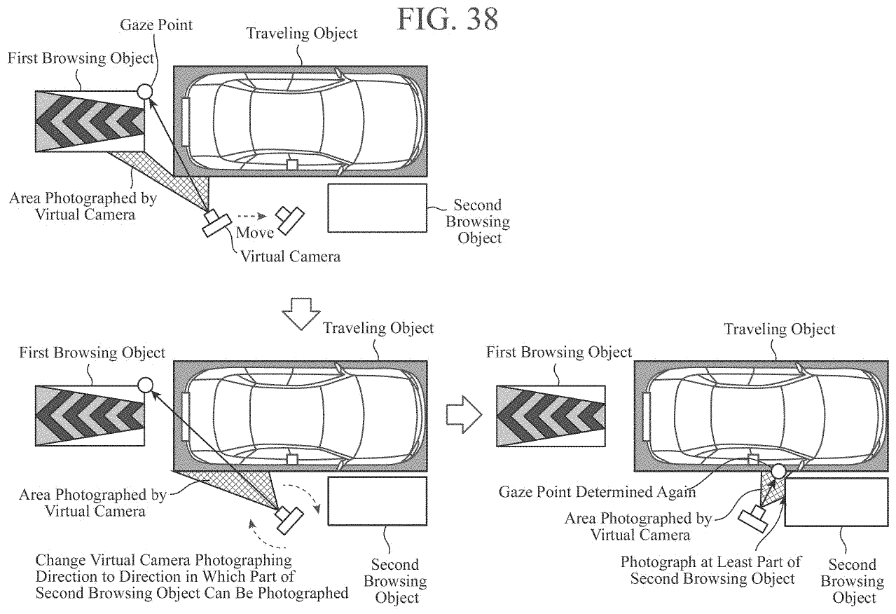

FIG. 38 is an arrangement diagram illustrating an example of a positional relationship among a traveling object, a first browsing object, a second browsing object, and a virtual camera as viewed from above a virtual 3D object indicating a vehicle that is the traveling object in the virtual 3D space according to the eighth embodiment.

Hereinafter, as illustrated in FIG. 38, a description will be given assuming that the gaze point is already determined as one point in the first browsing object that is the virtual 3D object indicating the first road surface image by the gaze point determining unit 130g.

As illustrated in FIG. 38, the virtual camera traveling unit 140 moves the virtual camera on the basis of the operation input information acquired by the operation information acquiring unit 110. Specifically, as illustrated in FIG. 38, in a case where the virtual camera traveling unit 140 moves the virtual camera to a position where the virtual camera does not photograph the first browsing object at all, the gaze point determining unit 130g changes the virtual camera photographing direction to a direction in which the virtual camera is in a state of photographing at least a part of the second browsing object, and determines the gaze point again. In the example illustrated in FIG. 38, the gaze point determined again is one point in the traveling object.

Note that, FIG. 38 illustrates, as an example, a case where the gaze point when the virtual camera traveling unit 140 moves the virtual camera is one point in the first browsing object, but the gaze point when the virtual camera traveling unit 140 moves the virtual camera may be one point in the traveling object.

Furthermore, FIG. 38 illustrates, as an example, a case where the gaze point after being determined again by the gaze point determining unit 130g is one point in the traveling object, but the gaze point after being determined again by the gaze point determining unit 130g may be one point in the second browsing object.

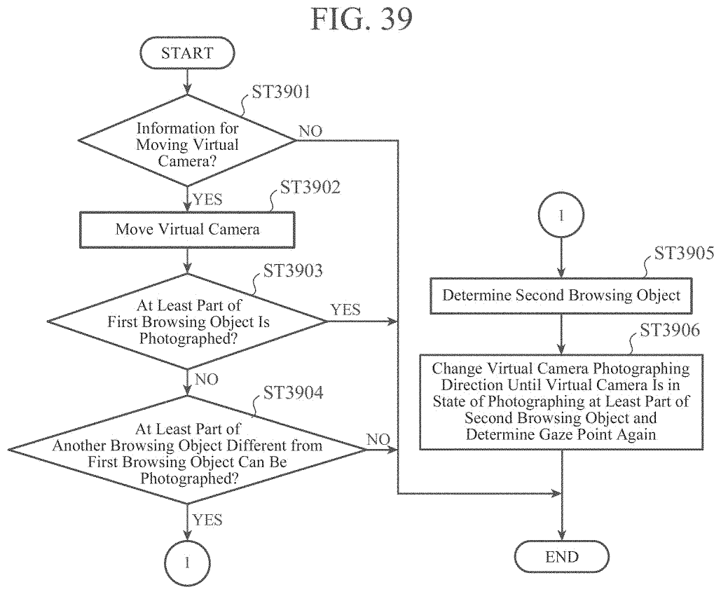

An operation in which the virtual camera control device 100g according to the eighth embodiment determines the gaze point again will be described with reference to FIG. 39.

FIG. 39 is a flowchart illustrating an example of processing in which the virtual camera control device 100g according to the eighth embodiment determines a gaze point. Note that, in the virtual camera control device 100g, it is assumed that the gaze point determining unit 130g determines the gaze point by the operation described with reference to FIG. 4 in the first embodiment or the like before performing the processing of the flowchart.

For example, every time the operation information acquiring unit 110 acquires the operation input information, the virtual camera control device 100g repeatedly executes the processing of the flowchart.

First, in step ST3901, the virtual camera traveling unit 140 determines whether or not the operation input information acquired by the operation information acquiring unit 110 is information for moving the virtual camera.

In step ST3901, when the virtual camera traveling unit 140 has determined that the operation input information acquired by the operation information acquiring unit 110 is not information for moving the virtual camera, the virtual camera control device 100g ends the processing of the flowchart.

In step ST3901, when the virtual camera traveling unit 140 has determined that the operation input information acquired by the operation information acquiring unit 110 is information for moving the virtual camera, in step ST3902, the virtual camera traveling unit 140 moves the virtual camera on the basis of the operation input information acquired by the operation information acquiring unit 110.

After step ST3902, in step ST3903, the gaze point determining unit 130g causes the photographing state determining unit 170g to determine whether or not the virtual camera is in a state of photographing at least a part of the first browsing object.

In step ST3903, when the photographing state determining unit 170g has determined that the virtual camera is in a state of photographing at least a part of the first browsing object, the virtual camera control device 100g ends the processing of the flowchart.

In step ST3903, when the photographing state determining unit 170g has determined that the virtual camera is not in a state of photographing at least a part of the first browsing object, that is, has determined that the virtual camera is in a state of not photographing the first browsing object at all, the photographing state determining unit 170g performs processing of step ST3904. In step ST3904, the photographing state determining unit 170g determines whether or not the virtual camera can photograph at least a part of other browsing objects different from the first browsing object by the gaze point determining unit 130g changing the virtual camera photographing direction.

In step ST3904, when the photographing state determining unit 170g has determined that the virtual camera is not in a state of photographing at least a part of other browsing objects different from the first browsing object even if the virtual camera photographing direction is changed, the virtual camera control device 100g ends the processing of the flowchart.

In step ST3904, when the photographing state determining unit 170g has determined that the virtual camera is able to be in a state of photographing at least a part of the other browsing objects different from the first browsing object by changing the virtual camera photographing direction, the photographing state determining unit 170g performs processing of step ST3905. In step ST3905, the photographing state determining unit 170g determines, as the second browsing object, the browsing object closest to the current virtual camera photographing direction among the other browsing objects different from the first browsing object, at least a part of which has been determined to be able to photograph.

After step ST3905, in step ST3906, the gaze point determining unit 130g changes the virtual camera photographing direction and determines the gaze point again until the virtual camera is in a state of photographing at least a part of the second browsing object.

After step ST3906, the virtual camera control device 100g ends the processing of the flowchart.

By the virtual camera control device 100g controlling the virtual camera in this manner, the display control device 10g can suppress a state in which the browsing object is not displayed on the display device 40. Therefore, the user can efficiently obtain a simulation result about how the browsing object looks.

Note that, in the above description, it has been described that the gaze point determining unit 130g changes the virtual camera photographing direction in a direction in which the virtual camera is in a state of photographing at least a part of the second browsing object that is the browsing object in a case where the virtual camera traveling unit 140 has moved the virtual camera to a position where the virtual camera does not photograph the first browsing object that is the browsing object at all, but it is not limited thereto. For example, the gaze point determining unit 130g may change the virtual camera photographing direction to a direction in which the virtual camera is in a state of photographing the entire second browsing object that is the browsing object when the virtual camera traveling unit 140 has moved the virtual camera to a position where the virtual camera does not photograph the entire first browsing object that is the browsing object. Note that the entire browsing object mentioned here is the entire outer shape of the browsing object that can be visually recognized when the browsing object is viewed from any direction.

Furthermore, in the above description, it has been described that the gaze point determining unit 130g determines, as the gaze point, any one point of the traveling object or the plurality of browsing objects, but it is not limited thereto. For example, the virtual camera control device 100g may include the spatial object determining unit 150, and in a case where the spatial object determining unit 150 determines that the virtual 3D object information acquiring unit 120 has acquired the spatial object information, the gaze point determining unit 130g may determine, as the gaze point, any one point of the traveling object, the plurality of browsing objects, or the spatial object.

Since the operation of the gaze point determining unit 130g in a case where the gaze point determining unit 130g determines, as the gaze point, any one point of the traveling object, the plurality of browsing objects, or the spatial object is similar to the operation of the gaze point determining unit 130g described so far, the description thereof will be omitted.

As described above, the virtual camera control device 100g includes the gaze point determining unit 130g that determines, as a gaze point, any one point of the traveling object or the browsing object, which is the virtual 3D object, disposed in the virtual 3D space, and the virtual camera traveling unit 140 that moves the virtual camera while keeping a photographing direction of the virtual camera photographing the inside of the virtual 3D space and disposed in the virtual 3D space in the direction from the virtual camera toward the gaze point determined by the gaze point determining unit 130g and keeping the distance from the virtual camera to the traveling object at a fixed distance, in which the gaze point determining unit 130g is configured to change the virtual camera photographing direction to a direction in which the virtual camera is in a state of photographing at least a part of the second browsing object that is the browsing object closest to the virtual camera photographing direction, when the virtual camera traveling unit 140 has moved the virtual camera to a position where the virtual camera does not photograph the first browsing object, which is the browsing object, at all.

With this configuration, the virtual camera control device 100g can set a virtual 3D object different from the browsing object as the traveling object, and at the same time, can suppress all of the virtual 3D objects from deviating entirely from the photographing range.

Furthermore, in the above-described configuration, when moving the virtual camera or changing the photographing direction, the virtual camera traveling unit 140 is configured to generate virtual camera information including information on the position of the virtual camera and information on the photographing direction, and output the generated virtual camera information to the image generating unit 13 that generates an image in which the virtual camera has photographed the virtual 3D object on the basis of the virtual camera information.

With this configuration, the virtual camera control device 100g can cause the display device 40 via the image generating unit 13 included in the display control device 10g to display, like a moving image, the photographed image in the process of changing the virtual camera photographing direction from the state in which the first browsing object is not photographed at all to the virtual camera photographing direction in which the virtual camera is in a state of photographing at least a part of the second browsing object. Therefore, the user can visually recognize how the virtual camera photographing direction has been changed.

Furthermore, as described above, the virtual camera control device 100g includes the gaze point determining unit 130g that determines, as the gaze point, any one point of the traveling object or the browsing object, which is the virtual 3D object, disposed in the virtual 3D space, and the virtual camera traveling unit 140 that moves the virtual camera while keeping a photographing direction of the virtual camera photographing the inside of the virtual 3D space and disposed in the virtual 3D space in the direction from the virtual camera toward the gaze point determined by the gaze point determining unit 130g and keeping the distance from the virtual camera to the traveling object at a fixed distance, in which the gaze point determining unit 130g is configured to change the virtual camera photographing direction to a direction in which the virtual camera is in a state of photographing the entire second browsing object that is the browsing object closest to the virtual camera photographing direction, when the virtual camera traveling unit 140 has moved the virtual camera to a position where the virtual camera does not photograph the entire first browsing object, which is the browsing object.

With this configuration, the virtual camera control device 100g can set a virtual 3D object different from the browsing object as the traveling object, and at the same time, can photograph the entirety of at least one of the plurality of browsing objects. Therefore, the user can efficiently obtain a simulation result about how the entire outer shape of any of the browsing objects looks.

Furthermore, in the above-described configuration, when moving the virtual camera or changing the photographing direction, the virtual camera traveling unit 140 is configured to generate virtual camera information including information on the position of the virtual camera and information on the photographing direction, and output the generated virtual camera information to the image generating unit 13 that generates an image in which the virtual camera has photographed the virtual 3D object on the basis of the virtual camera information.

With this configuration, the virtual camera control device 100g can cause the display device 40 via the image generating unit 13 included in the display control device 10g to display, like a moving image, the photographed image in the process of changing the virtual camera photographing direction from the state in which the virtual camera does not photograph the entire first browsing object to the direction in which the virtual camera is in a state of photographing the entire second browsing object. Therefore, the user can visually recognize how the virtual camera photographing direction has been changed.

It should be noted that the present invention can freely combine the embodiments, modify any constituent element of each embodiment, or omit any constituent element in each embodiment within the scope of the invention.

### INDUSTRIAL APPLICABILITY

The virtual camera control device according to the present invention can be applied to a display control device.

### REFERENCE SIGNS LIST

1, la, 1b, 1c, 1d, 1e, 1f, 1g: display system, 10, 10a, 10b, 10c, 10d, 10e, 10f, 10g: display control device, 11: input receiving unit, 12: information acquiring unit, 13: image generating unit, 14: image output control unit, 20: input device, 30: storage device, 40: display device, 100, 100a, 100b, 100c, 100d, 100e, 100f, 100g: virtual camera control device, 110: operation information acquiring unit, 120: Virtual 3D object information acquiring unit, 130, 130c, 130d, 130e, 130f, 130g: gaze point determining unit, 140, 140a, 140b: virtual camera traveling unit, 150: spatial object determining unit, 160: Information output unit, 170, 170b, 170c, 170d, 170e, 170f, 170g: photographing state determining unit, 201: processor, 202: memory, 203: processing circuit

1. A virtual camera control device comprising:
processing circuitry to perform a process to:
determine, as a gaze point, any one point of a traveling object or a browsing object that is disposed in a virtual 3D space and is a virtual 3D object; and
move a virtual camera while keeping a photographing direction of the virtual camera that photographs an inside of the virtual 3D space and is disposed in the virtual 3D space in a direction from the virtual camera toward the gaze point determined and keeping a distance from the virtual camera to the traveling object at a fixed distance, wherein the travelling object is the virtual 3D object indicating a vehicle in the virtual 3D space, and the browsing object is the virtual 3D object indicating an image formed on a road surface by a projecting device provided on the vehicle in the virtual 3D space.

2. The virtual camera control device according to claim 1, wherein when a photographing direction of the virtual camera is designated, the process determines, as the gaze point, a point closest to the virtual camera among points at which a straight line passing through a position of the virtual camera and extending in the designated photographing direction of the virtual camera intersects with the traveling object or the browsing object.

3. The virtual camera control device according to claim 1, wherein in a case where a distance from the virtual camera to a second surface of the traveling object becomes shorter than the fixed distance when the process has moved the virtual camera while keeping a distance from the virtual camera to a first surface of the traveling object at the fixed distance, the process moves the virtual camera to a position where the distance from the virtual camera to the second surface of the traveling object is the fixed distance.

4. The virtual camera control device according to claim 1, wherein the process moves the virtual camera within a range of a position at which the virtual camera can photograph at least a part of the browsing object.

5. The virtual camera control device according to claim 1, wherein the process, when having moved the virtual camera to a position at which the virtual camera does not photograph the browsing object at all, moves the virtual camera to a position at which the virtual camera is in a state of photographing at least a part of the browsing object.

6. The virtual camera control device according to claim 1, wherein the process moves the virtual camera within a range of a position at which the virtual camera can photograph the entire browsing object.

7. The virtual camera control device according to claim 1, wherein the process, when having moved the virtual camera to a position at which the virtual camera does not photograph the entire browsing object, moves the virtual camera to a position at which the virtual camera is in a state of photographing the entire browsing object.

8. The virtual camera control device according to claim 1, wherein the process determines the gaze point by changing a photographing direction of the virtual camera within a range of a direction in which the virtual camera can photograph at least a part of the browsing object.

9. The virtual camera control device according to claim 1, wherein the process changes a photographing direction of the virtual camera within a range of a direction in which the virtual camera can photograph the entire browsing object.

10. The virtual camera control device according to claim 1, wherein the process, when having changed a photographing direction of the virtual camera to a direction in which the virtual camera does not photograph the browsing object at all, changes the photographing direction of the virtual camera to a direction in which the virtual camera is in a state of photographing at least a part of the browsing object.

11. The virtual camera control device according to claim 1, wherein the process, when having changed a photographing direction of the virtual camera to a direction in which the virtual camera does not photograph a first browsing object that is the browsing object at all, changes the photographing direction of the virtual camera to a direction in which the virtual camera is in a state of photographing at least a part of a second browsing object that is the browsing object closest to the photographing direction of the virtual camera.

12. The virtual camera control device according to claim 1, wherein the process, when having changed a photographing direction of the virtual camera to a direction in which the virtual camera does not photograph the entire browsing object, changes the photographing direction of the virtual camera to a direction in which the virtual camera is in a state of photographing the entire browsing object.

13. The virtual camera control device according to claim 1, wherein the process, when having changed a photographing direction of the virtual camera to a direction in which the virtual camera does not photograph an entire first browsing object that is the browsing object, changes the photographing direction of the virtual camera to a direction in which the virtual camera is in a state of photographing an entire second browsing object that is the browsing object closest to the photographing direction of the virtual camera.

14. The virtual camera control device according to claim 1, wherein when the process has moved the virtual camera to a position at which the virtual camera does not photograph the browsing object at all, the process changes a photographing direction of the virtual camera to a direction in which the virtual camera is in a state of photographing at least a part of the browsing object.

15. The virtual camera control device according to claim 1, wherein when the process has moved the virtual camera to a position at which the virtual camera does not photograph a first browsing object that is the browsing object at all, the process changes a photographing direction of the virtual camera to a direction in which the virtual camera is in a state of photographing at least a part of a second browsing object that is the browsing object.

16. The virtual camera control device according to claim 1, wherein when the process has moved the virtual camera to a position at which the virtual camera does not photograph the entire browsing object, the process changes a photographing direction of the virtual camera to a direction in which the virtual camera is in a state of photographing the entire browsing object.

17. The virtual camera control device according to claim 1, wherein when the process has moved the virtual camera to a position at which the virtual camera does not photograph an entire first browsing object that is the browsing object, the process changes a photographing direction of the virtual camera to a direction in which the virtual camera is in a state of photographing an entire second browsing object that is the browsing object.

18. The virtual camera control device according to claim 1, wherein the process determines, as the gaze point, any one point of the traveling object, the browsing object, or a spatial object that is the virtual 3D object.

19. The virtual camera control device according to claim 18, wherein the process, when a photographing direction of the virtual camera is designated, determines, as the gaze point, a point closest to the virtual camera among points at which a straight line passing through a position of the virtual camera and extending in the designated photographing direction of the virtual camera intersects with the traveling object, the browsing object, or the spatial object.

20. The virtual camera control device according to claim 3, wherein the process, when moving the virtual camera or changing a photographing direction, generates virtual camera information including information on a position of the virtual camera and information on a photographing direction, and outputs the generated virtual camera information to an image generator that generates an image in which the virtual camera photographs the virtual 3D object on a basis of the virtual camera information.

21. A virtual camera control method, comprising:
determining as a gaze point, any one point of a traveling object or a browsing object that is disposed in a virtual 3D space and is a virtual 3D object; and
moving a virtual camera while keeping a photographing direction of a virtual camera that photographs an inside of the virtual 3D space and is disposed in the virtual 3D space in a direction from the virtual camera toward the gaze point determined and keeping a distance from the virtual camera to the traveling object at a fixed distance, wherein the travelling object is the virtual 3D object indicating a vehicle in the virtual 3D space, and the browsing object is the virtual 3D object indicating an image formed on a road surface by a projecting device provided on the vehicle in the virtual 3D space.

22. A nontransitory, tangible computer-readable storage medium storing a virtual camera control program for causing a computer to implement a process of:
determining, as a gaze point, any one point of a traveling object or a browsing object that is disposed in a virtual 3D space and is a virtual 3D object; and
moving a virtual camera while keeping a photographing direction of the virtual camera that photographs an inside of the virtual 3D space and is disposed in the virtual 3D space in a direction from the virtual camera toward the gaze point determined and keeping a distance from the virtual camera to the traveling object at a fixed distance, wherein the travelling object is the virtual 3D object indicating a vehicle in the virtual 3D space, and the browsing object is the virtual 3D object indicating an image formed on a road surface by a projecting device provided on the vehicle in the virtual 3D space.
